(19) United States
(12) Patent Application Publication
(10) Pub. No.: US 2015/0214824 A1
(43) Pub. Date: Jul. 30, 2015

(54) ELECTROMAGNETIC TURBINE

(71) Applicant: GUINA RESEARCH AND DEVELOPMENT PTY LTD, Surfers Paradise, Queensland (AU)

(72) Inventors: Ante Guina, Surfers Paradise (AU); John Kells, Surfers Paradise (AU); Kurt Labes, Surfers Paradise (AU); David Sercombe, Surfers Paradise (AU); Tony Lissington, Surfers Paradise (AU); Rene Fuger, Surfers Paradise (AU); Arkadiy Matsekh, Surfers Paradise (AU); Cesimiro Paulino Fabian Geronimo, Bridgeman Downs (AU)

(21) Appl. No.: 14/428,631

(22) PCT Filed: Sep. 17, 2013
(86) PCT No.: PCT/AU2013/001063

§ 371 Date: Mar. 16, 2015

(30) Foreign Application Priority Data
Sep. 17, 2012 (AU) 2012904048

(51) Int. Cl. H02K 55/06; H02K 13/00; H02K 47/14; H02K 3/28; H02K 1/12

(52) U.S. Cl. CPC H02K 55/06; H02K 3/28; H02K 1/12; H02K 47/14; H02K 13/003

(57) ABSTRACT

A generator including a first magnetic assembly and a second magnetic assembly wherein the first and second magnetic assemblies are arranged in parallel for the production of a magnetic field and a null magnetic field region, a rotor positioned between the first and second magnetic assemblies the rotor being coupled to a drive shaft extending through the first and second magnetic assemblies wherein a portion of the rotor is positioned in the null field region, a least one current transfer mechanism coupled to the rotor in the null field region and at least one current transfer mechanism coupled to the shaft, a drive mechanism attached to the shaft, whereby actuation of the drive mechanism causes rotation of the rotor in the magnetic field to produce a electric potential between the first and second current transfer mechanisms.

### TECHNICAL FIELD

The present invention relates to electromagnetic turbines. In particular although not exclusively the present invention relates to electromagnetic turbines for power generation.

### BACKGROUND ART

One of the fundamental principles of physics is the relationship between electricity and magnetism. This relationship was first observed in the mid-1800s when it was noted that current passing through a simple bar conductor, induces a magnetic field perpendicular to the direction of current flow. As a result of the induced magnetic field, each of the moving charges, which comprises the current, experiences a force. The force exerted on each of the moving charges generates torque on the conductor proportional to the magnetic field.

The above discussed basic interactions between electric and magnetic fields are the basic scientific principles which underpin electric motors and generators. One of the simplest forms of electric generator was first exemplified by Michael Faraday, with his use of a device now known as the Faraday disk. Faraday's device consisted of a copper disk rotated between the poles of a permanent magnet. This generates a current proportional to the rate of rotation. The Faraday disc was in essence the first homopolar generator. Faraday's generator however was exceedingly inefficient due to counter flows of current which limited the power output to the pickup wires, and the effects of parasitic heating on the copper disc.

More specifically the Emf produced between the centre and outside diameter of a rotating disc, radius R, at rotational speed ω in uniform magnetic field B is given by:

$$ɛ = {\int }_{0}^{R} ω Br d r = \frac{{R}^{2}}{2} B ω$$

This is one of the key formulas for homopolar generation as the voltage obtained from an individual stage or rotor is a significant determining factor with regard to the efficiency of the current extraction from the generator. In order to efficiently generate current this voltage must be significantly higher than the internal losses of the rotor, sliding contacts and the subsequent current interconnects and/or final load.

In a general sense, one of the most useful factors for comparing various designs is the integral ∫B(r)r.dr. This integral produces a value in V/rad/s which can be readily calculated for any field profile.

Despite various advances in design and materials since Faraday's original demonstration, homopolar generators have generally long been regarded as being extremely inefficient. Nonetheless homopolar generators have some unique physical properties that make them desirable for certain applications. Firstly homopolar generators are the only generators that produce a true DC output. Most multi-pole generators are required to commutate or selectively switch into AC windings to get a DC output. In addition to this homopolar generators typically produce low voltages and high currents.

Given the benefits of homopolar motor/generators it would be advantageous to provide a homopolar generator with improved performance. It would also be advantageous to provide a homopolar generator which ameliorates some of the aforementioned deficiencies of the prior art.

### SUMMARY OF INVENTION

In one form the invention resides in a generator, said generator including:

a first magnetic assembly and a second magnetic assembly wherein the first and second magnetic assemblies are arranged in parallel for the production of a magnetic field and a null magnetic field region;

a rotor positioned between the first and second magnetic assemblies, the rotor being coupled to a drive shaft which extending through the first and second magnetic assemblies wherein a portion of the rotor is positioned in the null field region;

a first current transfer mechanism coupled to the rotor in the null field region and a second current transfer mechanism coupled to the shaft;

a drive mechanism attached to the shaft;

whereby actuation of the drive mechanism causes rotation of the rotor in the magnetic field to produce an electric potential between the first and second current transfer mechanisms.

Preferably the first and second magnetic assemblies are of a cylindrical construction. Suitably each of the assemblies includes one or more coils of superconducting material contained within a cryogenic envelope. In the case where the assemblies include a plurality of superconducting coils the coils may be linked to form a solenoid. In some embodiments of the invention the superconducting conducting coils are arranged in specific geometric configurations. In some embodiments of the present invention the coils may be arranged concentrically. In some embodiments of the present invention the coils are arranged coaxially. In some embodiments of the present invention one or more coils within the first and second magnetic assemblies may be of opposing polarity.

The superconducting coils may be formed from any suitable superconducting wire. Preferably the superconducting wire is Nb₃Sn superconducting wire. Alternatively the coils may be constructed from NbTi superconducting wire.

Suitably the rotor and shaft are formed from a suitable conductive material. In some embodiments of the present invention the shaft and rotor are formed integrally. The rotor may be a solid disc. Alternatively the rotor could be in the form of a traditional spoke wheel configuration with central hub and one or more arms coupling the outer rim to the hub. In some embodiments of the present invention the hub of the rotor is hollow to allow for the insertion of a drive shaft from the drive mechanism. The rotor may be a laminated construction where one or more conductive layers are mechanically coupled together to form the rotor. In such cases each of the layers is electrically insulated from the adjacent rotors apart from a series connection to ensure current flow through the rotor on rotation of the rotor in the drive field.

The current transfer mechanisms may be in the form of brushes in direct contact with the rotor and shaft. Most preferably the current transfer mechanisms are in the form of liquid metal brushes. In such instance the liquid metal brushes may be formed by the use of a channel formed in a stator which surrounds the rim of the rotor, the rim of the rotor may be shaped with a complementary groove to further enhance electrical contact. The liquid metal may be introduced into the channel in the stator from a reservoir under variable pressure. A gas may also be introduced into the channel during sealing to reduce the adverse effects of moisture and oxygen on the liquid metal.

Suitably the current transfer mechanism is positioned external to the first or second magnetic assemblies. Preferably the current transfer mechanism is positioned in a region where the strength of the magnetic field is below 0.2 T

Suitably the drive mechanism may be a low speed drive. In such cases the resultant potential generated across the current transfer mechanisms is low voltage and high current. The drive mechanism may be a high speed drive. In such instances the potential produced across the current transfers is high voltage and low current. The drive mechanism may be any suitable drive mechanism such as a motor or wind turbine, steam turbine, water driven turbine or the like.

In another aspect of the present invention there is provided a generator including a DC-DC conversion stage the generator including:

a first magnetic assembly and a second magnetic assembly wherein the first and second magnetic assemblies are arranged in parallel for the production of a primary drive field and a null magnetic field region;

a first rotor positioned between the first and second magnetic assemblies, the first rotor being adapted for connection to a drive shaft wherein a portion of the rotor is positioned in the null field region;

an electric motor electrically coupled to the first rotor, the electric motor positioned between a third and fourth magnetic assemblies are arranged in parallel to produce a drive field for the motor said third and fourth magnetic assemblies producing a plurality of secondary null field regions wherein the electrical couplings of the motor are positioned with the secondary nulls;

a second rotor positioned between the first and second magnetic assemblies and adjacent the first rotor, said second rotor being mechanically coupled to the electric motor wherein a portion of the second rotor is positioned in the null field region

a drive mechanism mechanically coupled to the first rotor;

whereby actuation of the drive mechanism causes rotation of the first rotor within the primary drive field to produce a high current which is passed through the electric motor to generate a torque to drive the second rotor within the primary field to produce a low current output.

In yet another aspect of the present invention there is provided a generator including a DC-DC conversion stage the generator including:

a first magnetic assembly and a second magnetic assembly wherein the first and second magnetic assemblies are arranged in parallel for the production of a primary drive field and a null magnetic field region;

a first rotor adapted for connection to a drive shaft wherein a portion of the rotor is positioned in the null field region produced between the first and second magnetic assemblies;

an electric motor electrically coupled to the first rotor, the electric motor positioned between a third and fourth magnetic assemblies that are arranged in parallel to produce a drive field for the motor, said third and fourth magnetic assemblies producing a plurality of secondary null field s wherein the electrical couplings of the motor are positioned with the secondary nulls;

a second rotor positioned adjacent the first rotor, said second rotor being mechanically coupled to the electric motor and wherein a portion of the second rotor is positioned in the null field region produced between the first and second magnetic assemblies

a drive mechanism mechanically coupled to the first rotor;

whereby actuation of the drive mechanism causes rotation of the first rotor within the primary drive field to produce a high current which is passed through the electric motor to generate a torque to drive the second rotor within the primary field to produce a low current output.

Suitably the first and second rotors include inner and outer current transfer mechanisms. Preferably the inner current transfer mechanisms are positioned within at least one of the secondary null field regions and the outer current transfer mechanisms are positioned within the null field region. The current transfer mechanisms are in the form of liquid metal brushes. In such instance the liquid metal brushes may be formed by the use of a channel formed in a stator which surrounds the rim of each rotor, the rim of the rotor may be shaped with a complementary groove to further enhance electrical contact. The liquid metal may be introduced into the channel in the stator from a reservoir under variable pressure. A gas may also be introduced into the channel to reduce the adverse effects of moisture and oxygen on the liquid metal.

The electrical couplings for the electric motor may be in the form of an inner and an outer current transfer mechanism. Suitably the inner current transfer mechanism is positioned within a first region within the secondary null field regions and the outer brush is positioned within a second region within the secondary null field regions.

Preferably the first, second, third and fourth magnetic assemblies are of a cylindrical construction. Suitably each of the assemblies includes one or more coils of superconducting material contained within a cryogenic envelope. In some embodiments of the present invention the coils may be arranged concentrically. In some embodiments of the present invention the coils are arranged coaxially. In some embodiments of the present invention one or more coils within the first and second may be of opposing polarity. The superconducting coils may be formed from any suitable superconducting wire. Preferably the superconducting wire is Nb₃Sn superconducting wire. Alternatively the coils may be constructed form NbTi superconducting wire.

In some embodiments of the present invention the first, second, third and fourth magnetic assemblies may be arranged in overlapping relation. Preferably the third and fourth magnetic assemblies are arranged concentrically with the first and second magnetic assemblies.

In some embodiments of the present invention a third rotor may be provided. The third rotor being positioned between a fifth and a sixth magnetic assemblies such that a portion of the third rotor is positioned within the null magnetic field region produced between the fifth and sixth magnetic assemblies. The third rotor is preferably mechanically coupled to and electrically insulated from the second rotor.

The fifth and sixth magnetic assemblies may be of a cylindrical construction. Suitably the fifth and sixth magnetic assemblies include one or more coils of superconducting material contained within a cryogenic envelope. Preferably the coils are arranged concentrically.

In yet another aspect of the present invention there is provided a generator including:

a first magnetic assembly and a second magnetic assembly wherein the first and second magnetic assemblies are arranged in parallel for the production of a primary drive field and regions of null magnetic field region;

a third and a fourth magnetic assembly arranged in parallel and positioned concentrically within the first and second magnetic assemblies

a rotor positioned between the magnetic assemblies, the rotor being adapted for connection to a drive shaft;

a plurality of current transfer mechanisms coupled at discrete points along the rotor wherein each current transfer mechanism is positioned within a region of null field produced between the magnetic assemblies the rotor in the null field region and a second current transfer mechanism coupled to the shaft;

a drive mechanism attached to the rotor;

whereby actuation of the drive mechanism causes rotation of the rotor in the magnetic field to produce an electric potential between the current transfer mechanisms.

An important variation which may be employed as an alternative to or in addition to the above, is the use of active shielding. The aim of active shielding is the reduction of the stray magnetic field produced by the devices. This preferably reduces the space required surrounding the devices for safe operation or regulatory compliance. The required space is generally represented by a line (in reality a 3 dimensional surface) around the devices beyond which the magnetic field strength is below 5 Gauss (the 5 Gauss Line).

Typically, magnetic shielding or boundary reduction of the 5 Gauss line is achieved using large amounts of steel or other highly magnetically permeable material. In weight sensitive applications involving high magnetic fields, the use of large amounts of steel is a significant disadvantage. One way of overcoming this disadvantage is through the use of powered (active) electromagnetic coils positioned outside of the primary electromagnetic coils that create the driving field and null field regions.

The external magnetic active shielding coils vary in number, size and orientation, according to the desired amount of field cancellation, the type and amount of superconducting wire used and external constraints on the size of the device that is to be actively shielded. While preferred devices predominately use high and low temperature superconducting materials, it is conceivable that normal conducting materials, such as copper wire, might be used.

The preferred devices typically employ either two or four additional active shielding coils. The additional active shielding coils are preferably positioned coaxially with the preferred main drive and secondary null field creation coils. Generally speaking, two-coil active shielding arrangements have slightly lower total wire usage than four-coil designs. Four coil designs allow more freedom in the positioning and adjustment of the coils and hence usually result in more effective shielding.

The following are general rules or principles used as a starting point for the construction of active shielding systems:
For a two-coil system, the preferred starting point is a pair of coils that are twice the diameter of the midline diameter of the main coil assembly. The spacing between these coils is preferably equal to the diameter of one of the active shielding coils. This is roughly a Helmholtz coil arrangement.
Four coil shielding systems have finer control over the shielding parameters but the final optimal solution is dependent on the amount of axial and radial field to be shielded. Four coil designs tend to require a large amount of hand optimisation on a case by case basis. Generally, the four coil solution requires a pair of larger diameter outer coils spaced closer to the main body of the device and a pair of smaller diameter inner coils spaced further apart. In the majority of cases investigated, the spacing between the inner cancelling coils is roughly equal to the diameter of the outer cancelling coils. The axial spacing between each of the four coils is preferably also equal.
For main coils that are predominately long solenoids, a two coil shielding system tends to be optimal. As the aspect ratio of the main driving coils tends towards thin pancake coils the four coil solution tends to produce better shielding.

It is important to note that these are general principles and that the shielding coil parameters must then typically be further tuned to obtain an optimal solution. The wire selection, current density, shielding coil widths and number of turns, diameter and axial positions of the coil sets can all be varied to optimise for better shielding, lower cost and/or lighter weight devices.

It is important to note that the type of wire used and the current density of the active shielding coils can be adjusted to optimise the cost, weight and volume of the active shielding solution. Higher current densities generally require more expensive superconducting wire but at the same time reduce the total weight or volume of the device. Lower current densities allow for the use of cheaper superconducting wire or higher temperatures of operation but at the expense of higher overall weight of the device.

A preferred mechanism for effective transfer of current in the preferred embodiments of the electromagnetic turbines, is the employment of efficient liquid metal brushes between the rotating and stationary parts of the respective devices.

The basic operating principle of this particular aspect of the present invention namely the liquid metal current transfer brushes, is that current is transferred between a tongue shaped rotating element and a grooved stationary element (or vice versa) via a conductive fluid or liquid metal located therebetween and extending about the stationary element.

One of the more significant variations involves changes to the manner in which the liquid metal material is distributed around the brush and then preferably collected when the device is idle. It is possible to provide a device with a variably pressurised reservoir that is used to distribute the liquid metal material around the brush and also collect the liquid metal away from the rotating body.

In an alternative device, the liquid metal may be initially introduced into the assembly via fluid taps around the external perimeter of the inner and outer liquid metal brush assemblies. Initially, and when not rotating, the liquid metal preferably collects at the lowest point of the brush/rotor assembly contained by the preferred stationary liquid metal containment vessels and associated fluid seals between the walls of the containment vessels and in the rotating shaft.

When commencing operation, the liquid metal is normally progressively entrained in the groove created by the outer current collector ring through a combination of friction and centrifugal force. During operation, the liquid metal will generally be equitably distributed throughout the circumference of the rotor constrained between the tongue of the rotor and the groove of the stationary component of the brush.

Further additional preferred features of the device include the use of ceramic bearings to avoid distortions to the magnetic field caused by using steel or other ferrite based bearings and non-conducting shaft mounting points to provide electrical isolation between the shaft of the rotor (which normally conducts current) and the body of the device.

A further refinement is the mounting of the ceramic bearings on O-rings with a slight clearance fit in order to accommodate thermal expansion of the rotating shaft. Without this refinement, the differing rates of thermal expansion between the preferred aluminium shaft and the ceramic bearings may result in cracking and failure of the bearings.

The outer and inner liquid metal brush assemblies possess some improvements to aid in the assembly and performance of the brushes. The section of the rotor that forms a conductive tongue for the liquid metal brush assembly may be fastened to the rotating disc and shaft assembly allowing for differences in material construction to be explored. In one embodiment the disc/shaft assembly is made from aluminium with the rotor ‘tongues’ made from copper.

The stator ‘groove’ may be made from two copper halves allowing assembly over the rotor tongue. The stator groove assembly additionally preferably contains taps or drains to allow filling and drainage of the liquid metal material, as well as ports allowing the installation of thermal and other additional sensors.

The cross sectional shape of the preferred current carrying disc may be flared in order to aid the collection of the liquid metal material as the device is brought to rest. The liquid metal material preferably flows out of the preferred grooved outer radial channel and can then be directed to the inner radial collection grooves through the flaring on the rotor. Eventually the liquid metal collects at the lowest point of the device.

When the rotor and brush assembly is integrated with a superconducting magnet of the designs previously discussed, a complete motor or generator is formed.

A further key consideration for motor or generator devices incorporating the liquid metal brushes concerns the creation of practical devices for long term operation. In general, the performance of the liquid metal materials is degraded by the presence of oxygen and/or moisture. As a consequence it is often desirable for the liquid metal brush assembly to be housed in an inert gas environment (such as Argon gas preferably slightly above atmospheric pressure). A further improvement would be the use of a sealed containment vessel incorporating ferro-fluid seals between the rotating and stationery element of the rotor and the containment vessel.

Ferro-fluid seals will preferably achieve gas sealing through the use of a ferromagnetic fluid that is held between a stationary and a rotating surface by a permanent magnetic field. Ferro-fluid seals typically offer far longer service life and lower friction when compared with conventional seals.

The containment vessel could encapsulate the rotating disc, the rotating disc and a significant portion of the rotating shaft assembly, or the disc, shaft and the cryostat and magnetic coils.

In order to collect current from a rotating surface by means of a liquid metal medium, a ring channel between solid contacting surfaces will normally be fully filled by a liquid metal. The advantages of this method are uniformity of the current collection over the circumference of the rotor (and consequently the uniformity of the current flow in the rotor), and high achievable surface speeds and current densities which are impossible or impractical when conventional or advanced solid brushes are used. In the cases of moderate current densities, when recirculation of the liquid metal for the sake of cooling is not required, ring channel contact described as a “tongue and groove” contact can be constructed in a relatively straightforward manner.

In order to maximise the excellent electrical properties of the contact, it is important to choose optimal geometric properties of the rotor and its contact tip (tongue) and the stator and its ring channel (groove). These parameters are important, since mechanical losses from hydrodynamic friction substantially depend on tongue width and liquid metal gap thickness. In general there is a trade-off between the two conflicting requirements to minimise the electrical and mechanical losses. The wider the tip the lower the current density resulting in less heat released in the contact, however a wider tip substantially increases mechanical losses due to friction. Therefore optimisation of the contact tip width is required to obtain the minimum total loss in the contact.

An optimal gap thickness between contact surfaces in terms of minimising mechanical frictional losses can be derived from the following equation:

$${Δ}_{optimal} = C \frac{{D}_{tip}}{R {e}^{0.182}} ,$$

where C is constant derived from theoretical analysis and then experimentally corrected, Dₜᵢₚ is the contact tip diameter, Re is the hydrodynamic Reynolds number of the circular channel liquid flow, calculated by the contact tip diameter. For rotational movement Re is derived from the following well-known formula:

$$Re = \frac{{D}_{tip}^{2} ω}{v} ,$$

where ν is kinematic viscosity, and ω is angular velocity of the disk. In terms of mechanical and electrical losses, the thinner the liquid layer, the less electrical losses in the active zone of the current collector, however if the layer becomes too thin the mechanical losses suddenly become prohibitively high, which requires hydrodynamic aspects to be taken into account when determining the optimal gap.

Achieving an optimal design of the liquid metal current collector involves an optimization process to satisfy a number of conflicting requirements in order to reach minimal overall losses and highest performance. This is particularly the case when dealing with 100 kA class collectors with surface speeds exceeding 200 m/s.

Another important issue is contact resistance at the liquid-solid interface which can be typically ⅔ of the resistance of the liquid metal contact. Due to various chemical and electrochemical processes occurring in the active zone, various layers are formed at solid surfaces, increasing the resistance and thus reducing contact performance and stability over long periods of operation. A substantial reduction of contact resistance and increased chemical stability can be achieved by a proper choice of thin surface coating material applied to the solid surfaces of the liquid metal current collectors. For example, nickel coatings are known to work very well with mercury contacts and bare copper works well with NaK-alloys.

The following is a list of candidate materials for the various parts of the liquid metal brush assembly that will form part of the experimental activity concerning the liquid metal brushes. This experimental activity will seek optimal combinations of materials for the various components to minimise the mechanical, electrical, hydrodynamic and other losses.

### Contact Tip and Stator Materials:

Copper, aluminium or any other conductive materials possessing suitable mechanical strength.

### Coating Materials:

Nickel, Chromium, Rhodium, Cobalt, Gold and other noble metals.

### Liquid Mediums:

Mercury, Gallium, Gallium-Indium-Tin alloy, Sodium-Potassium alloys, Sodium or any other conductive materials in liquid form.

In addition to the above material options, the effect, of surface finish on the efficiency and performance of the liquid metal brush assemblies should be accounted for.

The above lists are an indication of the type of materials to be employed and are not exhaustive. It should be clear to a person skilled in the art that other materials with similar electrical and chemical properties could be substituted or utilised in each of the above listed sections.

One further variation involves the use of Graphene material as a coating on parts of the rotating and stationary assemblies, particularly in the region of the liquid metal brushes. Graphene is a crystalline form of carbon where the carbon atoms are arranged in a regular hexagonal pattern that is one atomic layer thick.

Coating parts of the motor/generator with Graphene can strengthen the mechanical structure, and at the same time increase the electrical conductivity and thermal conductivity of different parts of the motor/generator. Graphene can also reduce the friction at the boundary between static and moving parts and the liquid metals, i.e., sodium potassium alloy, lithium metal, sodium metal, gallium-indium-tin eutectic alloy, GaInSn (Galinstan), and gallium metal. The electrical properties could also be improved at the solid/liquid-metal interface. These improvements due to the incorporation of Graphene coating in the system results in reduced mechanical, hydrodynamic and electrical losses as well as a reduction in the weight of the overall system.

The reference to any prior art in this specification is not, and should not be taken as an acknowledgement or any form of suggestion that the prior art forms part of the common general knowledge.

### BRIEF DESCRIPTION OF DRAWINGS

In order that this invention may be more readily understood and put into practical effect, reference will now be made to the accompanying drawings, which illustrate preferred embodiments of the invention, and wherein:

FIGS. 1A, 1B depict sectional views of a turbine for use as a generator according to one embodiment of the present invention;

FIGS. 2A, 2B depict sectional views of a turbine for use as a generator according to one embodiment of the present invention;

FIG. 3 is a sectional view of a turbine for use as a generator according to one embodiment of the present invention;

FIGS. 4A, 4B depict sectional views of a turbine for use as a generator according to one embodiment of the present invention;

FIG. 5A is a sectional view of a turbine for use as a generator employing liquid metal brushes according to one embodiment of the present invention;

FIG. 5B depicts the construction of the rotor and stator employing liquid metal brushes for the generator of FIG. 5A in greater detail;

FIGS. 6A, 6B depict sectional views of a turbine employing DC-DC conversion for use as a generator according to one embodiment of the present invention;

FIGS. 7A to 7C are plots of the magnetic field produced by the turbine of FIGS. 6A and 6B using a particular type of superconducting material;

FIGS. 8A, SB depict the arrangement of the brushes of the turbine of FIGS. 6A and 6B.

FIG. 9 is a sectional view of the turbine of FIGS. 6A and 6B depicting the high and low current circuits within the turbine;

FIG. 10 is a field plot of the magnetic field produced by the turbine of FIGS. 6A and 6B using a particular type of superconducting material;

FIG. 11 is a sectional view of a turbine employing DC-DC step-up conversion for use as a generator according to one embodiment of the present invention

FIG. 12 is a sectional view of the turbine of FIG. 11 depicting the high and low current circuits within the turbine;

FIGS. 13A to 13C are plots of the magnetic field produced by the turbine of FIGS. 11 and 12 using a particular type of superconducting material;

FIG. 14 is a plot of the magnetic field produced by the turbine of FIGS. 11 and 12 using a particular type of superconducting material;

FIGS. 15A, 15B depict sectional views of a turbine employing DC-DC conversion for use as a generator according to one embodiment of the present invention;

FIGS. 16A to 16C are plots of the magnetic field produced by the turbine of FIGS. 15A and 15B using a particular type of superconducting material;

FIG. 17 depicts a sectional view of a turbine employing DC-DC step-up conversion for use as a generator according to one embodiment of the present invention;

FIG. 18 depicts a sectional view of a turbine employing DC-DC step-up conversion for use as a generator according to one embodiment of the present invention;

FIG. 19 depicts a sectional view of a turbine employing DC-DC step-up conversion for use as a generator according to one embodiment of the present invention;

FIG. 20 is a plot of the magnetic field produced by the turbine of FIG. 19 using a particular type of superconducting material;

FIG. 21 is a detailed view of a section of the field plot of FIG. 20;

FIG. 22 is a detailed view of a section, of the field plot of FIG. 20;

FIGS. 23A, 23B depict sectional views of a turbine for use as a generator according to one embodiment of the present invention;

FIGS. 24A and 24B are plots of the magnetic field produced by the turbine of FIGS. 23A and 23B for different coil configurations;

FIGS. 25A, 25B depict sectional views of a turbine for use as a generator according to one embodiment of the present invention;

FIG. 26 is a plot of the magnetic field produced by the turbine of FIGS. 25A and 25B;

FIGS. 27A, 27B depict sectional views of a turbine for use as a generator according to one embodiment of the present invention;

FIG. 28 is a plot of the magnetic field produced by the turbine of FIGS. 27A and 27B;

FIG. 29 is a cross sectional view depicting one possible arrangement for connecting multiple turbines to increase output voltage according to one embodiment of the present invention;

FIG. 30 is a field plot of a two turbine generator configuration showing alternate current paths for alternate rotor configurations;

FIG. 31 depicts sectional view of a turbine employing DC-DC step-up conversion for use as a generator according to one embodiment of the present invention;

FIGS. 32A and 32B depict sectional views of a turbine employing DC-DC step-down conversion for use as a motor/generator according to one embodiment of the present invention.

FIGS. 33A and 33B depict sectional views of a dual rotor motor/generator according to an embodiment of the present invention.

FIGS. 34A and 34B are field plots of the dual rotor motor/generator illustrated in FIGS. 33A and 33B.

FIGS. 35A and 35B depict sectional views of a dual rotor motor/generator with a shortened interconnect according to an embodiment of the present invention.

FIGS. 36A and 36B are field plots of the dual rotor motor/generator illustrated in FIGS. 35A and 35B.

FIGS. 37A and 37B depict sectional views of a dual stage generator with cancelling solenoids to create a null field region according to an embodiment of the present invention.

FIGS. 38A, 38B and 38C are field plots of the dual stage generator illustrated in FIGS. 37A and 37B.

FIGS. 39A and 39B depict sectional views of a multistage step up or step down, of speed and/or voltage/current device according to a preferred embodiment of the present invention.

FIGS. 40, 40A and 40B are field plots of the multistage rotor motor/generator illustrated in FIGS. 39A and 39B.

FIGS. 41A and 41B depict sectional views of a laminated low speed rotor device connected in series with separation between the low speed and high-speed sections according to an embodiment of the present invention.

FIG. 42A is an exploded isometric view of the mechanical components and FIG. 42B of the current paths of a low speed mechanical input to high voltage electrical DC output device according to an embodiment of the present invention.

FIG. 43A is an exploded isometric view of the mechanical components and FIG. 43B of the current paths of a high voltage DC input to low speed mechanical output device according to an embodiment of the present invention.

FIG. 44A is an exploded isometric view of the mechanical components and FIG. 44B of the current paths of a low speed mechanical input to an AC generator device according to an embodiment of the present invention.

FIG. 45A is an exploded isometric view of the mechanical components and FIG. 45B of the current paths of an AC motor to low speed mechanical output device according to an embodiment of the present invention.

FIG. 46A is an exploded isometric view of the mechanical components and FIG. 46B of the current paths of a homopolar electromagnetic gearbox (low speed to high-speed) device according to an embodiment of the present invention.

FIG. 47A is an exploded isometric view of the mechanical components and FIG. 47B of the current paths of a homopolar electromagnetic gearbox (high speed to low speed) device according to an embodiment of the present invention.

FIG. 48 is a sectional isometric view of an electromagnetic power converter low voltage DC to high voltage DC device according to a preferred embodiment.

FIG. 49 is a sectional isometric view of an electromagnetic power converter high voltage DC to low voltage DC device according to a preferred embodiment.

FIG. 50 is a sectional isometric view of an electromagnetic power converter DC input to AC output device according to a preferred embodiment.

FIG. 51 is a sectional isometric view of an electromagnetic power converter AC input to DC output device according to a preferred embodiment.

FIG. 52 is a sectional side view of a preferred liquid metal brush sealing arrangement according to a preferred embodiment of the present invention.

FIG. 53 is a schematic illustration of a preferred use of a DC output generator according to a preferred embodiment of the present invention in an energy generation and storage consideration.

FIG. 54 is a sectional illustration of a variation to the previously presented multistage variation with revised cancelling coils.

FIG. 55 is a schematic illustration of the variation illustrated in FIG. 54 showing the high and low current paths.

FIG. 56 is a field plot of the turbine illustrated in FIG. 54 with the null field regions below 0.2 T circumscribed by freeform lines in green.

FIG. 57 is a field plot of the outer coil region of the turbine illustrated in FIG. 54 with the null field regions below 0.2 T circumscribed by freeform lines in green.

FIG. 58 is a field plot of the inner cancelling coil region of the turbine illustrated in FIG. 54 with the null field regions below 0.2 T circumscribed by freeform lines in green.

FIG. 59 is a schematic illustration of a turbine generator of a preferred embodiment used in conjunction with a torque equaliser system

FIG. 60 is a cutaway side view of the arrangement illustrated in FIG. 59.

FIG. 61 is a detail view of the torque equaliser system illustrated in FIG. 59.

FIG. 62 is a section 3D view of a counter rotating turbine generator with two independent sections and indicating the opposing directions of input torque.

FIG. 63 is a sectional view of the turbine generator illustrated in FIG. 62.

FIG. 64 is an illustration of the high and low current paths through the Independent, counter rotating stages of the turbine generator illustrated in FIG. 62.

FIG. 65 is an overview field plot of the coil system used in the turbine generator illustrated in FIG. 62 with the areas circumscribed by freeform lines being regions where the field strength is below 0.2 T.

FIG. 66 is a half sectional field plot of the coil assembly used in the turbine generator illustrated in FIG. 62 showing the magnetic field.

FIG. 67 is a detailed sectional field plot view of the outer coil assembly of the turbine generator illustrated in FIG. 62.

FIG. 68 is a detailed sectional field plot view of the inner coil assembly of the turbine generator illustrated in FIG. 62.

FIG. 69 is a sectional elevation view of a multi-MW direct drive wind turbine generator according to a preferred embodiment of the present invention.

FIG. 70 is an illustration of the high and low current paths through the wind turbine generator illustrated in FIG. 69.

FIG. 71 is an overview of the magnetic field of the wind turbine generator illustrated in FIG. 69.

FIG. 72 is a half sectional field plot of the wind turbine generator illustrated in FIG. 69.

FIG. 73 is a detailed field plot of the outer coil assembly of the wind turbine generator illustrated in FIG. 69 with the area circumscribed by a freeform line being a region below 0.2 T.

FIG. 74 is a detailed field plot of the inner cancelling coil assembly of the wind turbine generator illustrated in FIG. 69 with the area circumscribed by freeform lines being a region below 0.2 T.

FIG. 75 is a sectional elevation view of a multi-MW wind turbine generator according to a preferred embodiment of the present invention.

FIG. 76 is an illustration of the high and low current paths through the wind turbine generator illustrated in FIG. 75.

FIG. 77 is a field plot for the wind turbine generator illustrated in FIG. 75 showing magnetic field vectors and the areas circumscribed by freeform lines where the field strength is below 0.2 T.

FIG. 78 is a sectional elevation view of a variation of the wind turbine generator illustrated in FIG. 75 including the addition of an inter-stage torque/rpm equaliser.

FIG. 79 is a sectional isometric view of the wind turbine generator illustrated in FIG. 78.

FIG. 80 is a detail sectional isometric view of a central portion of the wind turbine generator illustrated in FIG. 79 and indicating the relative directions of applied input torque.

FIG. 81 is an illustration of the high and low current paths through the wind turbine, generator illustrated in FIG. 78.

FIG. 82 is a drum configuration wind turbine generator incorporating a drum, style electromagnetic power converter to provide final high voltage output according to a preferred embodiment of the present invention.

FIG. 83 is an illustration of the high and low current paths through the wind turbine generator illustrated in FIG. 82.

FIG. 84 is an overall field plot of the superconducting coil arrangement of the drum style generator illustrated in FIG. 82 with inner cancelling coils that produce the inner null field regions circumscribed by freeform lines.

FIG. 85 is a detailed view of the null field region at the centre of the outer drive coils of the generator illustrated in FIG. 82 with a null field region indicated.

FIG. 86 is a schematic illustration showing the magnetic field vectors of the main driving field produced by the outer solenoid along the drum element of the embodiment illustrated in FIG. 82.

FIG. 87 is a schematic illustration of the field vectors in the region around the inner cancelling coil and the high-speed motor section of the generator illustrated in FIG. 82.

FIG. 88 is a sectional schematic illustration of a drum style wind turbine generator with a radial element electromagnetic power converter according to a preferred embodiment.

FIG. 89 is an illustration of the high and low current paths and connections in the embodiment illustrated in FIG. 88.

FIG. 90 is a 3 coil assembly variation of the drum style wind turbine generator illustrated in FIGS. 82 and 88 including a drum style electromagnetic power converter.

FIG. 91 is an illustration of the high and low current paths through the variant generator illustrated in FIG. 90.

FIG. 92 is an overall field plot illustrating the drive and cancelling coils for the variant generator illustrated in FIG. 90.

FIG. 93A is a schematic view of a generation one high-speed turbine according to a preferred embodiment of the present invention.

FIG. 93B is a schematic view of a generation two high-speed turbine according to a preferred embodiment of the present invention showing possible design variations when compared to a generation one turbine shown in FIG. 93A.

FIG. 94 is a detailed schematic view of a portion of the generation two turbine illustrated in FIG. 93B.

FIG. 95 is a field plot of the typical coil layout and null field regions for the generation two turbine illustrated in FIG. 93B.

FIG. 96 is a field plot of a smaller diameter variation of the generation two turbine illustrated in FIG. 93B with the outer cancelling coils removed.

FIG. 97 is a schematic illustration of the basic layout of a second generation electromagnetic converter according to a preferred embodiment.

FIG. 98 is a field plot showing the null field areas circumscribed by freeform lines in, the converter illustrated in FIG. 97.

FIG. 99 is a schematic illustration of a drum/radial hybrid motor/electromagnetic converter with alternate coil design according to a preferred embodiment.

FIG. 100 is a field plot showing the null field areas circumscribed by freeform lines in the embodiment illustrated in FIG. 99.

FIG. 101 is a sectional schematic view of a further embodiment of the generation two high-speed turbine according to a preferred embodiment.

FIG. 102 is a field plot showing the null field areas circumscribed by freeform lines and drive field present in the embodiment illustrated in FIG. 101.

FIG. 103 is a sectional schematic view of yet a further embodiment of the generation two high-speed turbine according to a preferred embodiment.

FIG. 104 is a field plot showing the null field areas circumscribed by freeform lines and drive field present in the embodiment illustrated in FIG. 103.

FIG. 105 is a sectional schematic view of still a further embodiment of the generation two high-speed turbine according to a preferred embodiment.

FIG. 106 is a sectional schematic view of a further embodiment of the generation two high-speed turbine with alternate rotor shape, position and cryostat layout according to a preferred embodiment.

FIG. 107 is a sectional schematic view of a further embodiment of the generation two high-speed turbine with alternate rotor shape, position and cryostat layout according to a preferred embodiment.

FIG. 108 is a magnetic field distribution image of a radial style disc device similar to that shown in FIGS. 23A and 23B excluding the tertiary cancelling coils.

FIG. 109 is a magnetic field distribution image of the device illustrated in FIGS. 23A and 23B employing active shielding using two shielding coils.

FIG. 110 is a magnetic field distribution image of the device illustrated in FIGS. 23A and 23B but modified to employ active shielding using four shielding coils.

FIG. 111 is a sectional view of the device illustrated in FIGS. 23A and 23B but with four additional active cancelling coils in the context of a disc style radial device.

FIG. 112 is a magnetic field distribution image showing the 5 Gauss and 200 Gauss lines of a drum style axial device similar to that illustrated in FIG. 82 without the use of active cancelling coils.

FIG. 113 is a magnetic field distribution image showing the 5 Gauss and 200 Gauss lines of a drum style axial device similar to that illustrated in FIG. 82 with the use of two active cancelling coils.

FIG. 114 is a sectional view of the device producing the field shown in FIG. 113 showing the positioning of the two additional active cancelling coils.

FIG. 115 shows the 5 Gauss and 200 Gauss lines of a drum style axial device similar to that illustrated in FIG. 82 modified to include four active cancelling coils.

FIG. 116 is a sectional view of the device producing the field shown in FIG. 115 showing the positioning of the four additional active cancelling coils.

FIG. 117 shows the 5 Gauss and 200 Gauss lines of a multi-stage radial style disc device similar to that shown in FIG. 69 without active shielding.

FIG. 118 shows the 5 Gauss and 200 Gauss lines of a multi-stage radial style disc device similar to that shown in FIG. 69 with active shielding using two shielding coils.

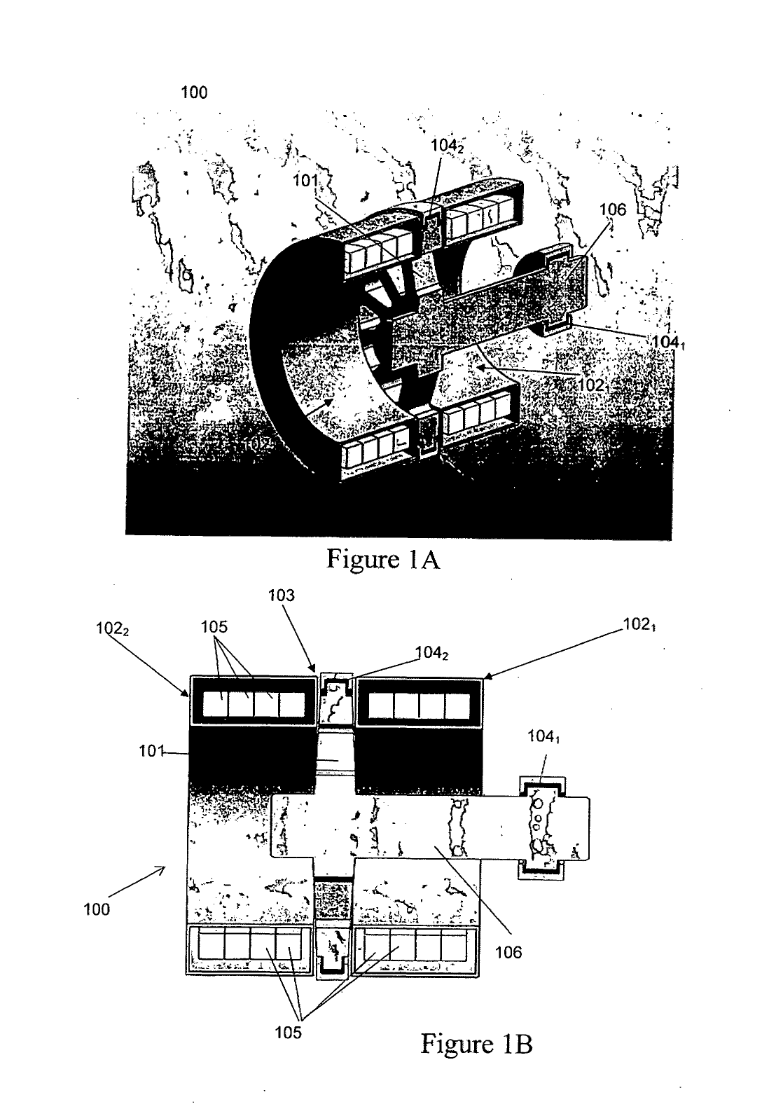

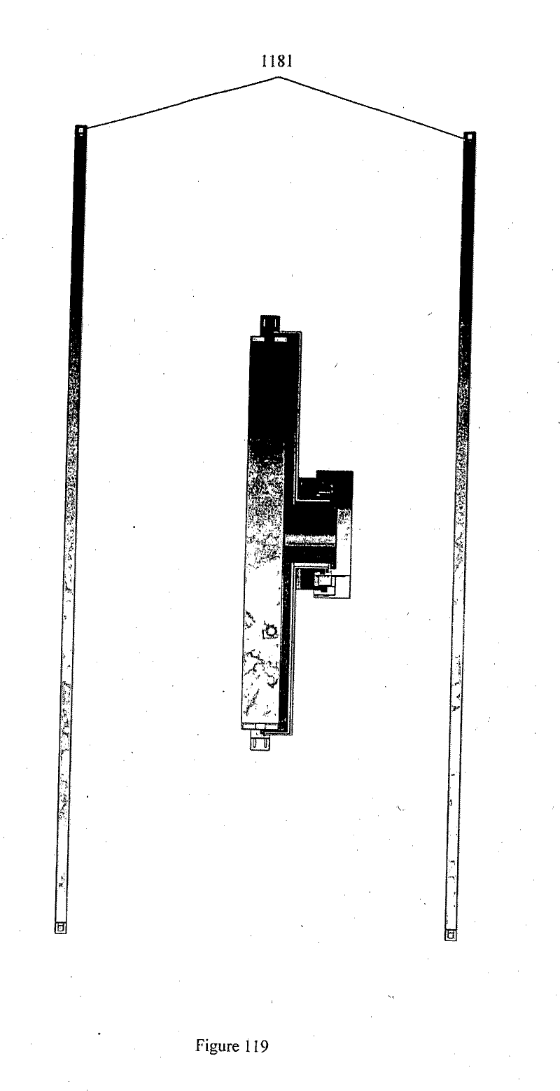

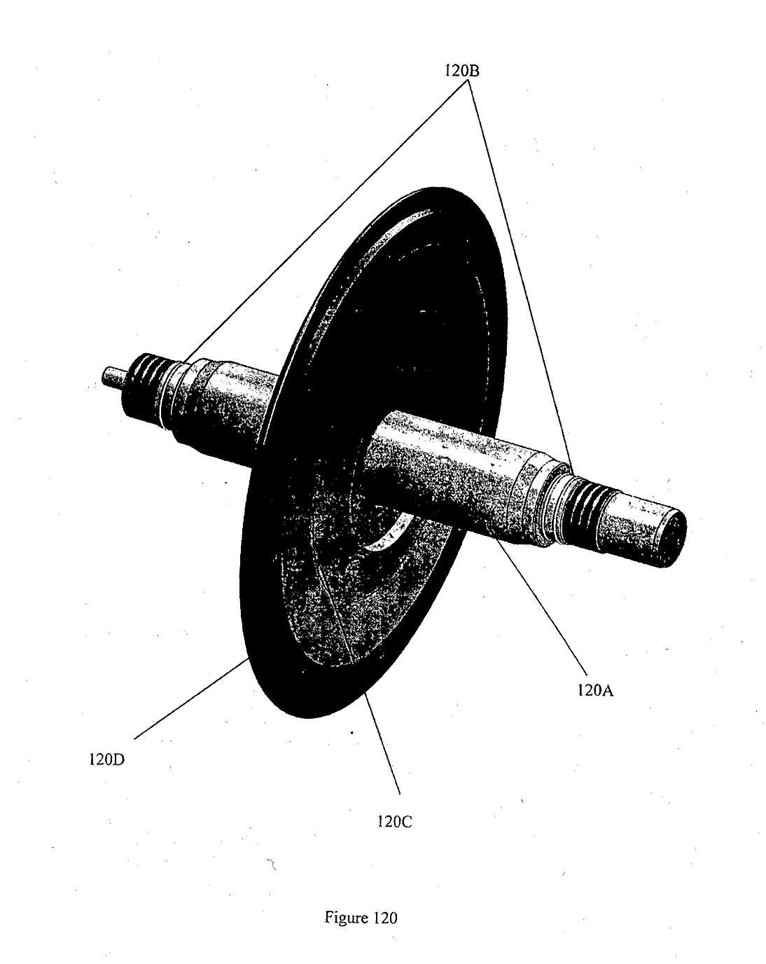

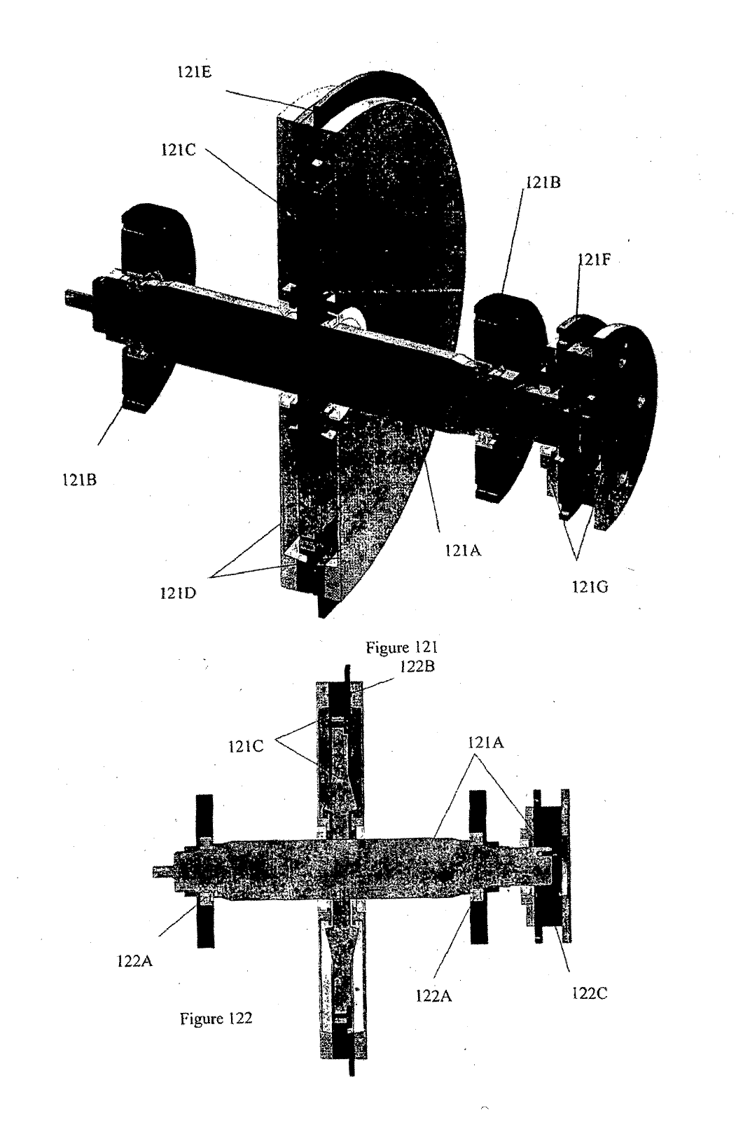

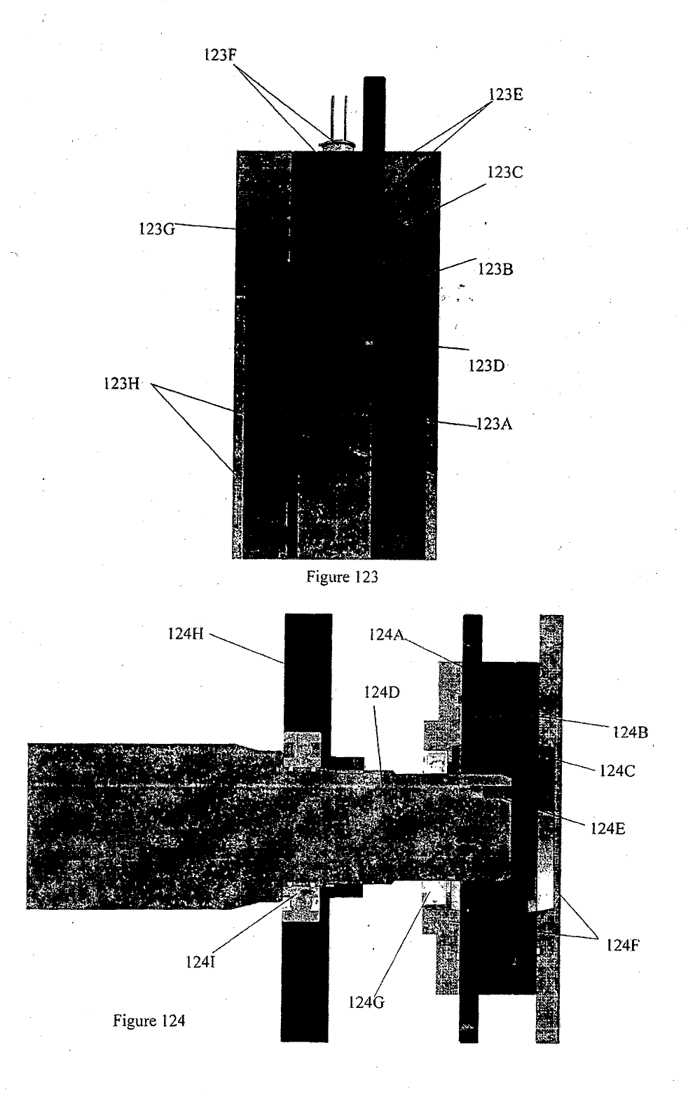

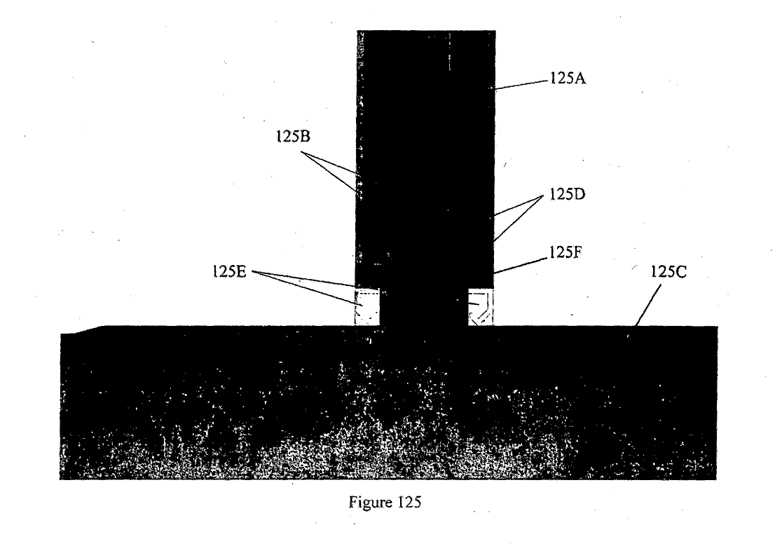

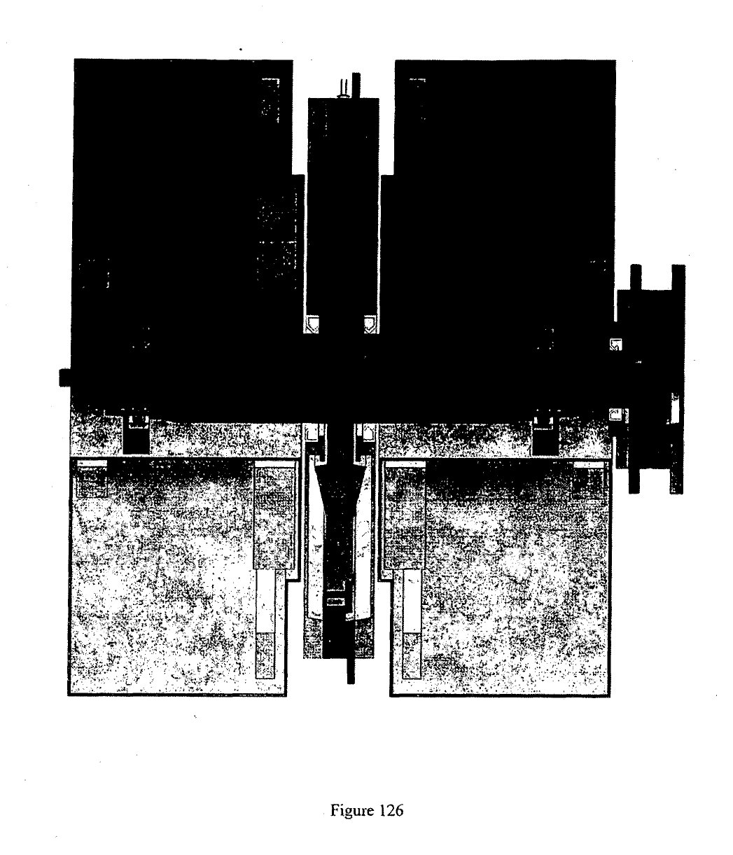

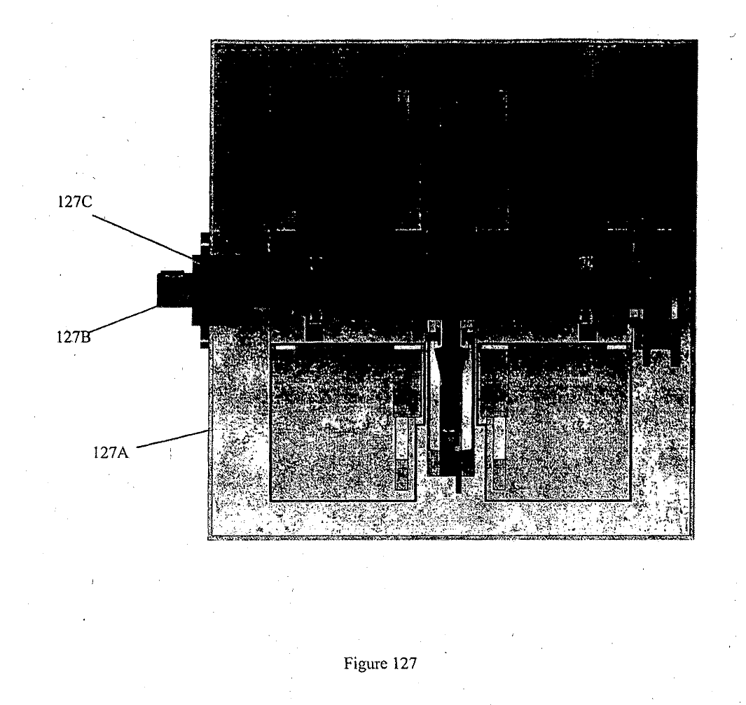

FIG. 1.19 is a sectional view of the device producing the field shown in FIG. 118 showing the positioning of the two additional shielding coils.

FIG. 120 is an isometric view of a main rotating disc and shaft assembly with tongue shaped outer ring forming one half of a Liquid metal brush assembly according to a preferred embodiment.

FIG. 121 is a sectioned isometric view of a full rotor and both inner and outer liquid metal brush assemblies according to a preferred embodiment including the containment walls for the liquid metal material.

FIG. 122 is a sectional front elevation view of the configuration illustrated in FIG. 121.

FIG. 123 is a sectional detailed view of the outer liquid metal brush assembly illustrated in FIG. 122.

FIG. 124 is a sectional detailed view of the inner liquid metal brush assembly illustrated in FIG. 122.

FIG. 125 is a sectional view of a preferred embodiment of a rotating disc/shaft assembly showing the flared disc section.

FIG. 126 is a sectional view of complete rotor and brush assemblies with the drive magnet and cryostat boundaries according to a preferred embodiment of the present invention.

FIG. 127 shows one possible implementation where the sealed inert environment is created around the rotor and cryostat assemblies with the final output shaft sealed using a low wear, Ferro-fluid seal.

### DESCRIPTION OF EMBODIMENTS

With reference to FIG. 1A there is illustrated one possible configuration of an electromagnetic turbine for use as a generator 100 according to one embodiment of the present invention. The basic generator layout consists of a conductive disc 101 rotating in a magnetic field that is orientated in the direction of the disc's rotational axis. The magnetic field in the basic layout is created by two superconducting solenoids 102₁, 102₂ circulating a DC current in the same direction separated by a gap 103. The rotor 101 is positioned in the centre of this gap 103 to utilise the null field area created for the placement of liquid metal brush, 104₂. As the disc 101 is rotated by an external power source a voltage is developed between the inner 104₁ and outer 104₂ liquid metal current collectors. When the arrangement is connected to a suitable electric load current flows from the disc to the load. In this way the mechanical input energy is converted into electrical energy.

A more detailed view of the construction of the turbine is shown in FIG. 1B. As shown the superconducting solenoids 102₁, 102₂ are composed of a series of superconducting coils 105. The current flows from the outer liquid metal brush 104₂ from the outer radius of the rotor element to the inner radius and along the axis of the conducting shaft 106 out through the inner liquid metal brush assembly 104₁.

The gap 103 between the solenoids 102₁, 102₂ in this instance enables the production of a region of field cancellation or electromagnetic field null. As will be appreciated by those of skill in the art that the operation of both metal fibre and liquid metal brushes is adversely affected by exposure to high/strong magnetic fields, in each case the exposure to such large fields can significantly reduce the current carrying capacity. The creation of a null field provides a region in which the liquid metal brushes can be positioned to operate effectively without degradation in current carrying capacity. In the present example the outer liquid metal brush 104₂ assembly is positioned within the gap 103 while the inner liquid metal brush 104₁ assembly is located outside the field produced by the solenoids so as be located in a region where the field density is low (ideally below 0.2 T).

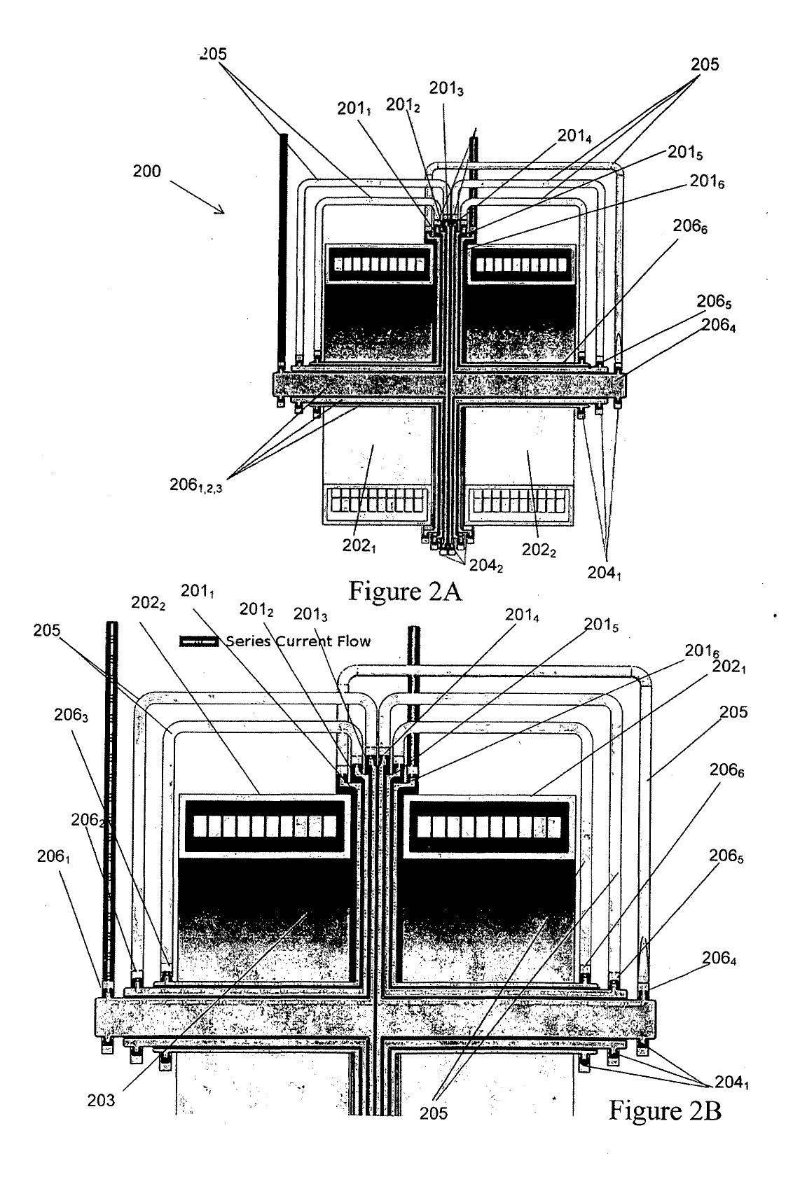

FIGS. 2A and 2B depict a one possible configuration of, an electromagnetic turbine for use as a generator 200 according to one embodiment of the present invention. As shown the turbine is of a similar construction to that of FIGS. 1A and 1B in that it again employs two superconducting solenoids 202₁, 202₂ separated by a gap 203 with rotor 201 disposed therein. The rotor 201 in this instance is a laminated structure. The laminated rotor 201 consists of a number of lamination layers including disc elements 201₁, 201₂, 201₃, 201₄, 201₅ and 201₆ attached to corresponding cylinder elements 206₁, 206₂, 206₃, 206₄, 206₅ and 206₆, the cylinder elements forming the turbine's conductive output shaft 206. Between each of the individual layers of the rotor 201 a non-conducting material is disposed to a strong mechanical connection between the laminations while retaining electrical isolation between the conducting layers.

The laminated sections of the rotor structure 201 are in this example connected in series, through liquid metal current collectors 204. A more detailed view of the interconnections between the rotor sections is shown in FIG. 2B. As can be seen each lamination layer has an input and output set of liquid metal brushes 204. The brushes 204 are coupled together to form a series circuit via current return interconnects 205 which enables the current to be returned from the outside brush 204₂, to the inner brush 204₁ of adjacent lamination layers.

As in the case of the turbine of FIGS. 1A and 1B, the outer brushes 204₂ are positioned within the null field region created within gap 203. The inner brushes 204₁ are again positioned outside of the solenoids in regions where the field density is low (ideally below 0.2 T).

The purpose of the laminated designs is to allow the voltages generated in the individual rotor laminations to be added together in series so as to make the final output voltage better suited to its final load (i.e. power electronics, grid connection, motor supply etc.). In addition by connecting the lamination layers in series in this manner it is possible for the output voltage of the generator to be increased and the working current lowered within the same power envelope.

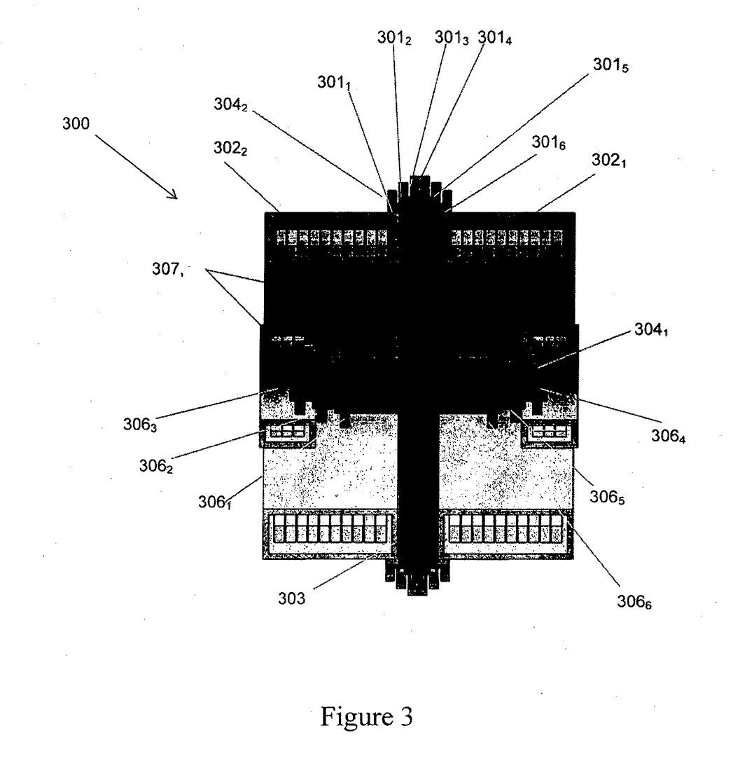

FIG. 3 depicts an alternate construction of an electromagnetic turbine for use as a generator 300 employing a laminated rotor 301. As in the case of FIGS. 2A and 2B, the laminated rotor 301 consists of a number of lamination layers including disc elements 301₁, 301₂, 301₃, 301₄, 301₅ and 301₆ attached to corresponding cylinder elements 306₁, 306₂, 306₃, 306₄, 306₅ and 306₆, the cylinder elements forming the turbine's conductive output shaft 306. Between each of the individual layers of the rotor 301 a non-conducting material is disposed to create a strong mechanical connection between the laminations while retaining electrical isolation between the conducting layers.

Again the rotor 301 is disposed within gap 303 disposed between superconducting solenoids 302₁, 302₂ to enable the outer brushes 304₂ to be positioned within the null field region produced within gap 303. In this example however the overall length of the laminated rotor 301 is reduced through the addition of cancelling coils 307. The cancelling coils 307 create additional null field regions for the placement of the inner current collectors 304₁. These cancelling coils 307 can be a superconducting wire winding or alternatively bulk superconducting material. In the case where a bulk superconductor is used, the outer solenoids 302₁, 302₂ can be used to create the bulk superconductor field by being operated at rated current (in the reverse direction) when the inner bulk material is being cooled down to operating temperature. The idea is to exploit the perfect diamagnetism of the bulk superconducting material. When the external source current is removed (i.e. the outer superconducting coils are discharged) a persistent field remains in the bulk superconductor. This persistent field becomes the cancelling field when the superconducting coils are charged in the usual current direction.

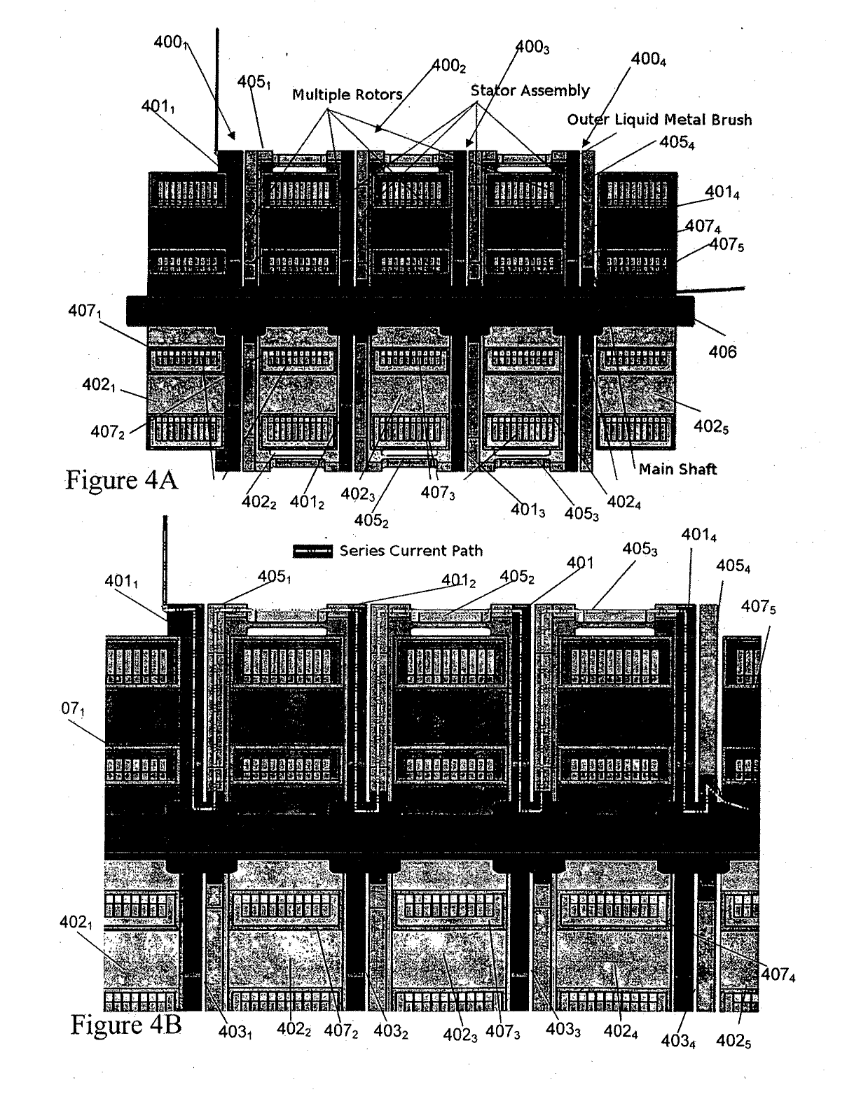

FIG. 4A depicts one possible construction of an electromagnetic turbine for use as a generator. In this example the generator is composed of multiple generator elements 400₁, 400₂, 400₃ and 400₄ connected together in series. As in the above examples each generator element includes a rotor 401₁, 401₂, 401₃, 401₄ disposed within gaps 403₁, 403₂, 403₃, 403₄ provided between primary solenoids 402₁, 402₂, 402₃, 402₄ and 402₅ which are utilised to generate the primary magnetic field in which the rotors are spun. The rotors 401₁, 401₂, 401₃, 401₄ are connected in series via the use of stators 405₁, 405₂, 405₃, 405₄. Current is transferred between the rotors and across the stators via a set of sliding metal contacts.

A series of cancelling coils 407₁, 407₂, 407₃, 407₄, 407₅ are disposed within the primary solenoids 402₁, 402₂, 402₃, 402₄ and 402₅. These inner coils produce both an increase in the density and uniformity of the magnetic field within the working radius and create a series of field nulls within the inner diameter of the cancelling coils in which liquid metal brushes could be suitably located.

As the rotors are mechanically rotated on shaft 406 that is electrically isolated from the rotors, current flow is induced through the rotor-stator pairings. A detailed view of the current path through the generator in shown in FIG. 4B. The advantage of serially connecting multiple rotors is the increased final generated output voltage. In general, higher voltages make efficient extraction of the generated power and coupling to downstream power electronics more straight forward.

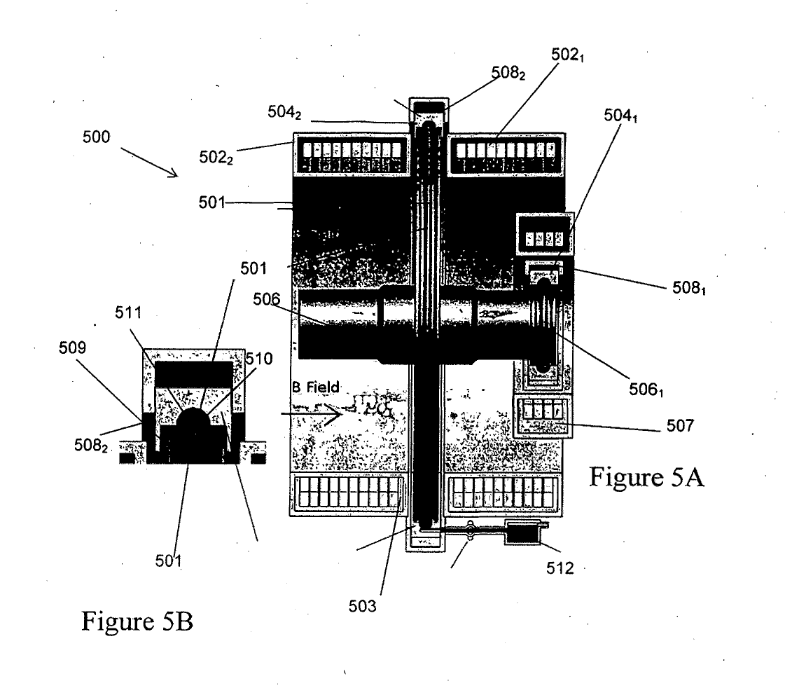

As noted above a number of generator designs utilise liquid metal brushes as current transfer mechanism. FIGS. 5A and 5B show in greater detail, the construction of a rotor and generator employing liquid metal brushes. As shown in FIG. 5A, the generator 500 includes rotor 501 mounted on shaft 506. The rotor 501 is again disposed within the null field region provided within the gap 503 between solenoids 502₁, 502₂. The rotor in this instance is encapsulated within a stator frame 508₂ which houses the outer liquid metal brush 504₂. In this particular example a cancelling coil 507 is employed, the cancelling coil is position adjacent the end of solenoid 502₁ and about the inner liquid metal brush 504₁. The inner liquid metal brush 504₁ is housed within stator frame 508₁ which is positioned within the cancelling coil 507 and about the end of shaft 506.

To accommodate the use of liquid metal brushes 504₁, 504₂, the rotor 501 and the portion of the shaft which engages the outer brush are formed with a grooved slip ring 509 as shown in FIG. 5B. The stator ring 508₂ has a corresponding groove 510 that forms a small channel for the liquid metal 511 to occupy. The liquid metal then forms an electrical connection between the stator ring and rotor through which current can be passed.

Typically liquid metals are reactive with moisture and oxygen in the air and require sealing within an inert gas environment. The above grooves 509, 510 and channel along with sealing system are designed to contain the liquid metal which experiences centrifugal forces when rotating. As can be seen in FIG. 5A, the liquid metal 511 filling the groove 510 in stator 508₂, is supplied from a reservoir 512 under variable pressure which is used to inject and recover liquid metal. The liquid in this reservoir 512 can also be cooled using an external heat exchanger and the liquid recirculated using a pumping system through the contact channel 510. In this way the cooling system can also remove heat from the rotor and stator system. A typical current collection system may also comprise cooling channels for water or other cooling fluids to be circulated about the stator ring, ensuring the stator, liquid metal and rotor remain at a stable operating temperature.

In the above example the current generated is drawn off directly to the load or to down stream power electronics etc. The utilisation of the produced current and voltage is a relatively simple procedure in cases where the generator is run at high speed (i.e. drive shaft is mechanical driven at high speed) as the generator at high speed produces high voltage and low current. The current and voltage produce is dependent on a number of factors such as the primary magnetic field strength. B etc. Current configurations of generators of the type discussed above are capable at high rotational speed to produce voltages in the order of 1 kV or more and current of around 500 A.

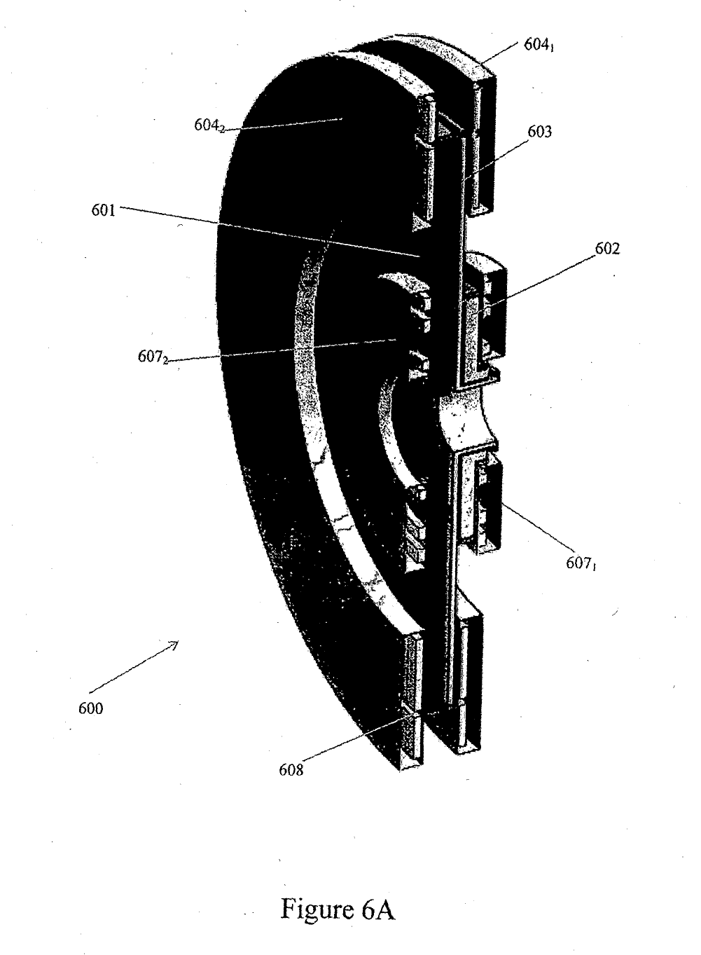

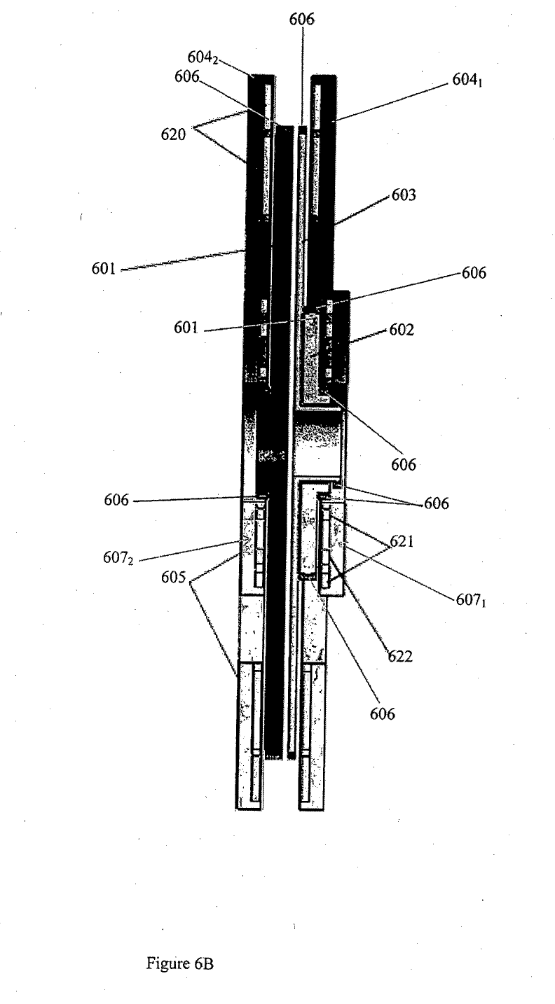

However, in instances where the generator is driven at comparatively low speeds, the voltages produced are relatively low in the order of 20V-60V and the current is in the order of a 0.5 MA. In such cases the power electronics needed to produce useful electricity are relatively complex, bulky and expensive. FIG. 6A depicts one possible configuration of a turbine 600 for use as a generator according to on embodiment of the present invention for use in low speed direct drive applications. As shown the turbine 600 in this case includes a pair of superconducting drive coils 604₁, 604₂ for the production the primary magnetic field. Disposed between the drive coils 604₁, 604₂ are a low speed generator stage 601 which may be connected to a low speed drive (i.e. typical drive speed 5-20 rpm) and a high speed generator stage 603 (i.e typical drive speed 300-600 rpm).

The low speed stage 601 typically develops low voltage and high current which needs significant power electronics to be fed into the grid. To convert the voltage and current to useful levels for the grid, the low voltage high current produced by the low speed generator stage is used to drive an intermediate stage 602 in the form of a high speed motor which directly drives the high speed generator stage 603. The high speed generator stage 603 produces a high voltage low current DC power that can be more readily utilised by the grid. The high speed motor in this instance is of a type discussed in the Applicant's earlier international application PCT/AU2012/000345 and PCT/AU2012/000346 which are herein incorporated by reference in their entirety.

As will be apparent from the above discussion the low speed 601 and high speed 603 stages are not mechanically connected and can rotate independently of one another. The high speed motor stage & high speed generator stage are mechanically coupled but electrically isolated from one another. The output terminals of the low speed generator are connected to the input terminals of the high speed motor intermediate stage. Depending on the wiring configuration the low speed stage and high speed stages may rotate in the same or opposite directions.

As noted above the EMF produced between the centre and outside diameter of a rotating disc, radius R, at rotational speed ω in uniform magnetic field B is given by:

$$ɛ = {\int }_{0}^{R} Br ω d r = \frac{{R}^{2}}{2} B ω$$

For the low speed generator parameters are as follows:
R_{lsg}=Radius of low speed generator
B_{lsg}=Magnetic field of low speed generator (assumed to be uniform in this case)
ω_{lsg}=Angular velocity of low speed generator
ε_{lsg} EMF generated by low speed generator=0.5*R_{lsg}²*B_{lsg}*ω_{lsg}

P_{lsg}=Input power into low speed generator

I_{lsg}=Current collected from low speed generator neglecting losses

As noted above the electrical output of the low speed generator is fed into the high speed motor having the following parameters:
Rₕₛₘ=Radius of high speed motor
Bₕₛₘ=Magnetic field of high speed motor (assumed to be uniform in this case)
Pₕₛₘ=Power into high speed motor=P_{lsg} (neglecting losses)
Iₕₛₘ=Current input into high speed motor=I_{lsg} (neglecting losses)
ξₕₛₘ EMF into high speed motor=ω_{lsg}
ωₕₛₘ=Angular velocity of high speed motor=2*ε_{lsg}/(Rₕₛₘ*Bₕₛₘ)

As can be seen from the above the angular velocity of the high speed motor is then a function of the radius and magnetic field of the high speed motor intermediate stage. Given this relationship it is possible to increase the rotational speed of the high speed motor intermediate stage relative to the low speed generator stage by decreasing the radius and/or applied magnetic field of the high speed motor intermediate stage relative to the low speed generator stage.

As an example case, if Rₕₛₘ=R_{lsg}/10 & B_{lsg}=Bₕₛₘ

εₕₛₘ=ε_{lsg}=0.5*R_{lsg}²*B_{lsg}*ω_{lsg}=0.5*Rₕₛₘ²*Bₕₛₘ*ωₕₛₘ

Cancelling, R_{lsg}²*ω_{lsg}=Rₕₛₘ²*ω_{hsm and} Substituting Rₕₛₘ=R_{lsg}/10 gives

R_{lsg}²*ω_{lsg}=(R_{lsg}/10)²*ωₕₛₘ

ωₕₛₘ=100*ω_{lsg}

The input speed of the low speed generator is multiplied 100 times in the high speed motor due to the factor of 10 difference in radius size for this example. The magnetic field can also be used to manipulate the speed of the high speed motor intermediate stage in a similar manner.

As the high speed motor intermediate stage is mechanically coupled to (and electrically isolated from) the high speed generator stage ωₕₛₘ=w_{hsg}. Thus the generated EMF by the high speed generator is given by:
ε_{hsg}=EMF generated by high speed generator=0.5*R_{hsg}²*B_{hsg}*ω_{hsg}

Where,
R_{hsg}=Radius of high speed generator
B_{hsg}=Magnetic field of high speed generator (assumed to be uniform in this case)
ω_{hsg}=Angular velocity of high speed generator
P_{hsg}=Input power into high speed generator
I_{hsg}=Current collected from high speed generator neglecting losses

If B_{hsg}=B_{lsg} & R_{hsg}=R_{lsg} then

ε_{hsg}=0.5*R_{hsg}²*B_{hsg}*ω_{hsg}=0.5*R_{hsg}²*B_{hsg}*100*ω_{lsg}

ε_{hsg}=100*[0.5*R(_{hsg})²*B(_{hsg})*ω(_{lsg})]

ε(_{hsg})=100*ε(_{lsg})

The output voltage of the high speed generator is 100 times more than the low speed generator while the output current of the high speed generator is 100 times less than the low speed generator neglecting losses.

Using this three stage system comprising of the low speed generator 601, high speed motor 602 and high speed generator 603 and given appropriate radius and magnetic field ratios as described above is it possible to transform the low voltage and high currents produced by a low speed rotational input into a more readily useable high voltage and lower current. It is also important to note that device could equally be run as motor/generator/motor stages allowing the final drive speed to be stepped up or down to suit the final drive requirements. In this manner the Electromagnetic DC-DC Converter stages would be more accurately called a Homopolar Gearbox.

The above example for simplicity assumed uniform magnetic fields. For non-uniform fields the integral form should be used.

$$ɛ = {\int }_{0}^{R} B ( r ) r ω d r = \frac{{R}^{2}}{2} B ω$$

If the integral ∫B(r)r.dr is evaluated then a value in V/rad/s can be calculated for any field profile. Using this method the ratio of the integrals can be used to calculate the speed ratio between the low speed generator and the high speed motor stage/high speed generator stage. Additionally the final voltage ratio between the low speed generator stage and high speed generator can be calculated as below. It should be noted that the integral ∫B(r)r.dr in V/rad/s is also equivalent to torque produced per amp (Nm/A)

∫B(r)r.dr(_{lsg})*ω_{lsg}=∫B(r)r.dr(ₕₛₘ)*ωₕₛₘ

ωₕₛₘ=σ_{lsg}*∫B(r)r.dr(_{lsg})/∫B(r)r.dr(ₕₛₘ)

ε_{hsg}=ωₕₛₘ*∫B(r)r.dr(_{hsg})

ε_{hsg}=[ω_{lsg}*∫B(r)r.dr(_{lsg})/∫B(r)r.dr(ₕₛₘ)]*∫B(r)r.dr(_{hsg})

FIG. 6B is a cross sectional view of the rotor construction of FIG. 6A in greater detail. As shown in the turbine 600, the low speed generator stage 601 and high speed generator stage 603 are positioned between a pair of primary drive coils 604₁, 604₂ housed in cryostats 605. As in the above examples the primary drive coils 604₁, 604₂ are spaced apart to produce a null field region for the positioning of the liquid metal, current transfer assemblies 606. As shown the primary drive coils are composed of 2 concentric coils 620 of superconducting material.

In addition to the primary drive coils a pair of inner cancelling coils 607₁, 607₂ are provided. The inner cancelling coils 607₁, 607₂ being positioned concentrically within the primary drive coils 604₁, 604₂. As shown the inner cancelling coils 607₁, 607₂ consist of a series of three concentric coils housed in cryostats 605. The innermost and outermost coils 621 have a current direction that opposite to that of the outer drive coils 604₁, 604₂. The coils 622 in between these cancelling coils have a positive direction of current, the same as the outer drive coils. The inner cancelling coils 607₁, 607₂ in this case produce additional nulls for the placement of the liquid metal brushes for application of drive current to the high speed motor stage 602. In addition the cancelling coils 607₁, 607₂ also provide the drive field for the electric motor stage 602.

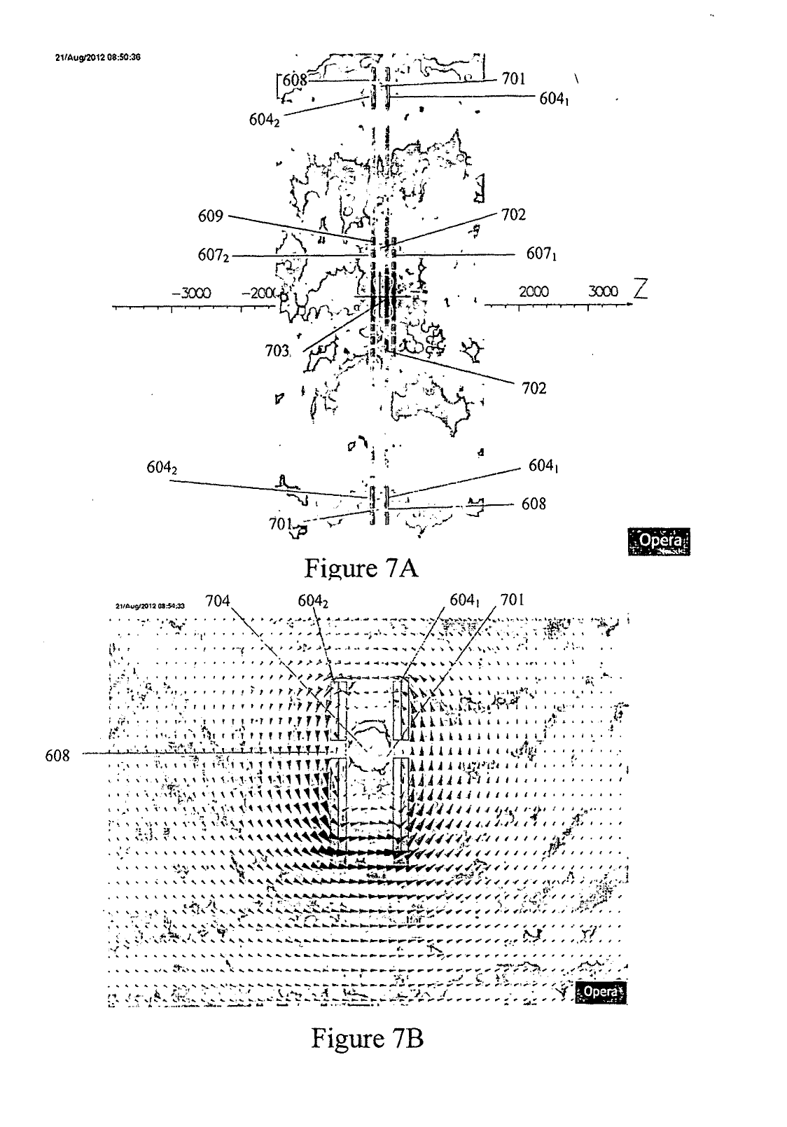

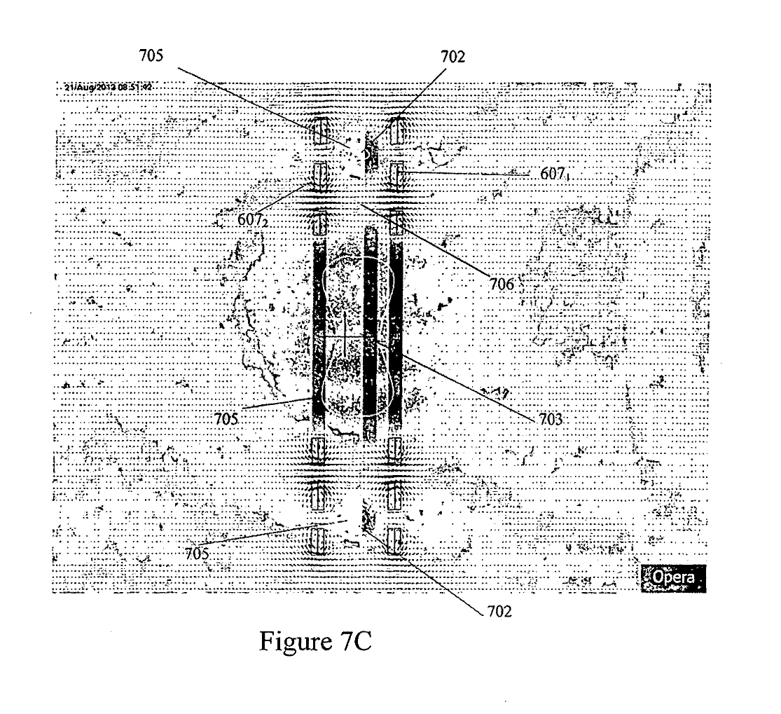

A plot of the field produced within the turbine 600 is shown in FIG. 7A in this case the drive coils and cancelling coils are constructed from Nb₃Sn superconducting wire. As can be seen from FIG. 7A the drive coils 604₁, 604₂ produce null field region 701 between the coil pairs the region being centred about the space 608 provided between the concentric coils forming the coil pairs. FIG. 7B provides a more detailed view of the null field region produced between the primary drive coils 604₁, 604₂. The gap between the two coils 604₁, 604₂ creates a region of null field. This region is enhanced and enlarged by introducing a small gap 608 in the winding radius of the coil. The encircled area 704 in the image above represents an area where the field strength is below 0.2 T.

The cancelling coils provide a central null field region 703. An additional null field region 702 is also produced between cancelling coils 607₁, 607₂. The region being centred about the space provided 609 between outer most coil and the second coil in the set of concentric coils forming the cancelling coils. A more detailed view of the null fields produce by the inner cancelling coils is shown in FIG. 7C. The encapsulated regions 705 represent the areas below 0.2 T. The arrangement of the three additional inner coil sets not only produces a null field region for brush interconnects they also provide a region of high axial field 706 that is used to drive the motor stage of the electromagnetic DC-DC converter motor-generator combination.

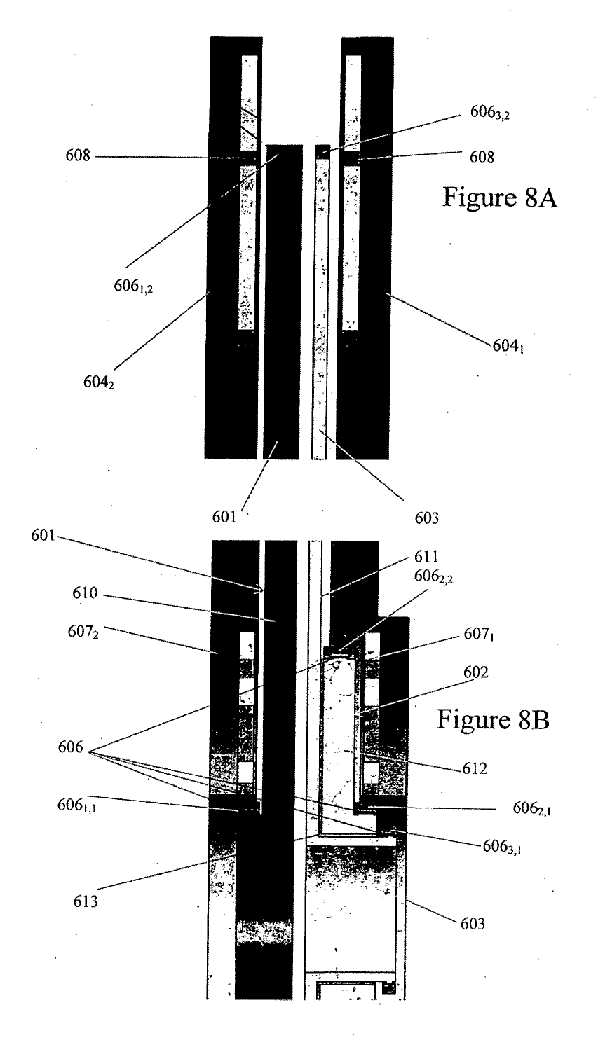

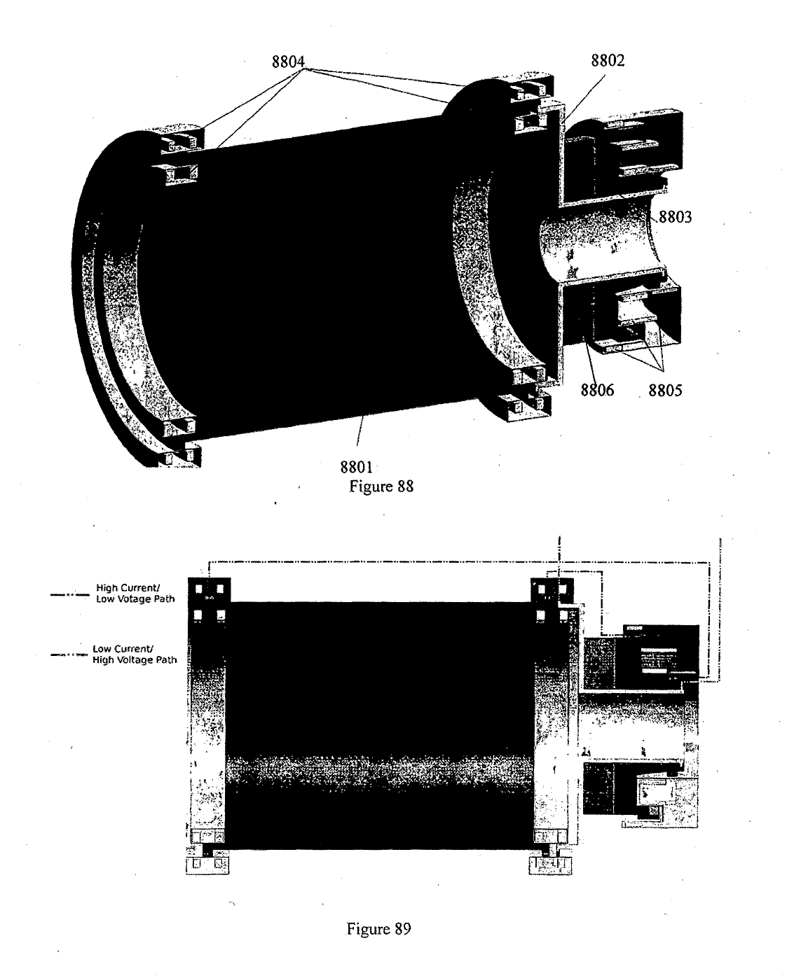

Detailed views of the positioning of the brushes are shown in FIGS. 8A and 88. FIG. 8 A shows the positioning of the outer brushes for the low and high speed generator stages 601, 603. As shown the rotor 610 for the low speed generator stage 601 is positioned adjacent the drive coil 604₂ such that the outer brush 606_{1,2} is positioned adjacent the gap 608 within the drive coil 604₂. The rotor 611 for the high speed generator 603 is positioned adjacent drive coil 604₁ such that the outer brush 606_{3,2} is positioned adjacent the gap 608 within the drive coil 604₁. In both cases the brushes 606_{1,2} 606_{3,2} are positioned in the null field region 701 produced between the coils 604₁, 604₂.

FIG. 8B depicts the arrangement of the inner brushes 606_{1,1}, 606_{3,1} for the low and high speed generator stages 601, 603. Also shown in further detail is the interconnection between the high speed motor stage 602 and the high speed generator stage 603. As shown the inner brushes 606₁, 606_{3,1} contact the hubs of their respective rotors 610, 611 are positioned within the bores of the cryostats 605. The inner brush 606_{1,1} for the low speed generator 601 is positioned adjacent the inner most concentric coil forming the cancelling coil 607₂. The inner brush 606_{3,1} for the high speed generator is positioned within the bore of cryostat 605 of cancelling coil 607₁ and adjacent the inner brush 606_{2,1} of the high speed motor 602 which is located in the null field area 703. In the case of the inner brushes 606_{1,1}, 606_{3,1} for the low 601 and high speed 603 generators are positioned in the null field area 703 produced by the cancelling coils.

The outer brush 606_{2,2} of the high speed motor 602 in this instance is positioned adjacent the outer most coil of cancelling coil 607₁ such that it is positioned with the null field region 702. Positioning the outer brush 606_{2,2} in this manner also means that the rotor 612 of the motor is positioned with high axial field. As noted above the high speed motor 602 is mechanically coupled to the high speed generator 603. As can be seen in FIG. 8B the motor 602 is connected to the high speed generator 603 via a suitable insulating material 613 via maintains the electrical isolation between the motor 602 and high speed generator 603.

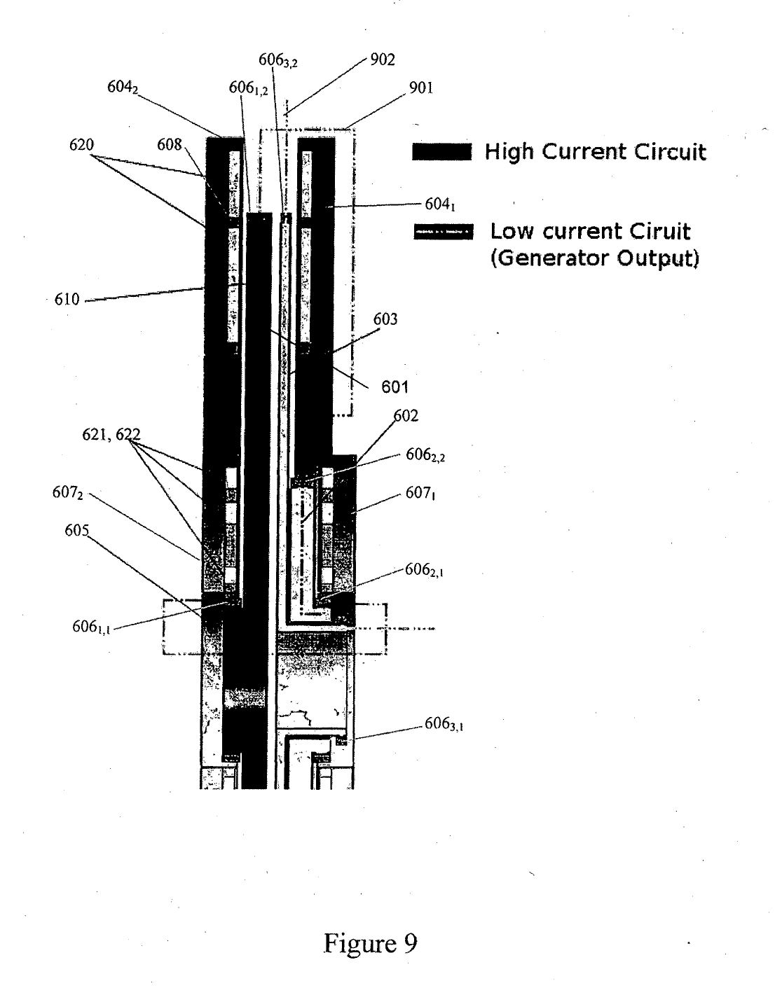

FIG. 9 depicts the current flow through the turbine 600 in this case the turbine includes a high current circuit formed by the low speed generator stage 601 and the high speed motor 602. The low current circuit in this case is formed by the high speed generator 603. As can be seen as the rotor 610 of the low speed generator is rotated via an external drive mechanism and current is generated via the motion of the conductive rotor within the primary magnetic field. The high current generated from the low speed generator 601 is passed to the high speed motor 602 as shown by current path 901. As current is passed through the rotor 612 of the motor 602 torque is produced due to the high axial field produce by the cancelling coils 607₁, 607₂. The torque is transferred to the rotor 611 of the high speed generator 603. The rotation of the rotor 611 of the high speed generator 603 in the primary induces a current which is drawn off to the load/grid as shown via current path 902.

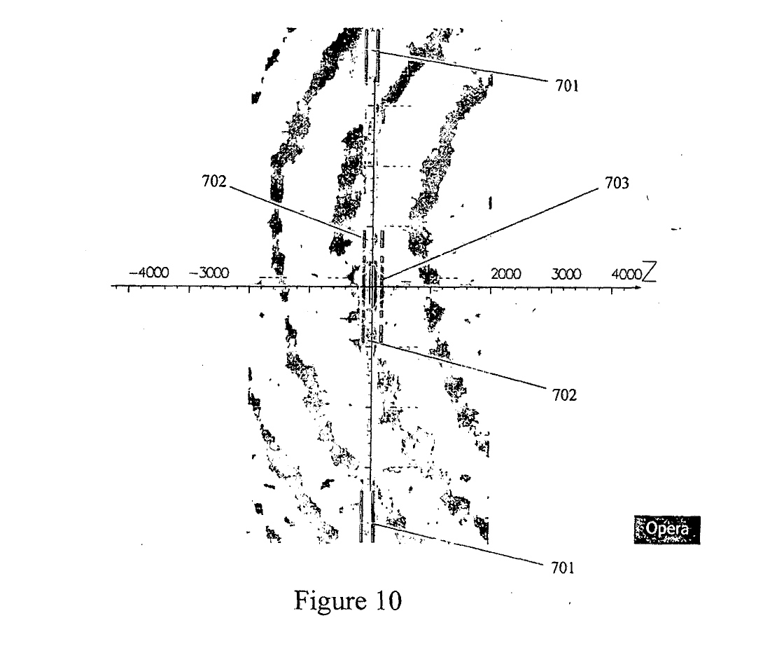

In the above examples the super conducting coils are composed of Nb₃Sn superconducting wire. Alternatively, the super conducting coils could be constructed from NbTi superconducting wire, which at present has some price advantage over Nb₃Sn as well as some advantages concerning the ease of constructing the superconducting coils. The price for this lower cost, easier alternative is an increase in the diameter of the outer pancake style coils, a corresponding increase in the diameter of the high and low speed rotors and the resultant increase in the wire and rotor weights of the completed generator. A plot of the field produced for the generator arrangement of FIGS. 6A and 6B is shown in FIG. 10. As can be seen the resultant null field regions produced are of a similar configuration to that of the case of Nb₃Sn wire with a slight alteration to the geometries of the regions.

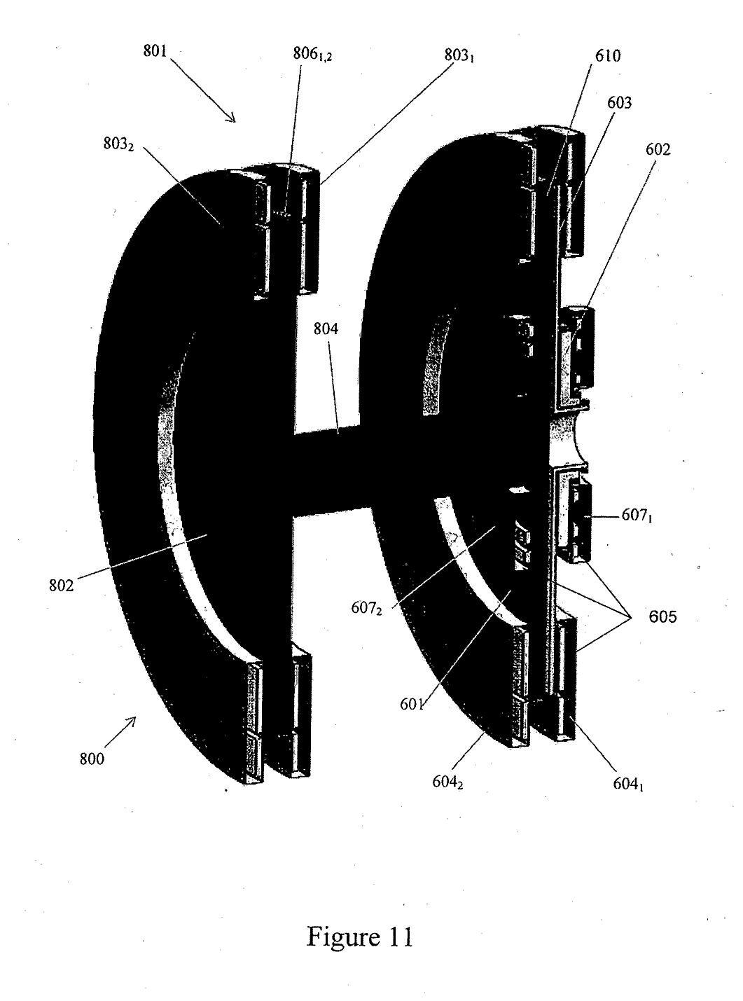

A further embodiment of turbine with DC-DC conversion is shown in FIG. 11. Again the turbine is designed to convert the low voltage high current produced by the low speed stage of the generator to a high voltage low current output. The turbine includes a first stage 800 which is of a similar construction to that of the turbine of FIGS. 6A and 6B and includes a primary low speed generator stage 601 and high speed generator stage 603 positioned between a pair of primary drive coils 604₁, 604₂ housed in cryostats 605. The primary drive coils 604₁, 604₂ are spaced apart to produce a null field region for the positioning of the liquid metal current transfer assemblies 606. Again the primary drive coils are composed of 2 concentric coils of superconducting material.

In addition to the primary drive coils a pair of inner cancelling coils 607₁, 607₂ are provided. The inner cancelling coils 607₁, 607₂ being position concentrically within the primary drive coils 604₁, 604₂. As shown the inner cancelling coils 607₁, 607₂ consist of a series of three concentric coils housed in cryostats 605.

The secondary low speed 801 stage includes a second low speed generator stage, which in this case includes a rotor 802 positioned between a pair of superconducting elements 803₁, 803₂. The secondary low speed generator is coupled to the primary low speed generator 601 via a conductive shaft 804. The secondary drive coils 803₁, 803₂ are arranged in opposite magnetic polarity to that of the primary drive coils 604₁, 604₂. The reversed field polarity ensures a consistent direction of rotation in the first low speed dual rotor assembly. That is the current flow runs from the outer to the inner radius in the first rotor 610, along the shaft 804, and then from the inner radius to the outer radius of the second rotor 802.

As in the single rotor case the low speed generator sections are utilised, to power the high speed motor. In this instance the secondary low speed generator is coupled to one of the brushes the of the motor 602 while the low speed generator of the primary stage 601 is coupled to the remaining brush of the motor of the brushes of the motor 602.

The primary advantage of the dual rotor design is the decrease in the overall diameter of the outer drive coils (and hence the overall diameter of the generator. In effect, the voltage generated in the first low speed rotor is generated across two physical rotors without the requirement for a sliding contact interconnect. As the voltage developed in the generator stages correlates strongly with the radius of the outer coils, the required voltage per plate can be halved and the outer coil diameter reduced to produce this lower per plate target voltage.

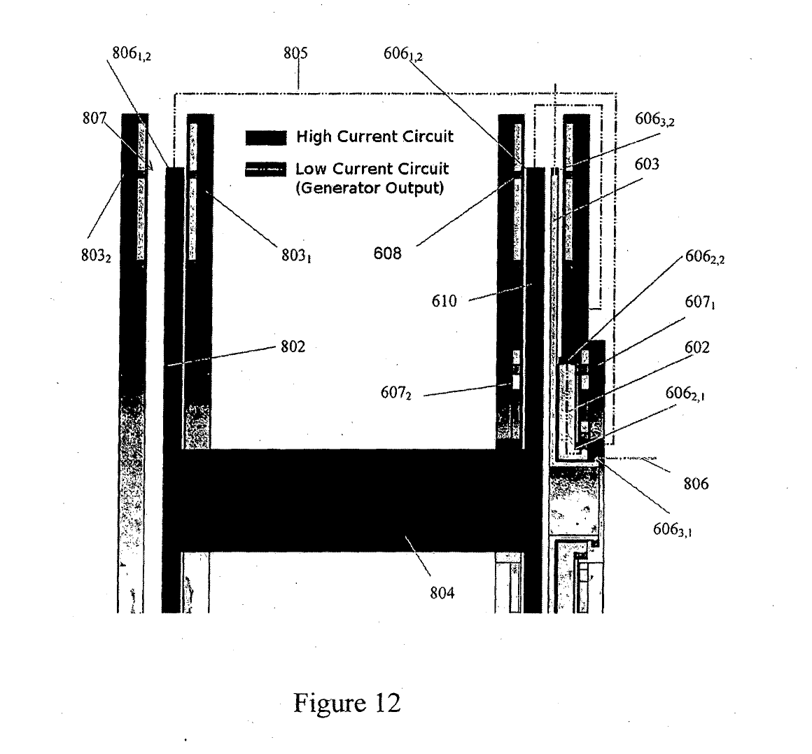

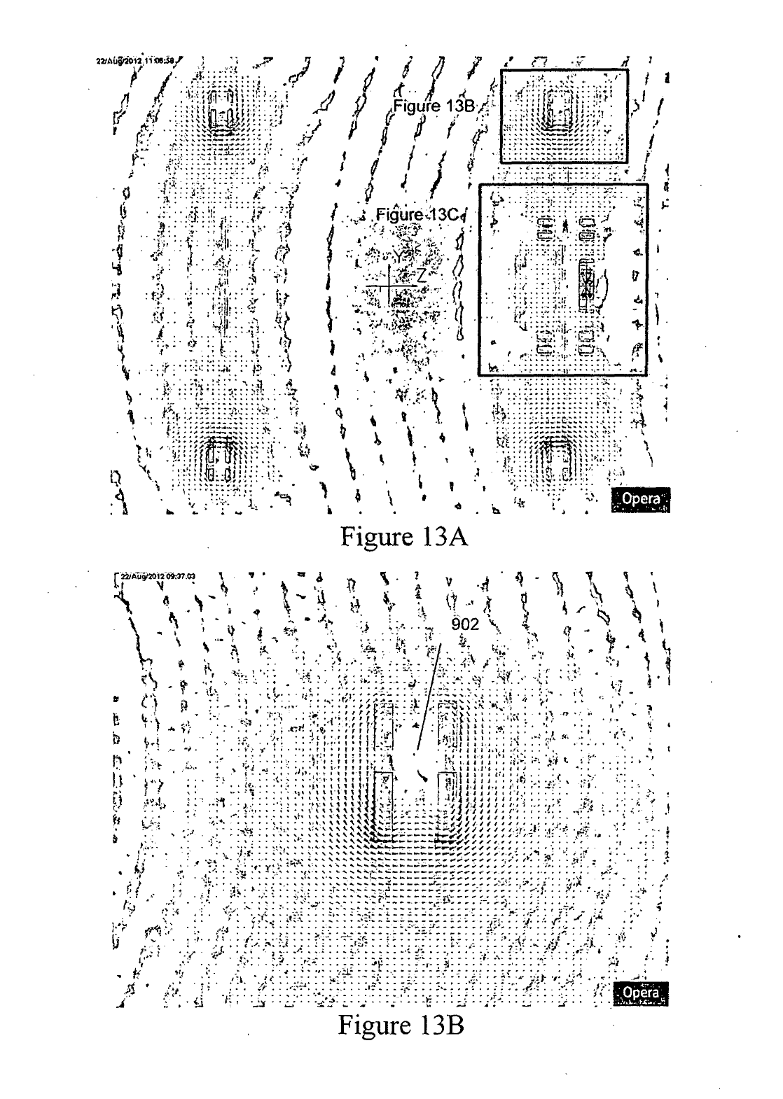

FIG. 12 depicts the high current and low current circuits for the DC-DC conversion within the turbine. As shown the high current generated in the low speed sections 801, 601 is passed to the high speed motor 602 as denoted by current path 805. The resultant torque generated by the motor 602 is passed to the high speed generator 603 stage. The rotation of the rotor of the high speed generator section 603 induce current which is drawn off to the grid as denoted by current path 806.

As can be seen in FIG. 12 the outer brushes 606_{1,2}, 606_{3,2} are positioned between the primary drive coils 604₁, 604₂ and adjacent gaps 608 i.e. brushes 606_{1,2} 606_{3,2} are positioned in the null field region produced between the coils 604₁, 604₂. The inner brushes 606_{2,1}, 606_{3,1} for the high speed generator and motor stages 602, 603 are positioned within the bores of the cryostats 605. The inner brush 606_{3,1} for the high speed generator is positioned within the bore of cryostat 605 of cancelling coil 607₁ and adjacent the inner brush 606_{2,1} of the high speed motor 602. The inner brushes 606_{2,1},606_{3,1} for the high speed 603 generator and motor 602 are positioned in the central null field area produced by the cancelling coils. The outer brush 606_{2,2} of the high speed motor 602 in this instance is positioned adjacent the outer most coil of cancelling coil 607₁ such that it is positioned with the outer null field region produced by the cancelling coils.

The outer brushes 806_{1,2} of the secondary low speed generator section are positioned within the gap disposed with the gap between the secondary drive coils 803₁, 803₂ as in the case of the primary drive coils the secondary drive coils 803₁, 803₂ are composed of a pair of concentric coils with gap 807 disposed therebetween. Again the gap enlarges the null field region.

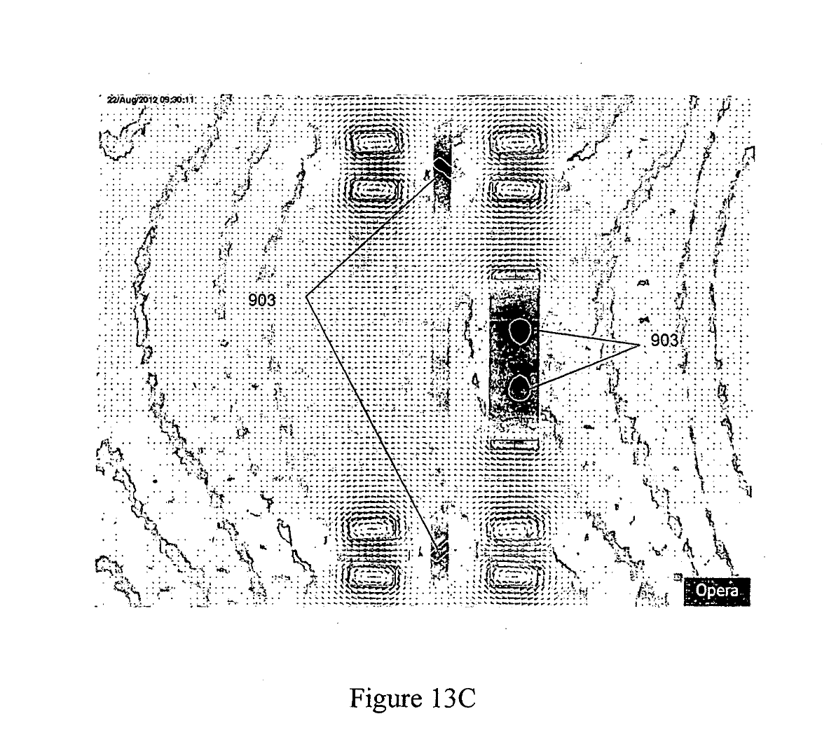

A plot of the magnetic field generated by the combination of drive and cancelling coils is shown in FIG. 13A. The field plot in this case has been modelled using Nb₃Sn wire. The dual rotor arrangement allows the total outer diameter of the generator to be reduced while still maintaining an output voltage high enough to efficiently extract power out of the first, low speed generator stage.

The field plot clearly shows the first rotor stage on the left, consisting of a set of outer driving coils. The composite stage on the right hand side contains the outer drive coils for the second half of the low speed generator/high speed final generation stage and the internal cancelling coils. These cancelling coils produce field nulls suitable for the placement of liquid metal contacts and produce a driving field for the intermediate high speed motor stage.

FIG. 13B is a detailed view of the field produced in the primary drive coils 604₁, 604₂. The area 902 circumscribed by freeform line indicates the region where the field strength is below 0.2 T (i.e. the region where liquid metal brushes can be placed without a reduction in performance).

As shown in the previous single rotor examples the field null is constructed first through the use of the separation between the drive coils 803₁, 803₂. As noted above each of the drive coils are formed from a set of concentric coils with a gap formed there between. The use of the air gap in this case further enhances the size of the null field region.

FIG. 13C depicts the field generated in the primary motor stage 800 of the turbine assembly. As in the above examples the series of additional coils create regions of null field 903 in which the liquid metal brushes that transport the current between the generator/motor/generator stages. The second function of these coils is the creation of a region of usable axial field below the field null that drives the high speed intermediate motor stage of the device.

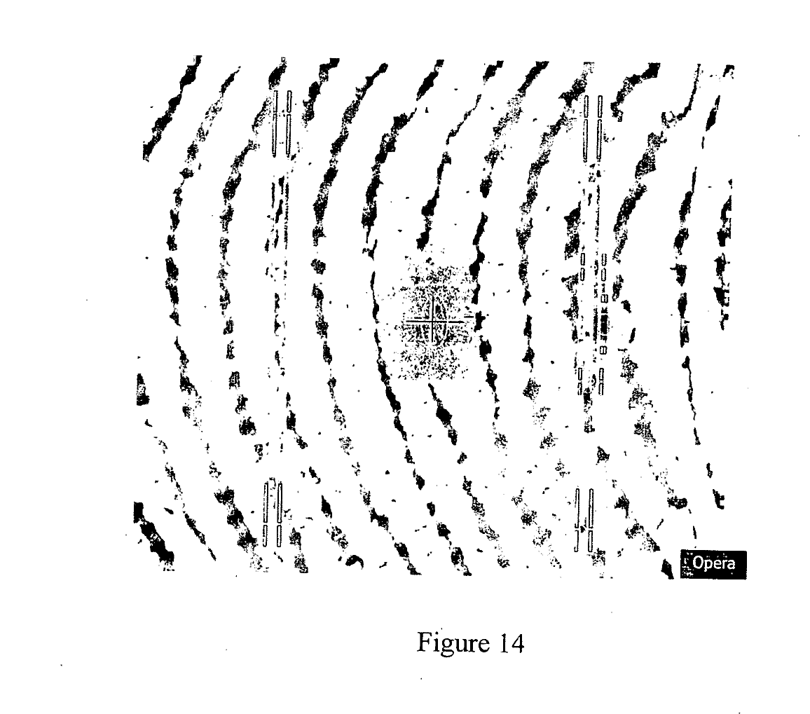

FIG. 14 is a field plot of the magnetic field generated by the combination of drive and cancelling coils modelled for NbTi superconducting wire. The different wire again results in a large diameter and ultimately heavier machine.

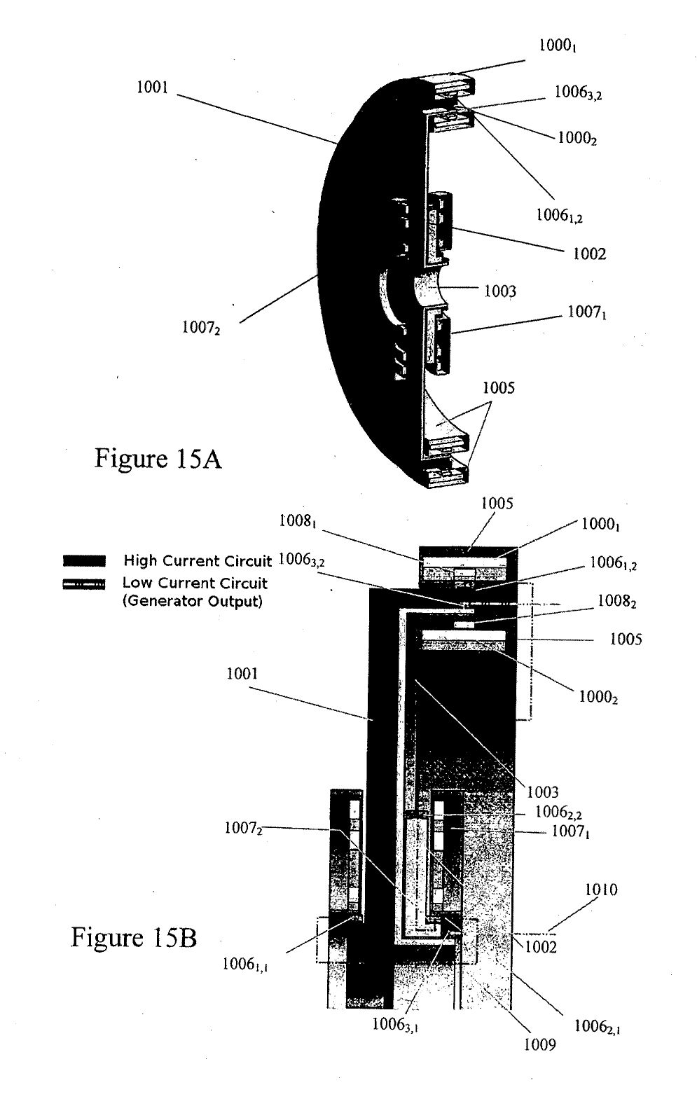

An alternate arrangement of a turbine employing DC-DC conversion is shown in FIGS. 15A and 15B. In this example the multiple layered outer coils have been replaced with solenoid style coils as discussed in relation to FIGS. 1A to 5. The increased gap between the concentric outer coils facilitates the side entry of the rotors forming the low speed and high speed generator sections. This option allows the supporting structure of the outer coils to incorporate structural hoop elements which may in turn reduce the total weight of the generator.

As in the above examples the turbine includes a set of drive coils 1000₁, 1000₂ housed within cryostats 1005. The coils in this case are arranged concentrically such that a portion of the rotors for the low speed generator 1001 and the high speed generator 1003 extend into the region between the coils. As in the above examples the introduction of the gap between the drive coils enables the production of a null field region into which the outer liquid metal brushes 1006_{1,2}1006_{3,2} for the generator stages are positioned. To further enlarge the null field regions cancelling coils 1008₁,1008₂ may be positioned with the cryostats adjacent the respective drive coils 1000₁, 1000₂. The positioning of the cancelling coils 1008₁,1008₂ can be seen in greater detail in FIG. 15B.

As in the above examples the side entry design again employs a set of cancelling coils 1007₁, 1007₂. As can be seen in this instance the cancelling coils 1007₁, 1007₂ are again composed of a set of three superconducting coils arranged in a concentric relation. The cancelling coils 1007₁, 1007₂ provide the null field regions for the placement of the inner brushes 1006_{1,1}, 1006_{3,1} for the low speed, high speed generator sections. The cancelling coils 1007₁, 1007₂ also provide null field regions for the placement of the drive brushes 1006_{2,1}, 1006_{2,2} for the electric motor stage 1002 as well as a region of high axial field which acts as the primary drive field for the motor 1002.

FIG. 15B shows the passage of current between the various high current and low current stages of the turbine. As shown the low speed generator section 1001 envelopes the high speed generator section 1003 with the outer brush 1006_{1,2} mounted adjacent drive coil 1000₁ and cancelling coil 1008₁. The inner brush 1006_{1,1} mounted adjacent the inner most coil of the cancelling coil 1007₂. The high current generated via the low speed rotation of the generator 1001 is passed to the high speed motor 1002 as shown by current path 1009. The rotor provides a current linkage between the motor's outer brush 1006_{2,2} positioned adjacent the outer most coil of cancelling coil 1007₁ and the inner brush 1006_{2,1} positioned adjacent the inner most coil of cancelling coil 1007₁. As current is passed through the motor a torque is produced due to the interaction of the current and the high axial field generated by the cancelling coils.

The torque generated by the motor is directly transferred to the rotor of the high speed generator 1003. The resultant rotation of the rotor of the high speed generator section produces a low current output which is drawn off, as denoted by current path 1010, via outer brush 1006_{3,2} positioned adjacent drive coil 1000₂ and cancelling coil 1008₂ and inner brush 1006_{3,1} positioned within the cryostat of cancelling coil 1007₁.

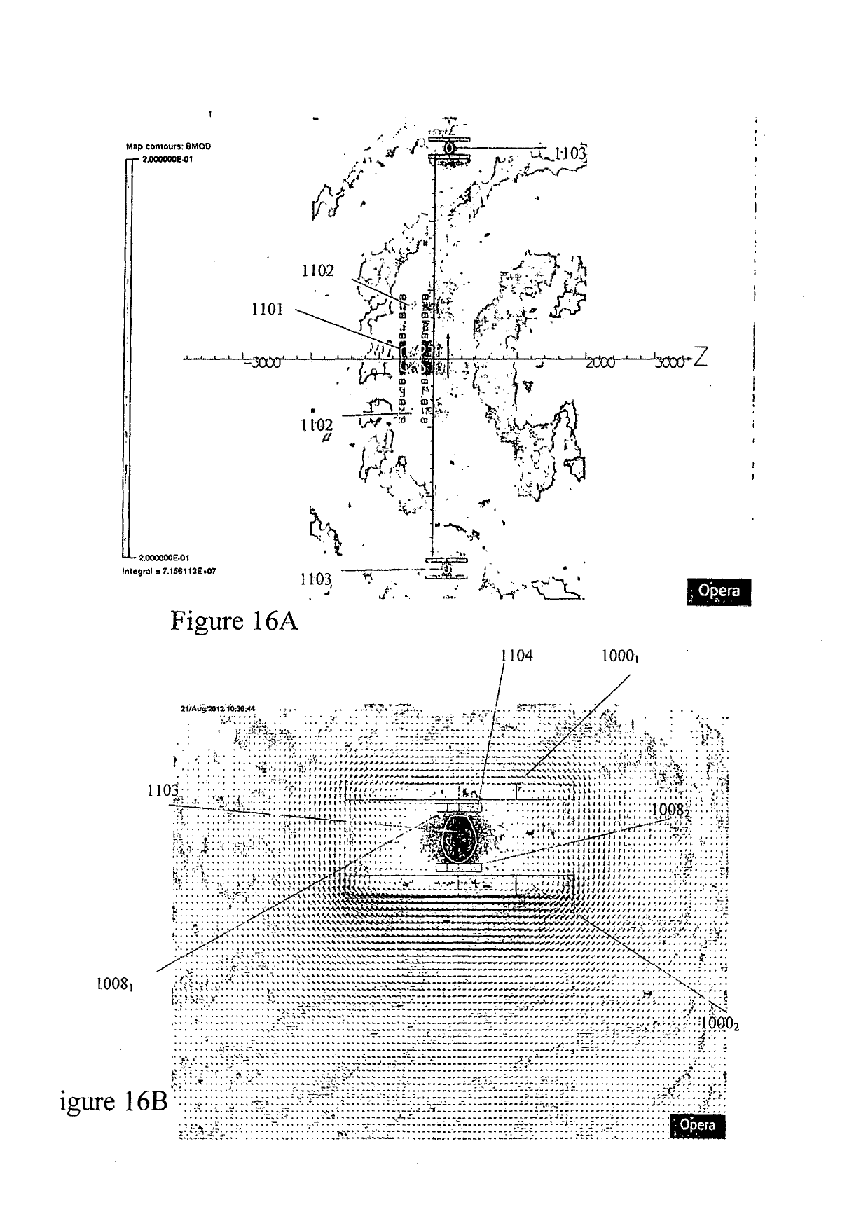

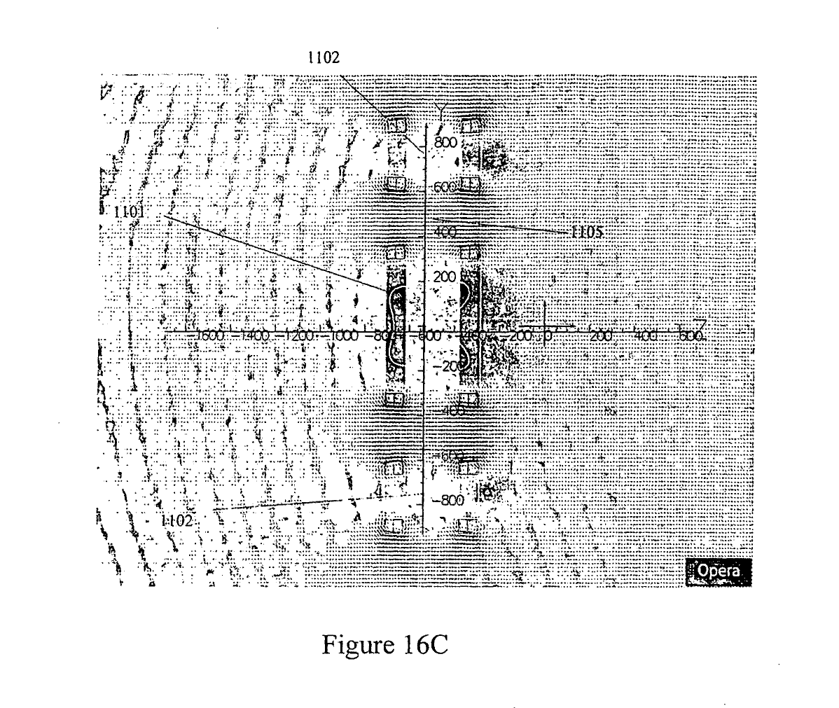

FIG. 16A is a field plot for the turbine arrangement of FIGS. 15A and 15B. As can be seen the cancelling coils 1007₁, 1007₂ are positioned adjacent the drive coils 1000₁, 1000₂ with a null 1101 being produced in the central region between the inner most coil of the cancelling coils 1007₁, 1007₂ and null 1102 produced between the outer most coils and the middle coils of the cancelling coils 1007₁, 1007₂. A null field 1103 is also produced in the region between the drive coils 1000₁, 1000₂. The null field in the outer coils is increased and enlarged by a set of additional smaller field cancelling coils 1008₁, 1008₂ in the horizontal gap of the outer coils.

FIG. 16B depicts the null field 1103 generated between the drive coils 1000₁, 1000₂ in greater detail. The series of smaller cancelling coils 1008₁, 1008₂ inside the gap between the inner and outer drive coils 1000₁, 1000₂ have the direction of current flow reversed so as to increase the field null. The encapsulated region 1104 represents the area where the field density is below 0.2 T.

FIG. 16C depicts the null field regions generated by the cancelling coils 1007₁, 1007₂. As can be seen the arrangement of the cancelling coils cancelling coils 1007₁, 1007₂ produces a large central null 1101 and a set of smaller nulls 1102 in the region between the outer coils and middle coil. A high axial field is generated in the region 1105 between the innermost coil and the middle coil.

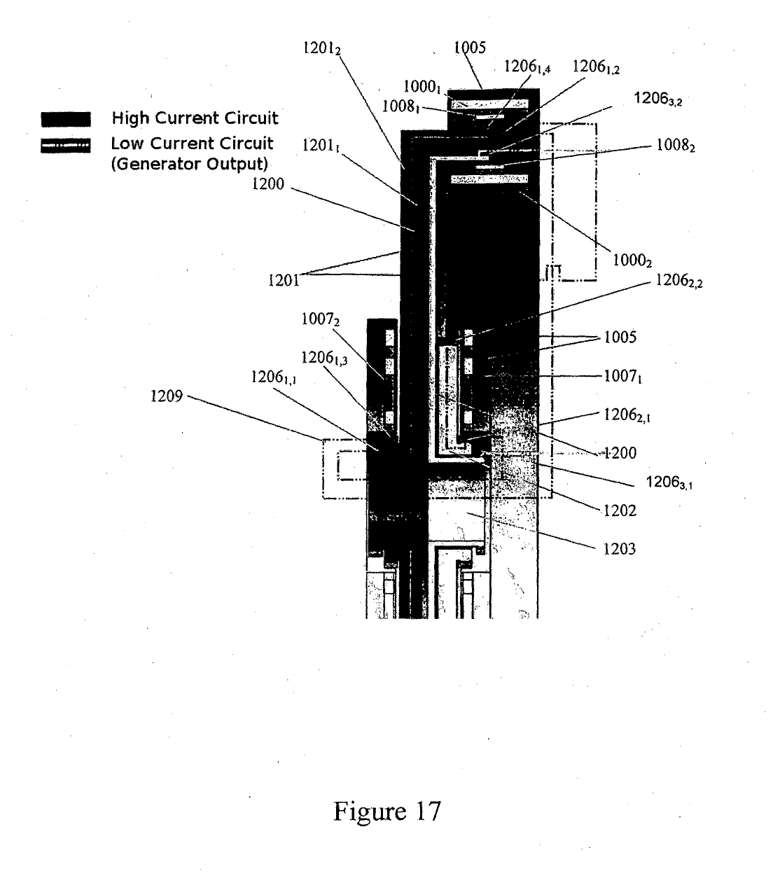

Depending on the required output voltage and power levels the generator stages (low and high speed) can be made using a series connected laminated rotor assembly. The current direction is maintained in the laminations through corresponding stationary return busses connecting the rotor laminations. FIG. 17 depicts a turbine configured for side entry employing a laminated low speed generator stage. The configuration of the drive coils 1000₁,1000₂ and cancelling coils 1007₁, 1007₂ is the same as that discussed above in relation to FIGS. 15A and 15B.

In this example a secondary low speed 1201₂ generator is stacked on top of the primary low speed generator 1201₁. The two generators are mechanically linked via an insulating layer 1200. As can be seen in this case as rotors of the low speed stage are connected together in series together with the motor stage 1202 (as can be seen via current path 1209). As the low speed generator section is rotated the current generated in the primary rotor 1201₁ is transferred from outer brush 1206_{1,2} disposed adjacent to the end of secondary rotor to the inner brush 1206_{1,3} of the secondary generator 1201₂. Current from the secondary low speed generator stage is feed from outer brush 1206_{1,4} disposed adjacent drive coil 1000₁ and cancelling coil 1008₁ to the outer brush 1206_{2,2} of the motor 1202 across the rotor to inner brush 1206_{2,1} which is coupled to the inner brush 1206_{1,1} completing the power circuit for the motor 1202.

As in the above examples the motor is again mechanically connected to the high speed generator stage 1203 via a suitable insulating layer 1200. As the current from the low speed stage is passed through the motor the resultant torque is transferred to the rotor of the high speed generator which induces a current. The low current output which is drawn off, as denoted by current path 1210, via outer brush 1206_{3,2} positioned adjacent drive coil 1000₂ and cancelling coil 1208₂ and inner brush 1206_{3,1} positioned within the cryostat of cancelling coil 1007₁.

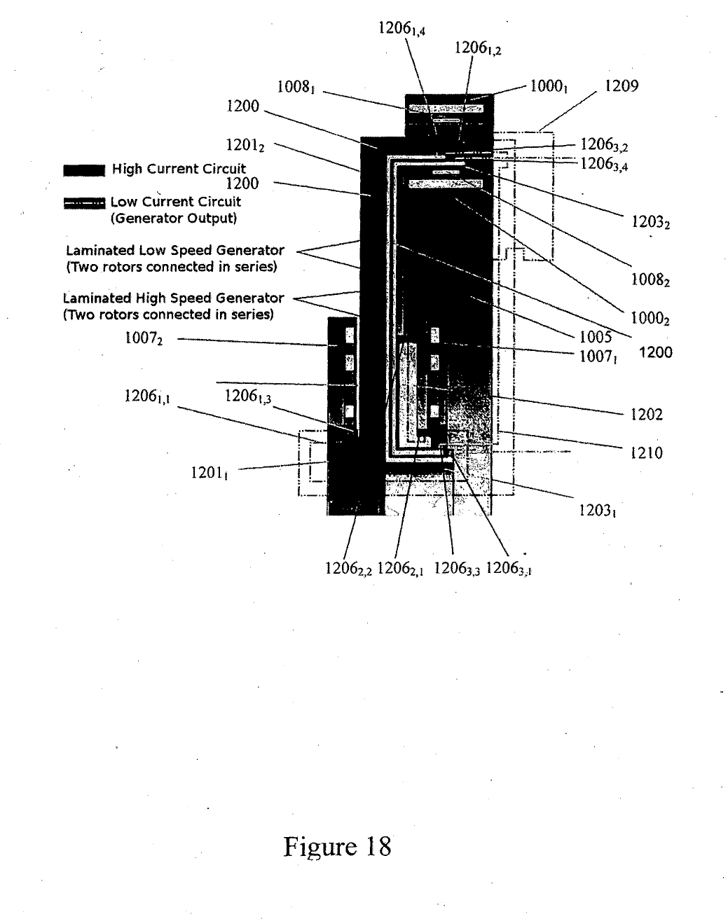

FIG. 18 depicts the case of a turbine configured for side entry employing a laminated low speed and high speed generator stage. The configuration of the drive coils 1000₁, 1000₂ and cancelling coils 1007₁, 1007₂ is the same as that discussed above in relation to FIGS. 15A and 15B.

As in the case of the configuration of FIG. 17 the low speed stage includes two low speed generators mechanically linked via a suitable insulating layer. Again the secondary low speed 1201₂ generator is stacked on top of the primary low speed generator 1201₁. Current is passed between the various stages of the low speed generator to the motor 1202 as denoted by current path 1209. More specifically as the low speed generator section is rotated the current generated in the primary rotor 1201₁ is transferred from outer brush 1206_{1,2} disposed adjacent to the end of secondary rotor to the inner brush 1206_{1,3} of the secondary generator 1201₂. Current from the secondary low speed generator stage is fed from outer brush 1206_{1,4} disposed adjacent drive coil 1000₁ and cancelling coil 1008₁ to the outer brush 1206_{2,2} of the motor 1202 across the rotor to inner brush 1206_{2,1} which is coupled to the inner brush 1206_{1,1} completing the power circuit for the motor 1202.

As in the above examples the motor is again mechanically connected to the high speed generator stage. However in this instance the high speed generator stage includes a primary high speed stage 1203₁ with a secondary high speed stage 1203₂ stacked between the motor 1202 and the primary stage 1203₁. The motor 1202 is mechanically linked to the secondary stage 1203₂ via a suitable insulating layer 1200 likewise the secondary stage 1203₂ is linked to the primary stage via a suitable insulating layer 1200. As the current from the low speed stage is passed through the motor the resultant torque is transferred to the high speed stages 1203₁, 1203₂.

The subsequent rotation of the high speed stages 1203₁, 1203₂ produces a low current output. As can be seen here the outer brush 1206_{3,2} is coupled to the inner brush 1206_{3,3} of the secondary rotor with the current being drawn off, as denoted by current path 1210, across outer brush 1206_{3,4} of the secondary high speed generator 1203₂ and the inner brush 1206_{3,1} of the primary high speed generator 1203₁.

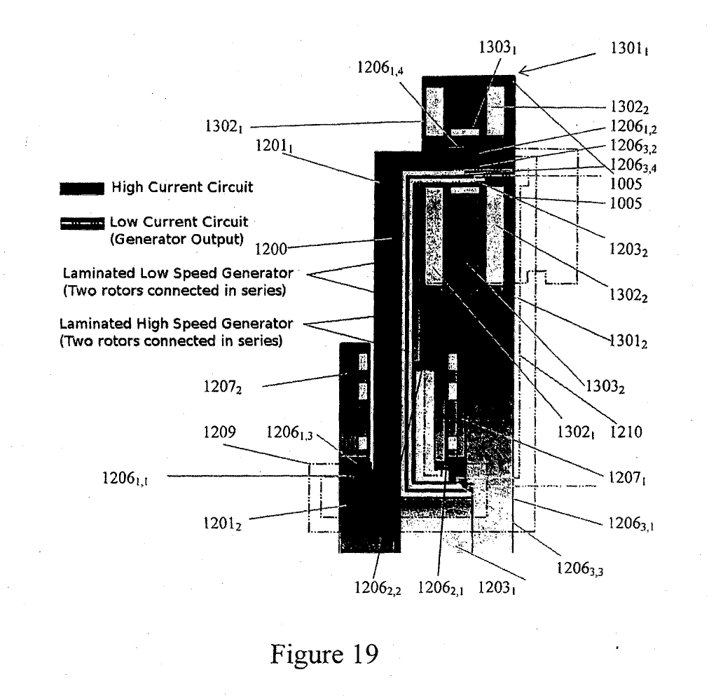

FIG. 19 depicts yet another configuration of a side entry turbine. In this case the low speed stage and high speed stages are configured as per that discussed in respect of FIG. 18. In this case the turbine employs a different drive coil configuration to that of the previously discussed configurations. In the case of the designs depicted in FIGS. 15A, 15B, 17 and 18 a concentric arrangement of the drive 1000₁, 1000₂ and the cancelling coils 1008₁, 1008₂ is utilised. In the case of the example in FIG. 19 a coaxial arrangement is employed.

As can be seen from FIG. 19 each drive coil assembly 1301₁, 1301₂ includes a set of 3 coils, a pair of drive coils 1302₁, 1302₂ and a cancelling coils 1303₁ and 1301₂. As in the above examples the drive coil assembly 1301₁, 1301₂ are arranged concentrically with respect to each other with a gap disposed there between to accept a portion of the primary and secondary low speed generators 1201₁, 1201₂ and the high primary and secondary generators 1203₁, 1203₂ and their respective brushes. The drive coils 1302₁, 1302₂ and cancelling coils 1303 are arranged coaxially within the coil assembly 1301₁, 1301₂.

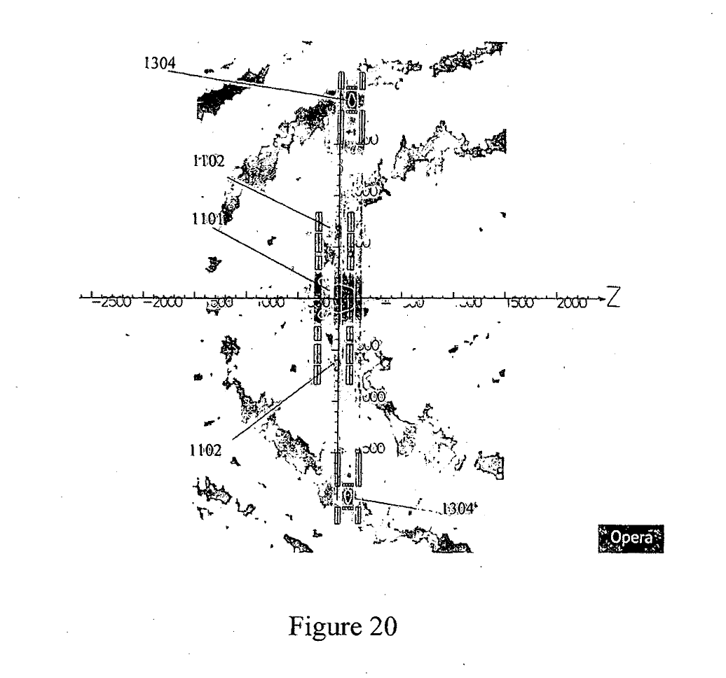

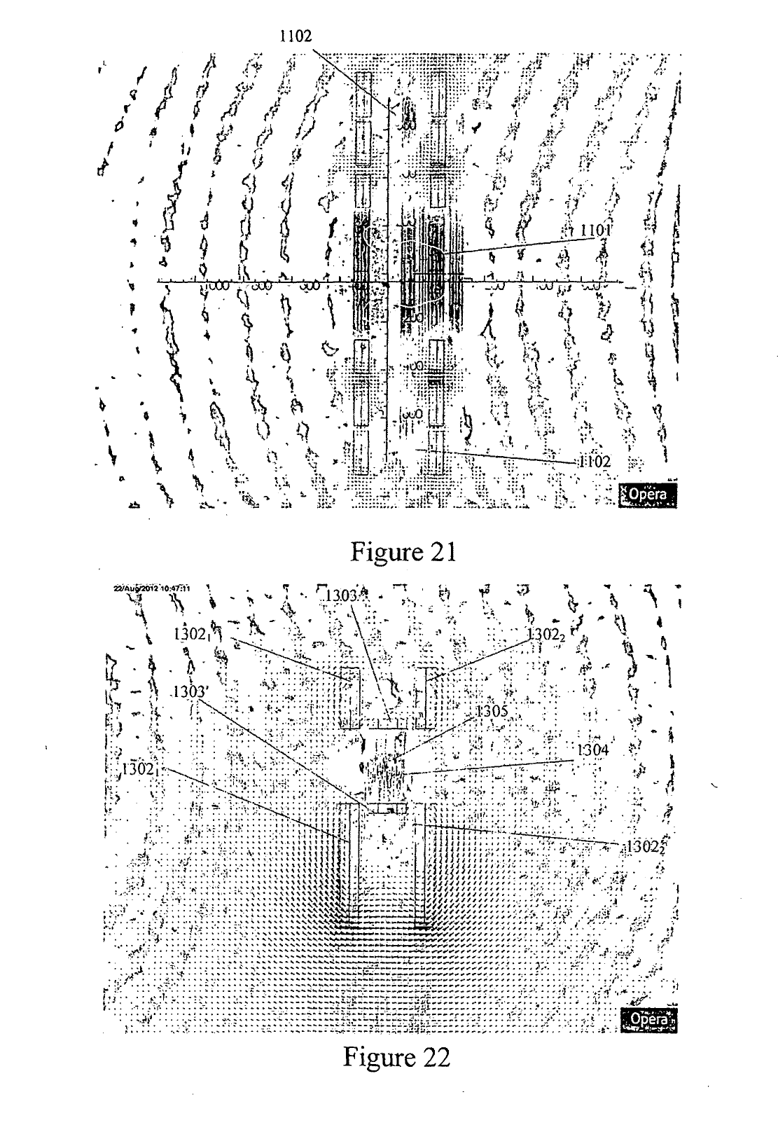

FIG. 20 shows a plot of the resultant magnetic field produced by the coil arrangement of FIG. 19. Again null 1304 field regions are produced within the gap between the drive coil assemblies 1301₁, 1301₂. The nulls 1101, 1102 produced by the cancelling coils 1207₁, 1207₂ are not affected by the change in the configuration of the coils within the drive coil assemblies 1301₁, 1301₂ As can be seen from the field plot shown in FIG. 21.

FIG. 22 is a detailed view of the null field region 1304 produced between the coil assemblies 1301₁, 1301₂. As in the above cases the introduction of the cancelling coils into the drive coil arrangements has the effect of increasing the size of the null field region into which the brushes can be positioned as circumscribed by freeform line 1305.

It is important to note that all of the Turbines that incorporate the Electromagnetic DC-DC Converter stages can be run in reverse as a generator (to step down the voltage from a high speed generator) or run as a motor in either direction (low voltage, low speed to high voltage, high speed final drive or high voltage, high speed to a low voltage, low speed final drive). Additionally in the case of a wind turbine application the final high speed DC generator stage could be removed and the high speed motor stage coupled to an external AC generator. Again this implementation could be more accurately described as a Homopolar Gearbox.

The above discussed examples have resulted from the need to deal with low rotational speed, as either an input for a generator, as with direct drive wind turbines, or as a final output drive shaft for a motor. The low speed and corresponding high torque that exists in these scenarios requires a large amount of infrastructure and support mechanisms. These limitations are faced by all motor and generators designs that have to operate with this type of loading.

If the operating speed can be substantially increased then the size of the generator and motor can generally be significantly reduced. On the mechanical side, higher operating speed means less torque on the drive/driven shaft for the same power envelope. This means smaller and lighter shafts and rotors can be employed. Additionally, as the voltage term in the generator/motor equation is a direct function of the RPM, higher speed operation means a higher operating voltage and correspondingly lower current. This reduces the required size of the rotors and current carrying interconnects, further reducing the size and weight of the overall device.

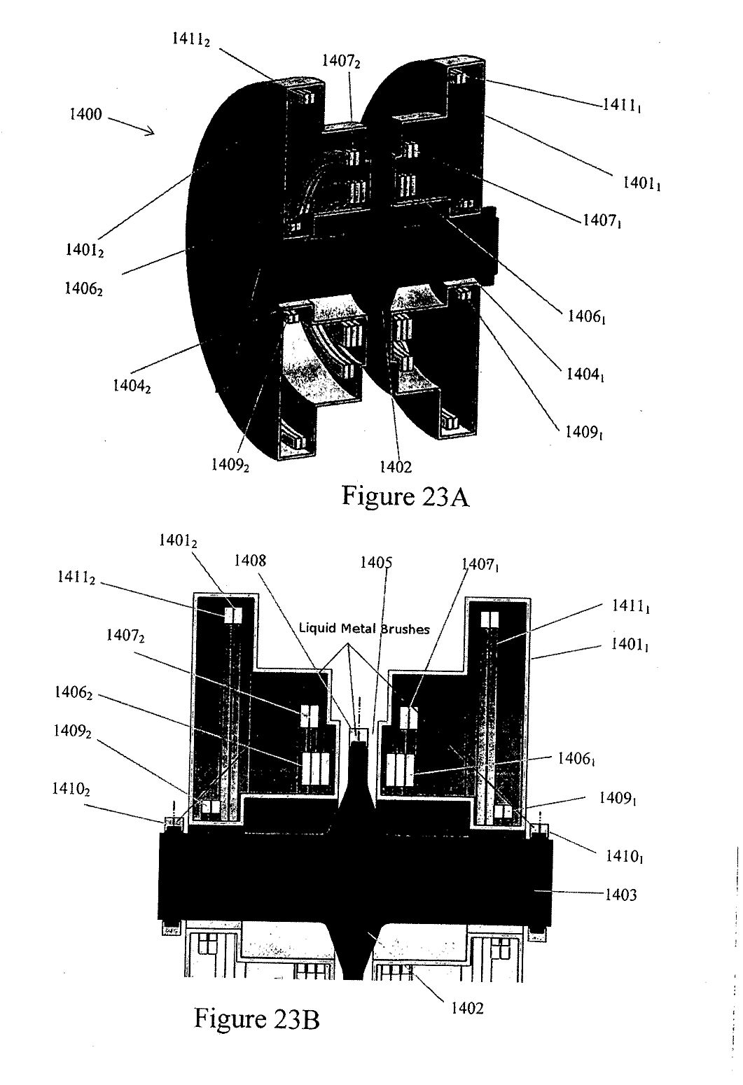

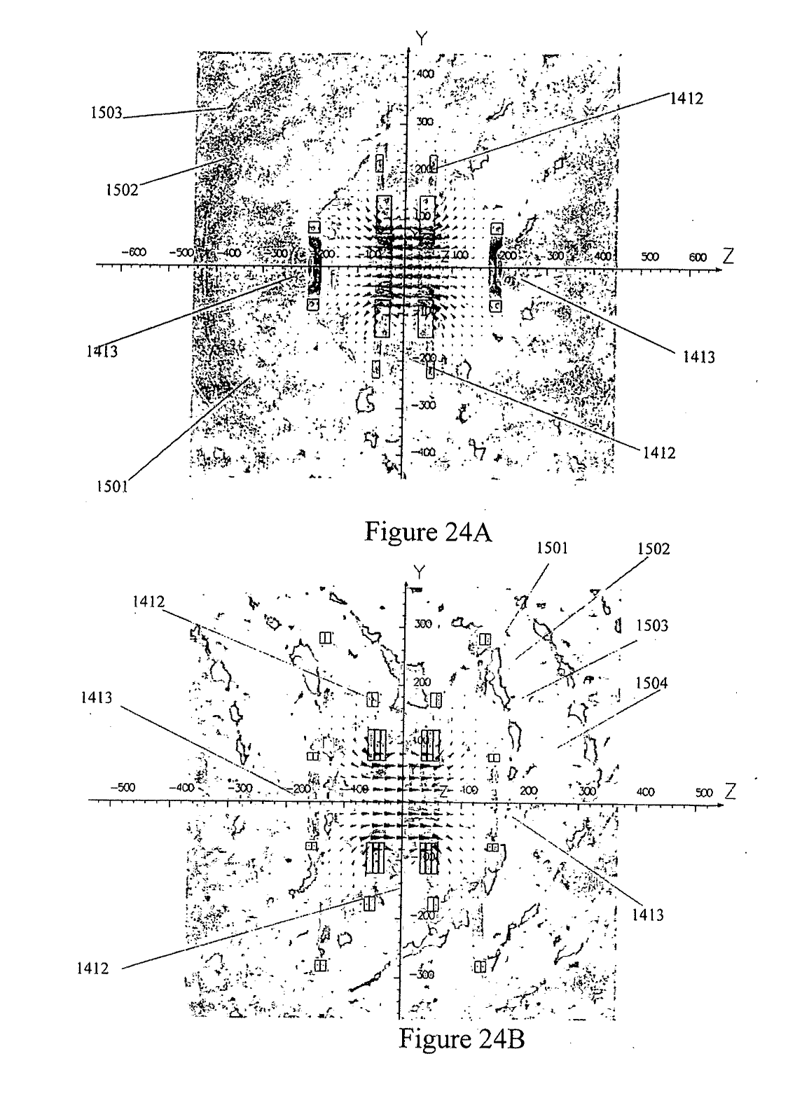

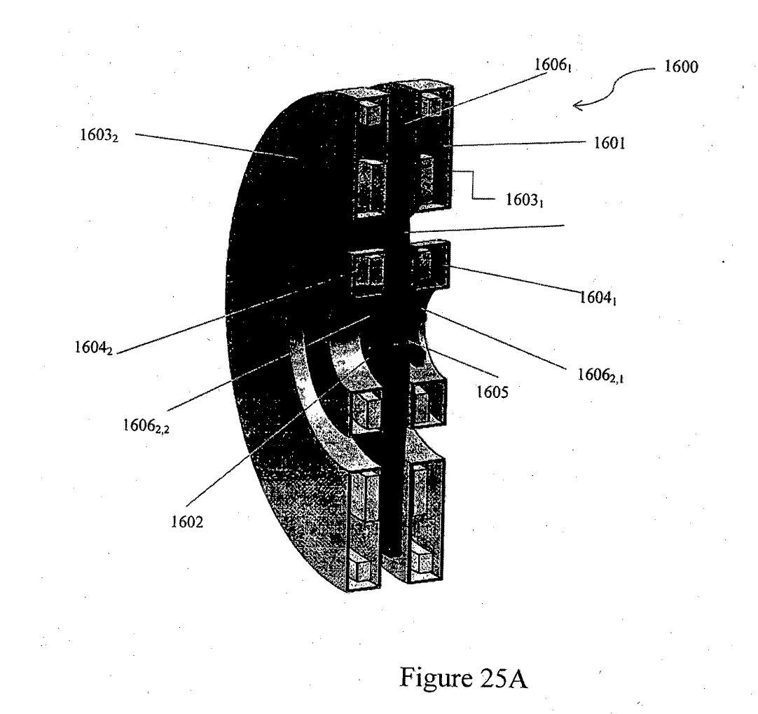

FIG. 23A depicts one possible configuration of a turbine 1400 for use as a high speed motor/generator. As shown the turbine includes pair of magnetic assemblies 1401₁, 1401₂. The magnetic assemblies having a plurality of super conducting coils, a number of the coils being configured for the production of a primary magnetic drive field and a number of coils being configured as cancellation coils for the production of field nulls and to reduce the turbines reduce the stray field profile to meet necessary shielding standards (i.e. shaping of the turbine's 5 gauss line). As can be seen from FIG. 23A the turbine includes a single rotor 1402 positioned between the magnetic assemblies 1401₁, 1401₂. The rotor 1402 in this case is formed integral with a drive shaft 1403 which extends through a bores 1404₁, 1404₂ provided in the magnetic assemblies 1401₁, 1401₂.

FIG. 23B shows the arrangement of the magnetic assemblies 1401₂ with respect to the rotor 1402 and drive shaft 1403. As can be seen the rotor 1402 is positioned within gap 1405 provided between the magnetic assemblies 1401₁, 1401₂. As in the above examples while the gap is primarily provided to accommodate the rotor 1402 it also assists in the creation of the null field regions given the interaction between the drive coils 1406₁ and 1406₂.

As can be seen the drive coils 1406₁ and 1406₂ in this case are composed of 3 superconducting coils arranged coaxially. A set of cancelling coils 1407₁, 1407₂, the cancelling coils are positioned in an overlapping concentric arrangement with respect to the drive coils 1406₁ and 1406₂. As shown the cancelling coils are composed of 2 superconducting coils arranged coaxially. As in the above cases cancelling coils 1407₁, 1407₂ are utilised to increase the size of the null field region into which the liquid metal brush 1408 for the rotor can be positioned to ensure effective operation of the brush 1408.

In addition to cancelling coils 1407₁, 1407₂ the magnetic assemblies include an outer set of cancelling coils 1409₁, 1409₂ disposed adjacent the ends of the shaft 1403. The outer cancelling coils 1409₁, 1409₂, produce null field regions for the placement of the shaft's 1403 liquid metal brushes 1410₁, 1410₂.

In addition to the inner 1407₁,1407₂ and outer 1409₁, 1409₂ cancelling coils the magnetic assemblies 1401₁, 1401₂ also include a tertiary set of cancelling coils 1411₁, 1411₂ these coils are significantly larger in diameter than the inner 1407₁,1407₂ and outer 1409₁, 1409₂ cancelling coils and drive coils 1406₁ and 1406₂. The tertiary coils in this instance are provided to reduce the stray field profile of the turbine. The addition of these coils means that the 5 gauss line for the turbine is within a few 100 mm of the turbine.

FIG. 24A shows a field plot for the turbine of FIG. 23 without the use of the tertiary cancelling coils. As can be seen null field region 1412 is produce in the region adjacent the primary drive coils 1406₁ and 1406₂ and inner cancelling coils (i.e. within the gap between the magnetic assemblies 1401₁ and 1401₂. Null fields 1413 are also produced at opposing ends of the turbine by the outer cancelling coils. The line 1501 in this instance shows the 0.2 T cut off i.e. outside this line the field strength drops off below 0.2 T. Likewise line 1502 shows the region where the field intensity begins to drop below 0.15 T and line 1503 shows the region where the field intensity begins to drop off from 0.1 T.

FIG. 24B depicts the effects on the field when the tertiary coils are utilised. As can be seen the null field produced with the gap between the magnetic assemblies is substantially unchanged. There is some reshaping of the null field regions 1413 produced at the ends of the turbine. As can be seen the tertiary coils bring the 5 Gauss line closer to the body of the device and actively contain the stray field. In this case the 0.2 T line 1501 is within tens millimetres of the device likewise the 0.15 T line 1502. The 0.1 T line is within 100 mm or so of the device. Line 1504 in this case depicts the cut-off region where the field strength starts to drop below 500G.

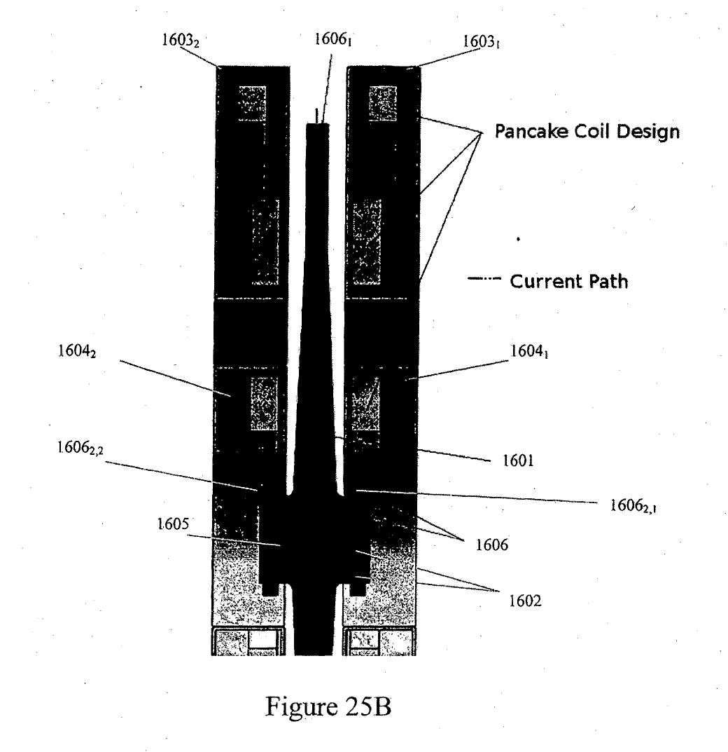

FIGS. 25A and 25B depicts a further possible arrangement of a turbine 1600 for use as high speed generator/motor according to one embodiment of the present invention. This design is possible when the diameter of the outer drive coils is sufficiently large. The inner cancelling coils can be contained within the main outer drive solenoids. This shrinks the overall length of the generator/motor assembly significantly.

The turbine 1600 includes a single rotor 1601 formed integrally with shaft 1602. The rotor is disposed between a pair of drive coil assemblies 1603₁, 1603₂. The drive coil assemblies 1603₁, 1603₂ are composed of a pair of superconducting coils arranged concentrically. As can be seen a gap is provided between each of the coils in the drive coil assemblies 1603₁, 1603₂ as previously noted the introduction of this gap enhances the size of the null field region produced between the coil assemblies 1603₁, 1603₂ for placement of the outer liquid metal brush 1606₁.

Cancelling coils 1604₁, 1604₂ are arranged concentrically with respect to the relevant drive coil assemblies 1603₁, 1603₂. As can be seen from FIG. 25B the inner cancelling coils allow the inner brushes 1606_{2,1}, 1606_{2,2} to be placed close the internal bore 1605 of the total turbine assembly. The resulting reduction in the current carrying length of the inner shaft reduces the total machine weight. FIG. 25B also shows the path of the current when the turbine is in the motor or generator configuration. As can be seen the current flows from the outer brush 1606₁ through the rotor 1601 to shaft 1602 and out brushes 1606_{2,1}, 1606_{2,2}

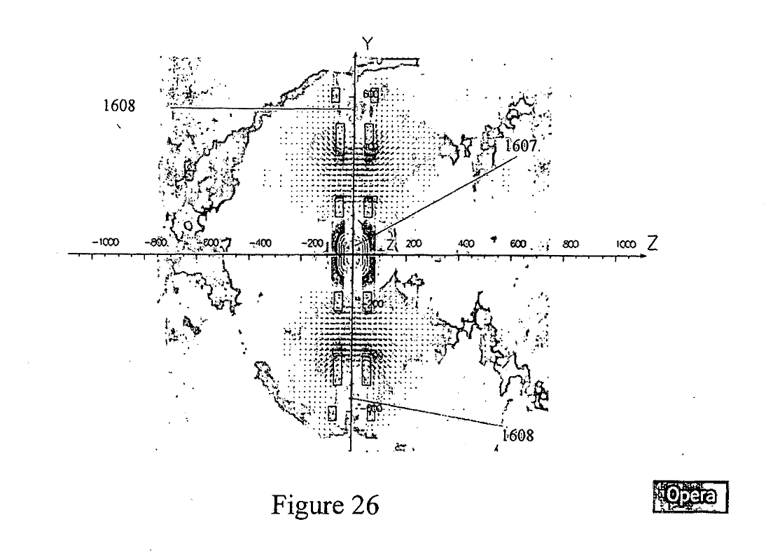

FIG. 26 is a plot of the resultant magnetic field produced by the drive coil assemblies 1603₁, 1603₂ and the cancelling coils 1604₁, 1604₂. As can be seen here a central null 1607 region is provided by cancelling coils within the region of the bore 1605. A null field region 1608 is also provided between the drive coil assemblies and is centred about the gap provided between the inner and outer coils forming each of the coil assemblies.

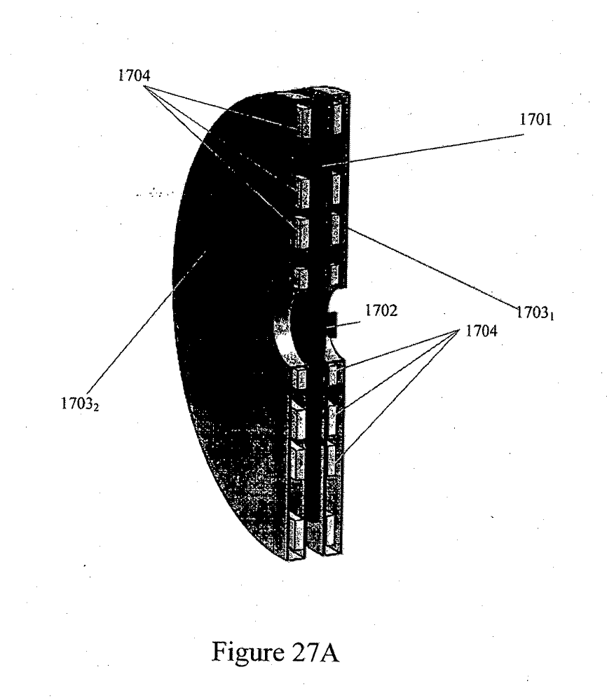

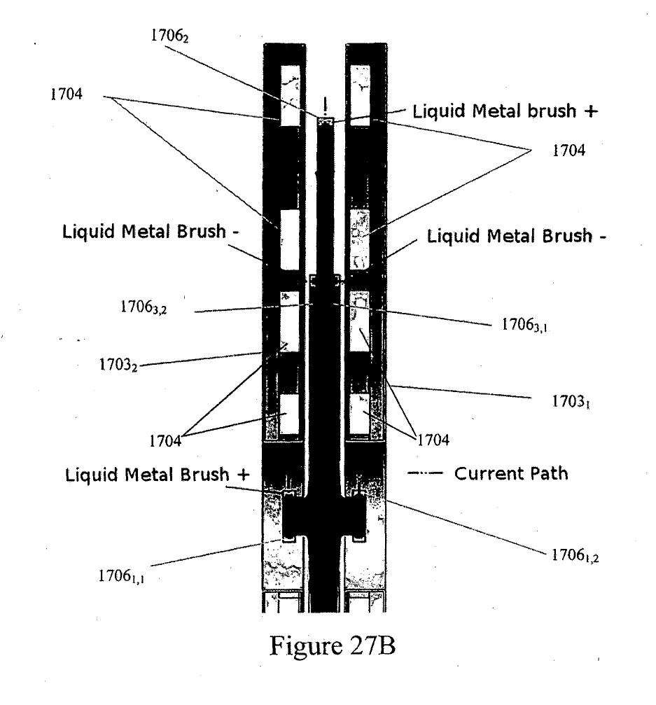

FIGS. 27A and 27B depict yet a further arrangement of a turbine for use as a high speed motor/generator. In this arrangement a single rotor 1701 which is formed integrally with shaft 1702 such that the rotor 1701 is positioned between magnetic assemblies 1703₁, 1703₂. The magnetic assemblies 1703₁, 1703₂ in this case are composed of multiple superconducting coils 1704 which are arranged concentrically. This coil arrangement creates two regions of working field on two concentric rotor working lengths by generating three null field regions allowing the placement of current input brushes on the outer and inner working radius and a central collector brush location at the radial midpoint.

FIG. 27B shows the shows the current path for this design. As the direction of the magnetic field changes at the mid-radius, the current has to be fed from the inner 1706_{1,1} 1706_{1,2} and outer radial 1706₂ brushes and collected by the mid radial brushes 1706_{3,1}1706_{3,2} in order to ensure that the correct orientation of rotation when operating as a motor. A similar connection convention must be used when operating the device as a generator in order to, ensure correct generation of current.

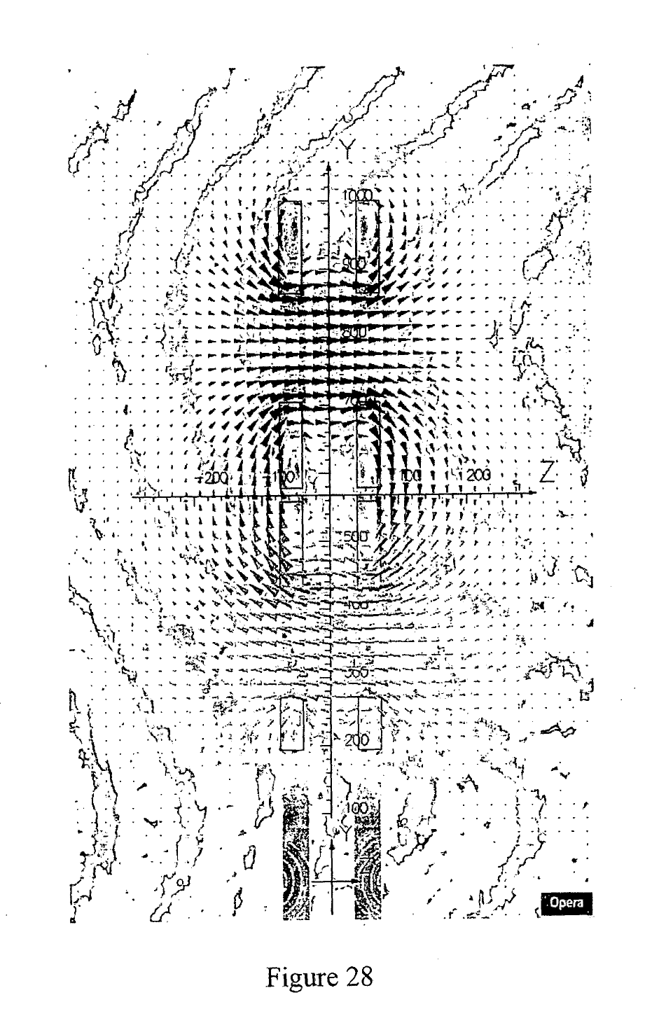

FIG. 28 is a plot of the field profile for the turbine of FIGS. 27A and 27B. As can be seen the configuration of the coils produces null field regions within the central bore 1705 and at near the circumference of the coil assemblies 1703₁, 1703₂. A further null field region is produced at the id point between the magnetic coil assemblies. It should be noted that the field null regions shown are small and could be enlarged by introducing winding gaps in the outer pancake coils in a manner similar to that discussed previously.

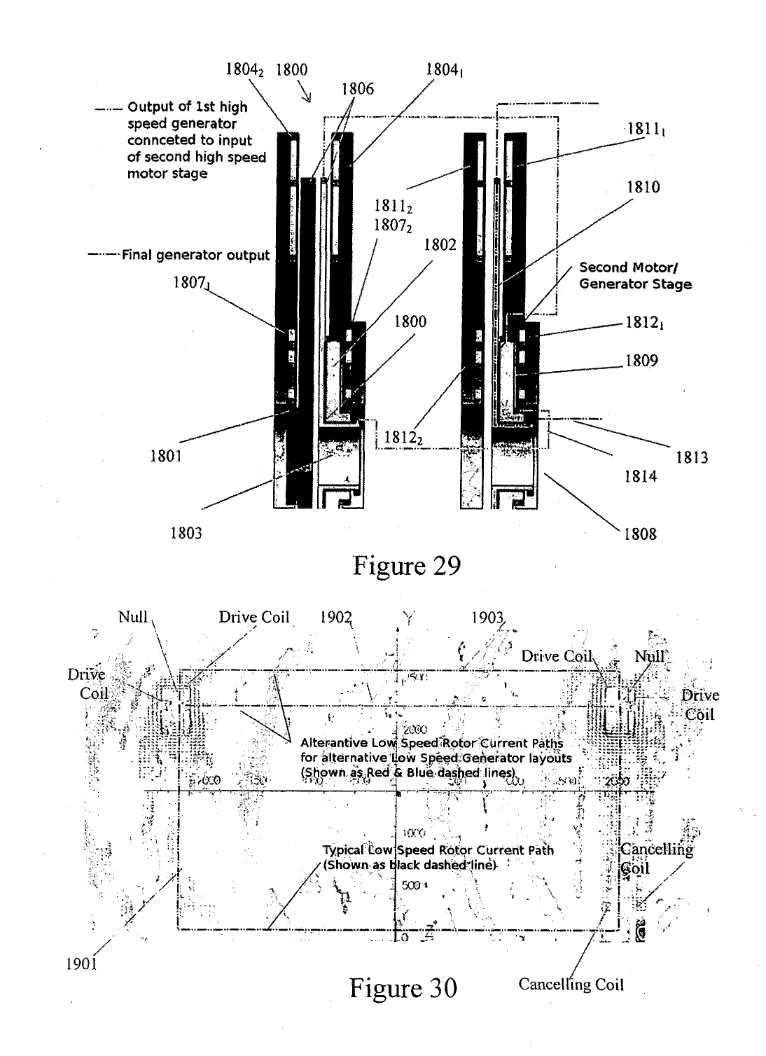

FIG. 29 depicts one possible configuration for the interconnection of two turbines for increased voltage output. As shown the first turbine 1800 is of a similar construction to that discussed above in relation to FIGS. 6A and 6B above. As can be seen the first turbine 1800 low speed generator stage 1801 and high speed generator stage 1803 positioned between. As in the above examples the primary drive coils 1804₁, 1804₂ are spaced apart to produce a null field region for the positioning of the liquid metal current transfer assemblies 1806. As shown the primary drive coils are composed of 2 concentric coils of superconducting material.

In addition to the primary drive coils a pair of inner cancelling coils 1807₁, 1807₂ are provided. The inner cancelling coils 1807₁, 1807₂ being positioned concentrically within the primary drive coils 1804₁, 1804₂. As shown the inner cancelling coils 1807₁, 1807₂ consist of a series of three concentric coils housed in cryostats. The innermost and outermost coils have a current direction that opposite to that of the outer drive coils 1804₁, 1804₂. The coils in between these cancelling coils have a positive direction of current, the same as the outer drive coils. The inner cancelling coils 1807₁, 1807₂ in this case produce additional null magnetic field regions for the placement of the liquid metal brushes for application of drive current to the high speed motor stage 1802. In addition the cancelling coils 1807₁, 1807₂ also provide the drive field for the electric motor stage 1802.

Rotation of the low speed stage 1801 within the drive field generates current that is passed to the high speed motor 1802 which generates a torque which is used to drive the high speed rotor stage 1803 directly. The rotation of the high speed rotor stage 1803 produces a current which in this example is utilised to run a secondary motor 1809 and generator 1810 stages contained within a second turbine 1808.

As shown the second turbine includes a pair of primary drive coils 1811₁, 1811₂ a pair of inner cancelling coils 1812₁, 1812₂ arranged concentrically with respect to the primary drive coils 1811₁, 1811₂. Again the cancelling coils 1812₁, 1812₂ provide the primary drive field for the electric motor stage 1809. As the current from the high speed generator stage 1803 is passed through the motor 1809 denoted by current path 1814 torque is produced. The torque is transferred directly to the high speed generator 1810 via a mechanical coupling between the motor and generator.

As the rotor of the high speed generator 1810 is spun in unison with the motor 1809 within the magnetic field produced by drive coils 1811₁, 1811₂ current is produced. The resultant output denoted by current path 1813 is at a higher voltage and a lower current than that produced at generator stage 1803.

FIG. 30 is a field plot for two turbine arrangements of a similar construction to that discussed in relation to FIGS. 11 and 12. More specifically the arrangement includes two low speed generator stages. The first generator stage disposed in the primary drive coils (coil arrangement disposed right of the plot) and the second low speed generator is disposed in the secondary drive coils (coil arrangement on the left of the plot). As in the case of FIGS. 11 and 12 current is passed along the two low speed generators via path 1901. However it would be possible to pass current along a rotor or rotors that form any path between the two outer null field regions produced by the driving coils. Examples of this are denoted by current path 1902 or by path 1903.

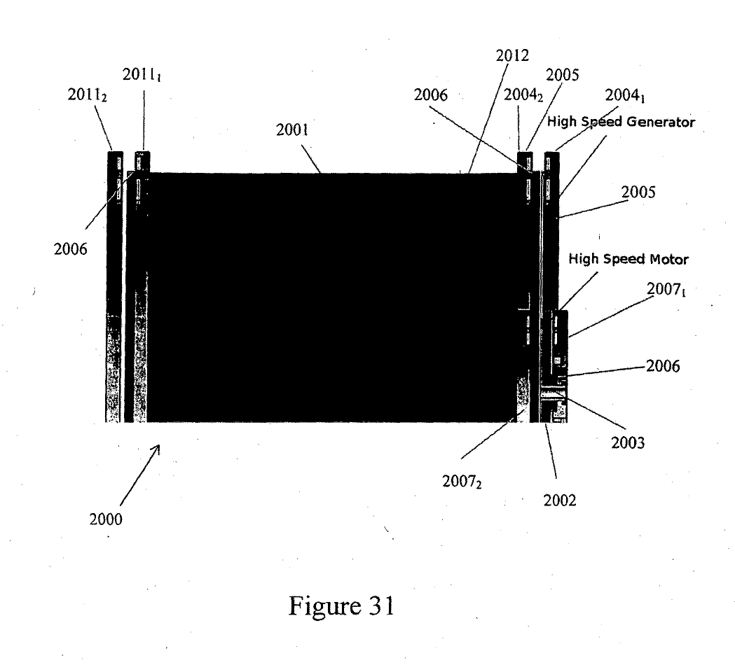

One arrangement of the turbine for use as a generator that utilises current path 1902 is shown in FIG. 31. As shown the device includes a first stage 2000 which is of a similar construction to that of the turbine of FIGS. 6A and 6B and includes a high speed generator stage 2003 positioned between a pair of primary drive coils 2004₁, 2004₂ housed in cryostats 2005. The primary drive coils 2004₁, 2004₂ are spaced apart to produce a null field region for the positioning of the liquid metal current transfer assemblies 2006. Again the primary drive coils are composed of 2 concentric coils of superconducting material.

In addition to the primary drive coils a pair of inner cancelling coils 2007₁, 2007₂ are provided. The inner cancelling coils 2007₁, 2007₂ being positioned concentrically within the primary drive coils 2004₁, 2004₂. As shown the inner cancelling coils 2007₁, 2007₂ consist of a series of three concentric coils housed in cryostats 2005. These cancelling coils produce the null field regions required for the current transfer brushes of the high speed motor stage 2002 and for the inner brush of the high speed generator stage 2003.

The low speed generator is formed by a conductive drum 2001 which passes through the gap between the secondary drive coils 2011₁ and through the gap in the primary drive coils 2004₁. The polarity of the drive coils are arranged to ensure proper current direction along the low speed generator stage.

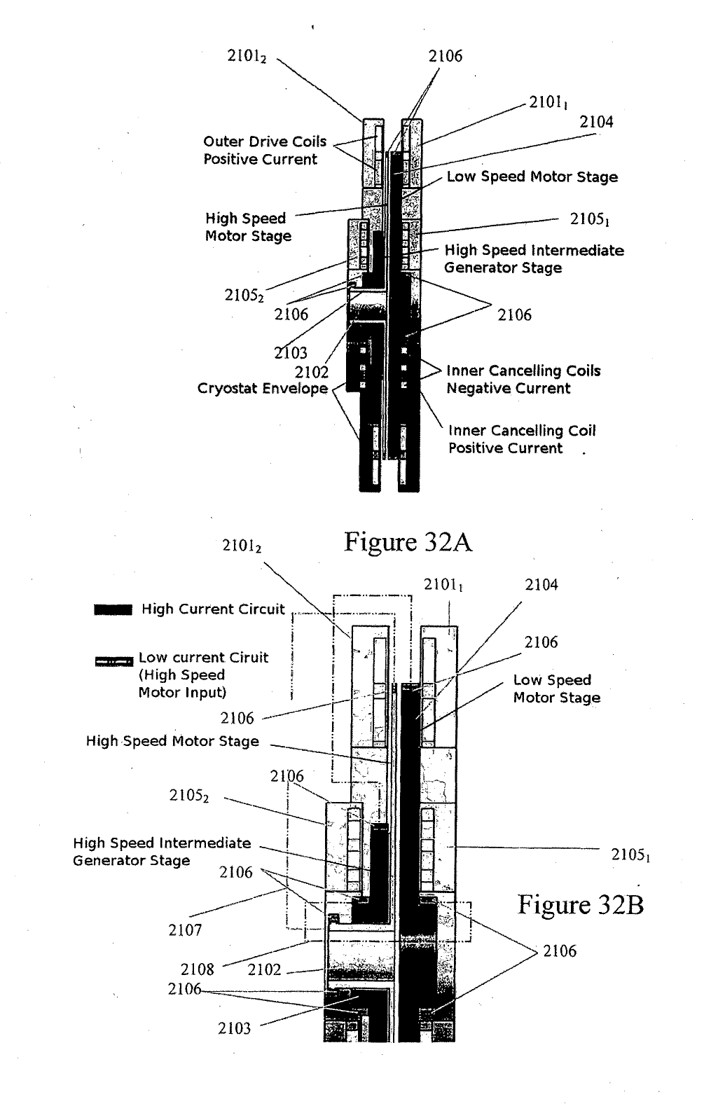

FIGS. 32A and 32B depict a turbine employing a DC-DC conversion. The turbine in this instance is configured to run as a low speed, high current motor with the application of a low current input. The structure in this case is not unlike the structure of the turbine of FIGS. 6A and 6B in that it includes three stages positioned between a set of primary drive coils 2101₁, 2101₂. As in the above case the primary coils produce a null field region for the positioning of brushes 2106 for current transfer between the relevant stages of the turbine.

As shown the turbine includes a high speed motor stage 2102 which is mechanically coupled to an intermediate high speed generator stage 2103 which is positioned between a set of cancelling coils 2105₁, 2105₂. As in the above cases the cancelling coils produce magnetic field nulls for positioning of the brushes 2106 for current transfer between the relevant stages. In addition the cancelling coils provide the primary drive field for the high speed generator stage 2103. The current generated in the high speed generator 2103 is passed to a low speed motor stage 2104.

The output produced by the high speed generator is high current and low voltage. This high current and low voltage is used to power the motor resulting in a low speed and high torque output. FIG. 32B shows the high current and low current circuits within the turbine. As can be seen low current is passed through the high speed motor denoted by current path 2107. The torque generated by the motor 2102 causes the generator 2103 to produce a high current output which is passed to the low speed motor 2104 as denoted by 2108.

As can be seen the use of a 2-stage DC-DC conversion arrangement enables the turbine to function as a homopolar gearbox, that is, producing a speed difference between the input and output shafts using the electromagnetic devices and current path. It will be appreciated by those of skill in the art that the gearing ratio (for a homopolar gearbox) or the voltage ratio (for an electromagnetic DC-DC converter) could be varied by varying the current density in the superconducting coils and hence the strength of the magnetic field acting on the rotor. In this manner a variable ratio system could be created.

While the above discussion of the converter arrangement focuses primarily on direct DC-DC conversion it will of course be appreciated by those of skill in the art that the converter could be used to convert a DC input into an AC output and vice versa. For example the generator stage of the converter could be driven by an AC motor or the output from the converter could be used to drive an AC motor/generator.

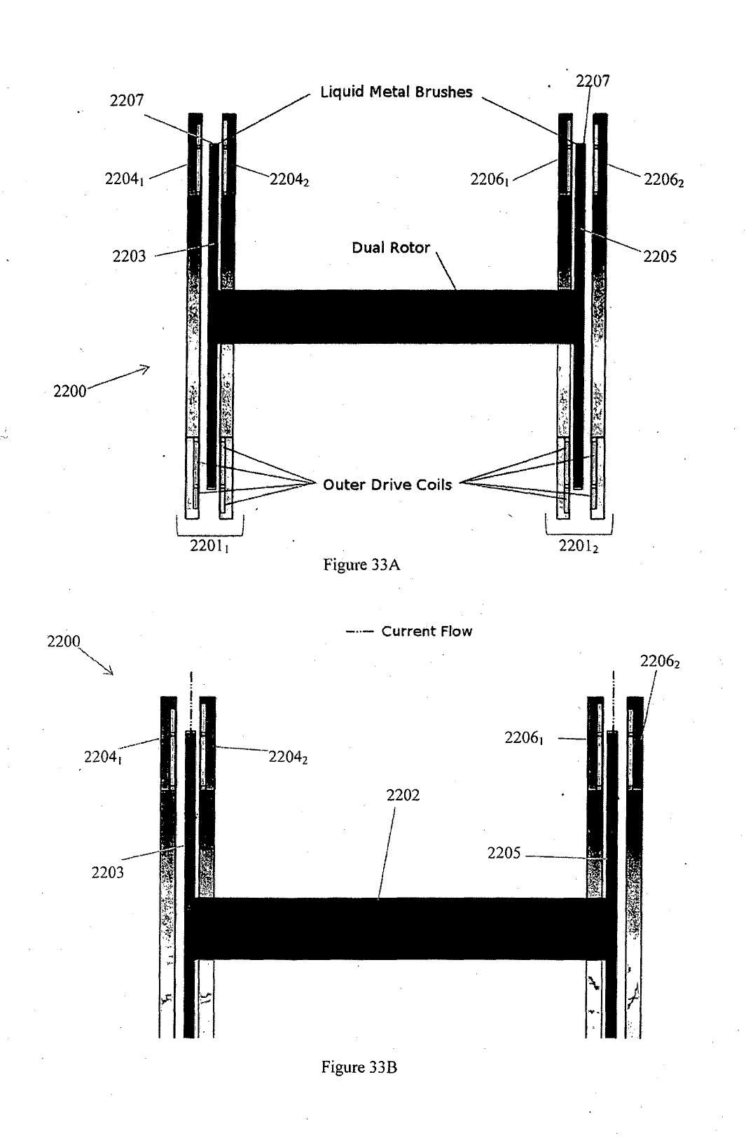

FIG. 33A depicts another possible arrangement of a turbine 2200 for power generation. The construction in this case is similar to that discussed in relation to FIG. 11 above. The turbine includes a first generator stage 2201₁ and a second generator stage 2201₂ linked via conductive shaft 2202. As shown the first generator stage 2201₁ includes a rotor 2203 positioned between a pair of superconducting elements 2204₁, 2204₂ for the provision of a magnetic drive field. Similarly the secondary generator stage 2201₂ includes a rotor 2205 disposed between a pair of superconducting elements 2206₁, 2206₂ for the provision of a magnetic drive field. Each of the superconducting elements 2204₁, 2204₂,2206₁, 2206₂ includes a pair of superconducting coils arranged concentrically. As discussed above the spacing between the pair of superconducting elements and the arrangement of the coils provides a suitable drive field as well as permitting the formation of null field regions between the superconducting elements for the placement of the liquid metal brushes 2207.

FIG. 338 depicts the current flow across the turbine 2200. As can be seen the current flow runs from the outer to the inner radius in the first rotor 2203 across shaft 2202 and through rotor 2205. As will be appreciated by those of skill in the art the superconducting elements 2204₁, 2204₂ are arranged in opposite magnetic polarity to that of the primary drive coils 2206₁, 2206₂. The reversed field polarity ensures a consistent direction of rotation in the first and second rotors.

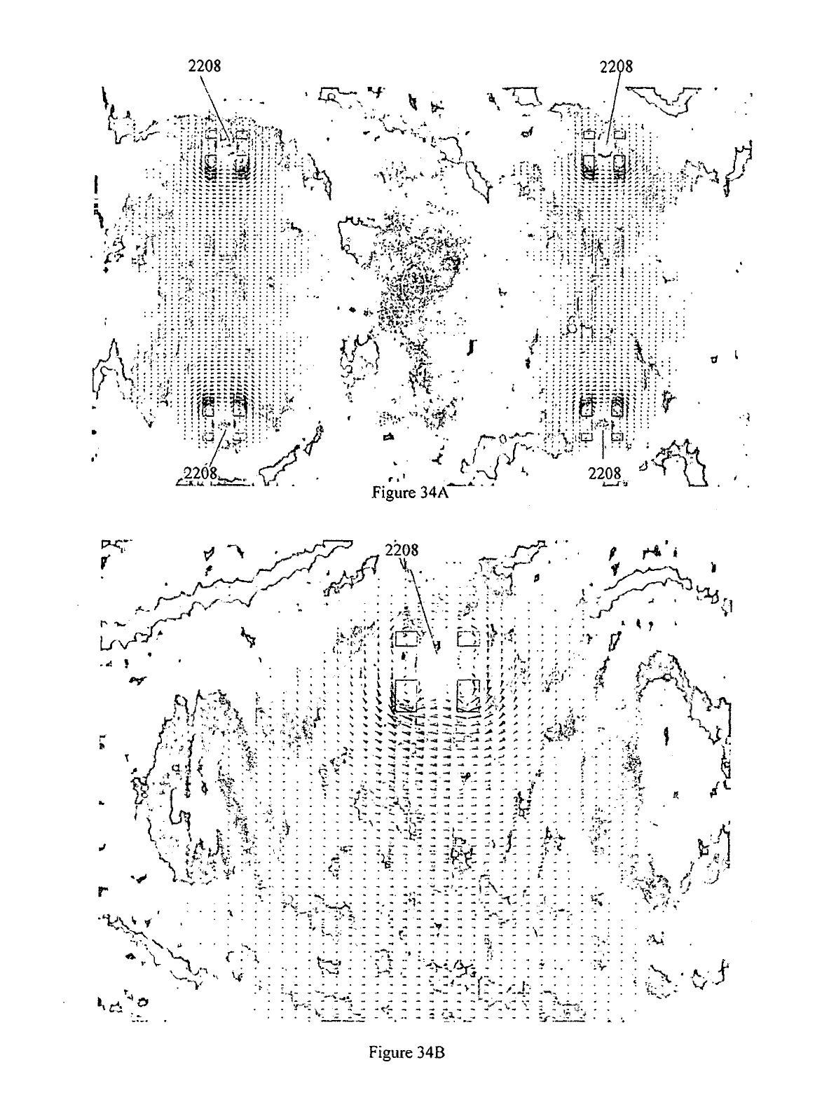

FIG. 34A is a field plot for the turbine arrangement of FIGS. 33A and 33B. As can be seen in this instance each of the coil arrangements 2204₁, 2204₂ and 2206₁, 2206₂ produces a working field region in which the rotors are suspended. In addition, each of the coil arrangements create null field regions 2208. A more detailed view of the positioning of these null field regions is shown in FIG. 34B as can be seen the null field regions 2208 are formed in the gap between the pair of superconducting elements and centred about the spacing provided between the concentric coil arrangements of the superconducting elements.

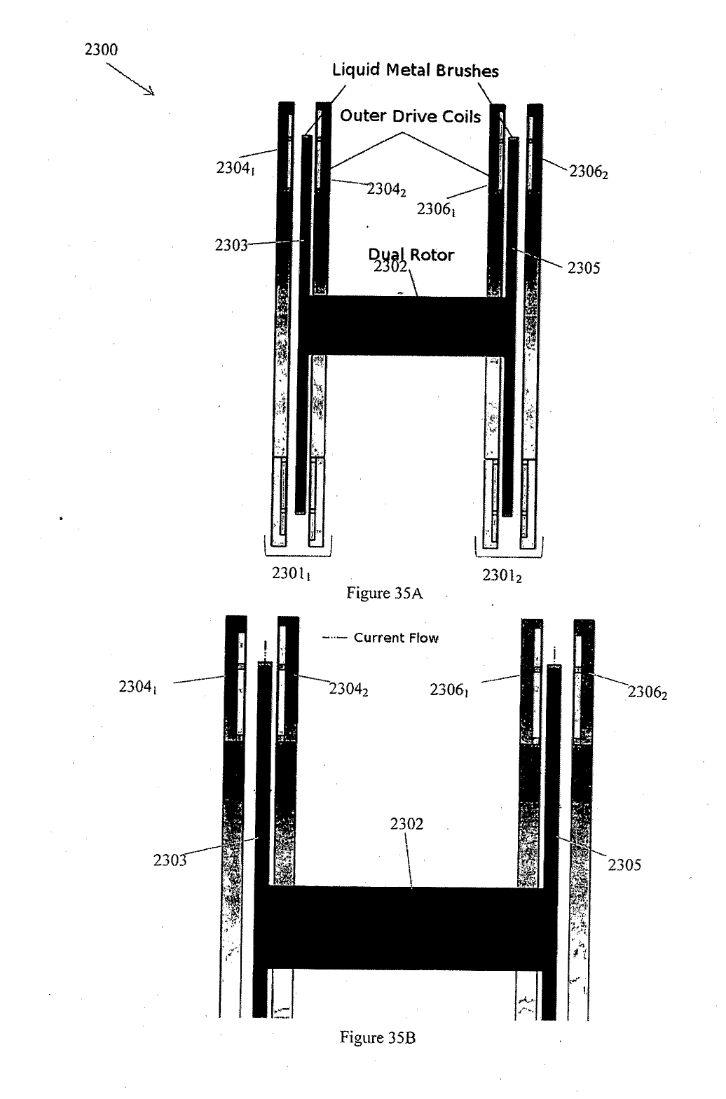

FIG. 35A depicts a further possible arrangement of a turbine 2300 according to one embodiment of the present invention. The construction in this case is similar to that discussed in relation to FIGS. 33A and 33B above. The turbine includes a first generator stage 2301₁ and a second generator stage 2301₂ linked via conductive shaft 2302. As shown the first generator stage 2301₁ includes a rotor 2303 positioned between a pair of superconducting elements 2304₁, 2304₂ for the provision of a magnetic drive field. Similarly the secondary generator stage 2301₂ includes a rotor 2305 disposed between a pair of superconducting elements 2306₁, 2306₂ for the provision of a magnetic drive field.

The current flow through the turbine 2300 is shown in FIG. 358. As can be seen the current flow runs from the outer to the inner radius in the first rotor 2303 across shaft 2302 and through rotor 2305. As will be appreciated by those of skill in the art the superconducting elements 2304₁, 2304₂ are arranged in opposite magnetic polarity to that of the primary drive coils 2306₁, 2306₂. The reversed field polarity ensures a consistent direction of rotation in the first and second rotors.

The difference between the construction of the turbine of FIGS. 35A and 35B to that of the turbine of FIGS. 33A and 33B is that the length of the shaft 2302 is significantly shorter in length. Consequently the drive coil pairs 2304₁, 2304₂ and 2306₁, 2306₂ are positioned closer together. The drive coil pairs 2304ₜ, 2304₂ and 2306₁, 2306₂ may be positioned closer together axially with some modifications to the drive coil geometry to preserve a usable region on null field. These modifications include additional turns of superconducting wire on the innermost opposing pair of drive coils and a small reduction in the diameter of the outermost main coils. In the below example the inner diameter of the outermost main drive coils are 98.5% the diameter of the innermost drive coils.

It should be noted that the force of repulsion increases significantly with this reduction in the axial gap. A reduction in this distance of 2.5 times results in an increase in the repulsion force by a factor of 10 times. With this in mind, this technique would tend to be used only when the axial length of the device is at a premium.

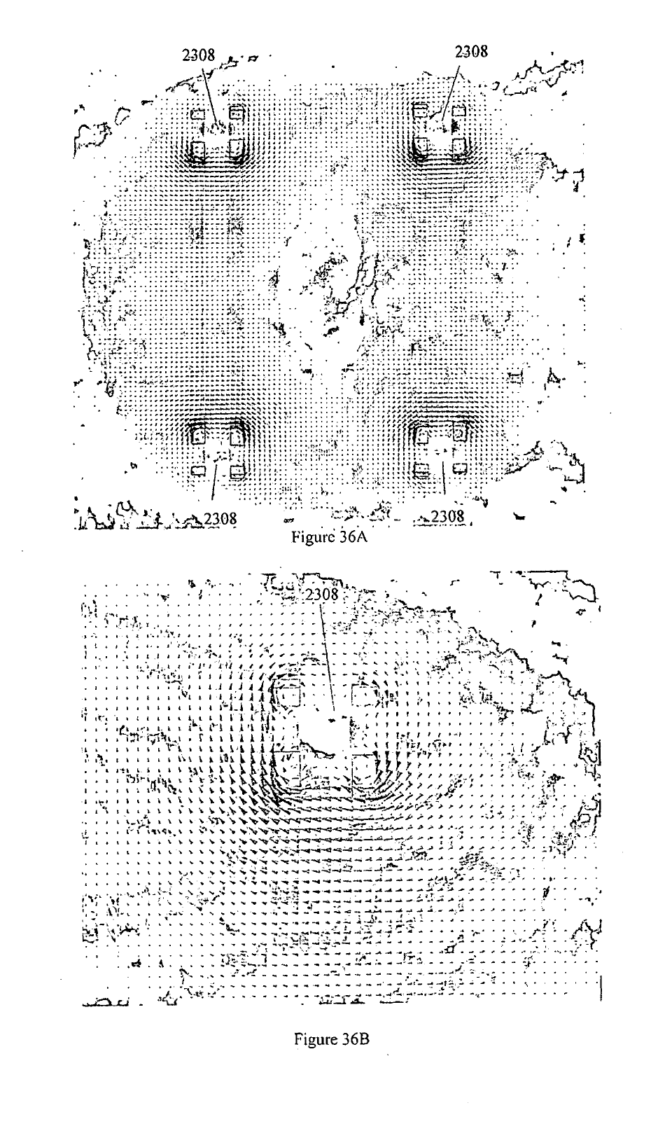

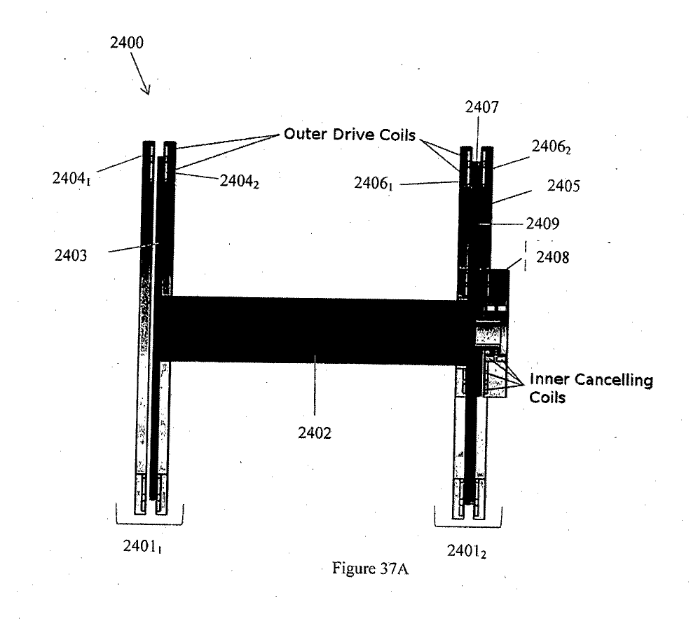

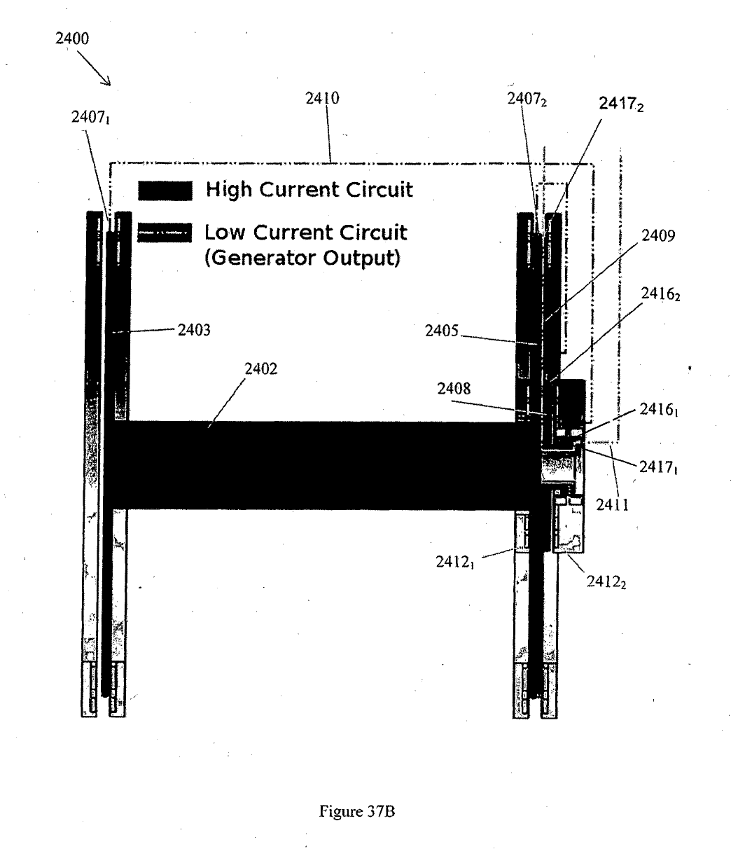

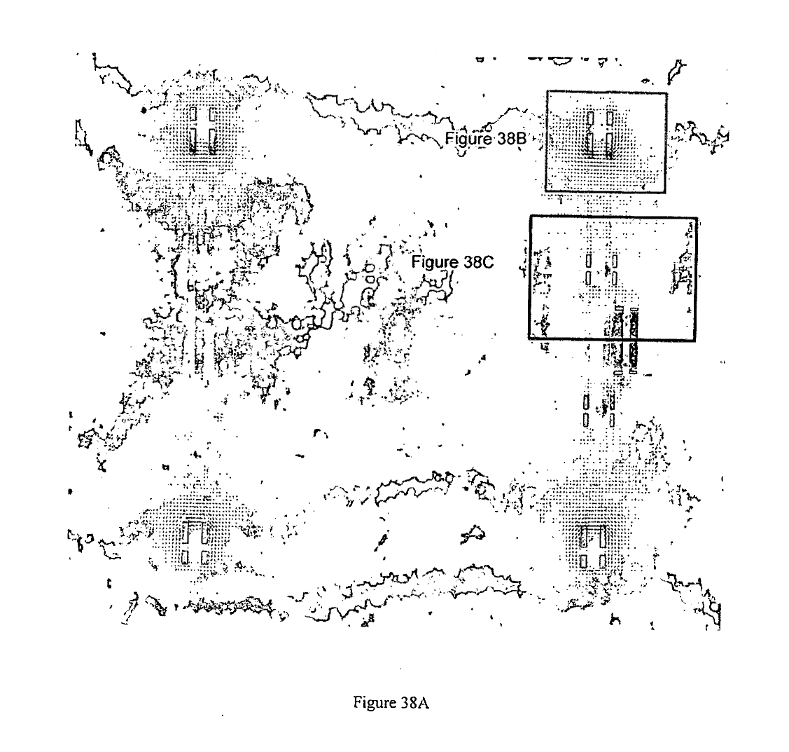

FIG. 36A is a field plot for the turbine arrangement of FIGS. 35A and 35B. As can be seen in this instance each of the coil arrangements 2304₁, 2304₂ and 2306₁, 2306₂ produces a working field region in which the rotors are suspended. In addition each of coil arrangements create null field regions 2308 between the drive coil pairs. A more detailed view of the positioning of these null field regions is shown in FIG. 37B as can be seen the null field regions 2308 are formed in the gap between the pair of superconducting elements and centred about the spacing provided between the concentric coil arrangements of the superconducting elements.

FIG. 37A depicts a further possible arrangement of a turbine 2400 according to one embodiment of the present invention. The construction in this case is similar to that discussed in relation to FIGS. 33A and 33B above. The turbine includes a first generator stage 2401₁ and a second generator stage 2401₂ linked via conductive shaft 2402. As shown the first generator stage 2401₁ includes a rotor 2403 positioned between a pair of superconducting elements 2404₁, 2404₂ for the provision of a magnetic drive field. Similarly the secondary generator stage 2401₂ includes a rotor 2405 disposed between a pair of superconducting elements 2406₁, 2406₂. for the provision of a magnetic drive field.

The second generator stage 2401₂ is electrically coupled via liquid metal brushes 2407 to a high speed motor stage 2408 which is mechanically coupled to a high speed generator stage 2409 mounted between the pair of superconducting elements 2406₁, 2406₂ adjacent the rotor 2405 of the second generator stage 2401₂.

The current flow through the turbine 2400 is shown in FIG. 37B. In this instance there are two current circuits, a tow current circuit denoted by 2411 and a high current circuit denoted by 2410. As can be seen the high current circuit 2410 runs from the outer to the inner radius in the first rotor 2403 across shaft 2402 and through rotor 2405 to brush 2407₂. The brush 2407₂ is then coupled to the input brush 2416₂ of the high speed motor 2408. The current is then passed across the motor 2408, out brush 2416₁ back to the rotor 2403 via brush 2407₁ to complete the series circuit. As current is passed through the motor 2408 it produces torque which is then transferred to the high speed generator 2409. The rotation of the generator 2409 in the field produces a current 2411 which is drawn off via brushes 2417₁, 2417₂.

As can be seen the turbine 2400 of FIGS. 37A and 37B also includes cancelling coils 2412 arranged concentrically with superconducting elements 2406₁, 2406₂. Unlike previously discussed constructions the width of the inner cancelling coils have been increased in order to create a null field region that is better suited to the preferred placement of the liquid metal brush assemblies. In addition to the increase in their width, the inner cancelling coil has an axial offset and a slight increase in the number of turns and hence a larger outer diameter than its co-cancelling coils. Both inner cancelling coils are positioned on the lateral outsides of the rotor assemblies.

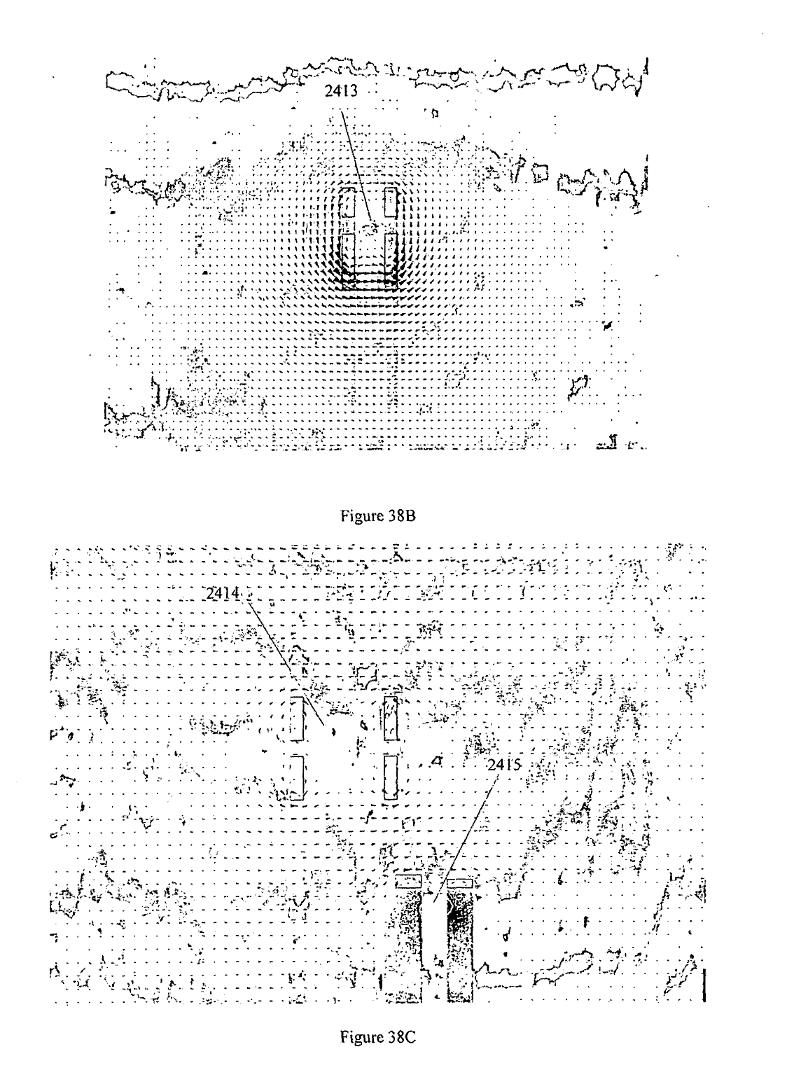

FIG. 38A is a field plot depicting the location of the null field regions produced by the coil arrangement of the turbine of FIGS. 37A and 37B, with detail illustrated in FIGS. 38B and 38C. FIG. 38B particularly depicts the null field region 2413 produced between each pair of the super conducting elements 2404₁, 2404₂,2406₁, 2406₂. As in the above examples, the null field region is produced in the gap between the pair of superconducting elements and centred about the spacing provided between the concentric coil arrangements of the superconducting elements. FIG. 38C depicts the null field regions produced by the cancelling coils 2412. As can be seen a null field region 2414 is formed between the outer cancelling coils in addition a null 2415 is produced in the space provided between the outer set of cancelling coils.

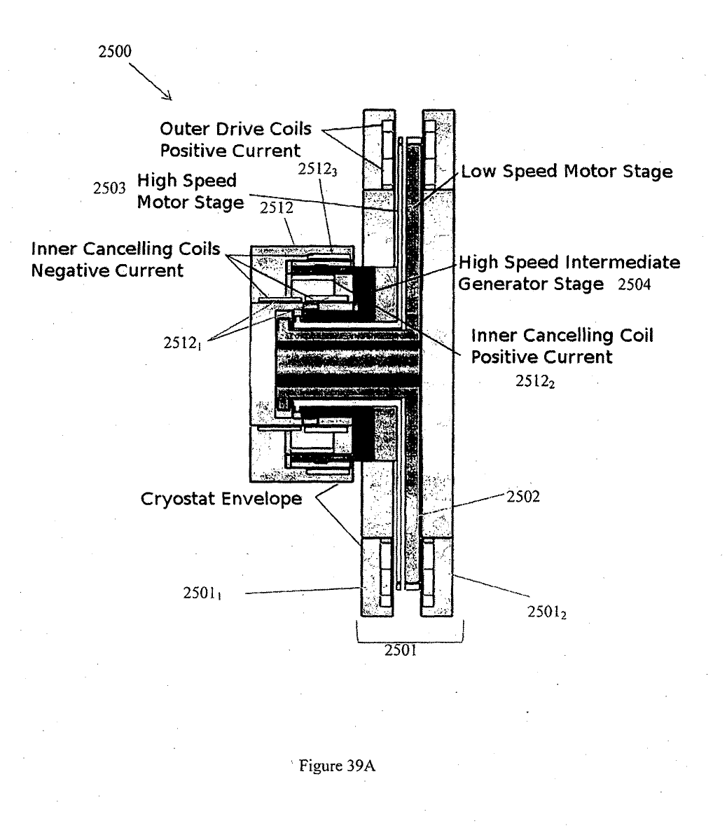

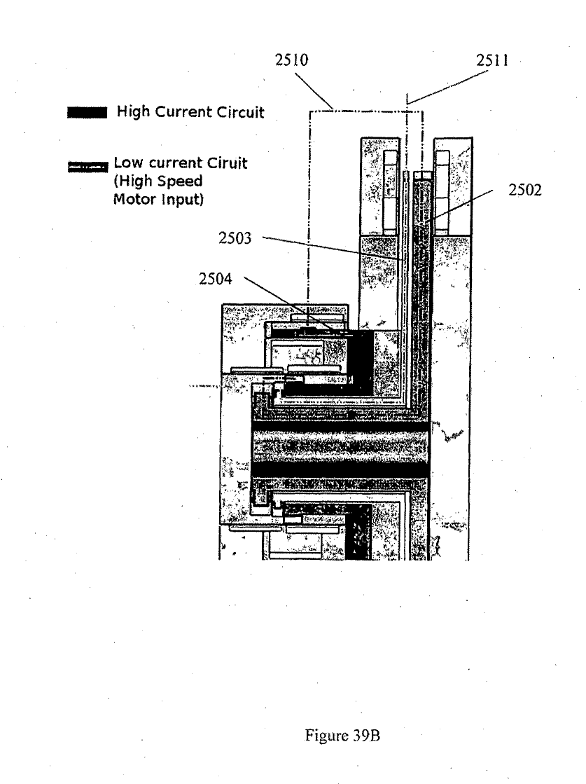

A further possible configuration of a turbine 2500 according to the present invention is depicted in FIG. 39A. In this design, the cancelling coil assembly 2512 used to produce the inner nulls have been shifted outside the drive coil assembly 2501. As in the above examples the main drive coil assembly 2501 includes a pair of superconducting elements 2501₁, 2501₂ each element including a pair of concentrically arranged superconducting coils. Disposed between the superconducting elements 2501₁, 2501₂ are low speed motor stage 2502 and high speed motor stage 2503 which are electrically and mechanically isolated from each other.

As mentioned above the cancelling coils in this example are positioned outside the main drive coil 2501 assembly. As can be seen in this instance the cancelling coils 2512 are arranged co-axial with the main drive coil assembly 2501. The cancelling coil assembly 2512 in this case includes three sets of coils arranged substantially concentrically. The inner most coil set 2512₁ includes a pair of coils arranged in parallel these being concentric with the middle coil 2512₂ of the coil assembly 2512. The outer most coil 2512₃ is positioned in an overlapping concentric arrangement with inner most and middle coils. A high speed generator 2504 is arranged such that a portion of the generator is disposed between the outer most cancelling coil 2512₃ and the middle coil 2512₂ and a portion between the inner most coil 2512₁ and the middle coil 2512₂. As such the high speed generator stage 2504 is substantially C-shaped with a section of the generator extending into the bore of superconducting element 2501₁. The generator 2504 is mechanically coupled to but electrically isolated from the high speed motor stage 2503.

FIG. 39B depicts the current flow through the turbine of 39 A. In this case there is again a high current circuit 2510 and a low current circuit 2511. As current is applied 2511 across the high speed motor stage 2503 torque is generated this is then transferred directly to the generator 2504 which procures the drive current 2510 for the low speed motor stage 2502. As current is passed through the low speed motor, a torque is produced. As can be seen in this case the arrangement is able to translate high speed rotational energy to low speed rotational energy with no rectifying electronics.

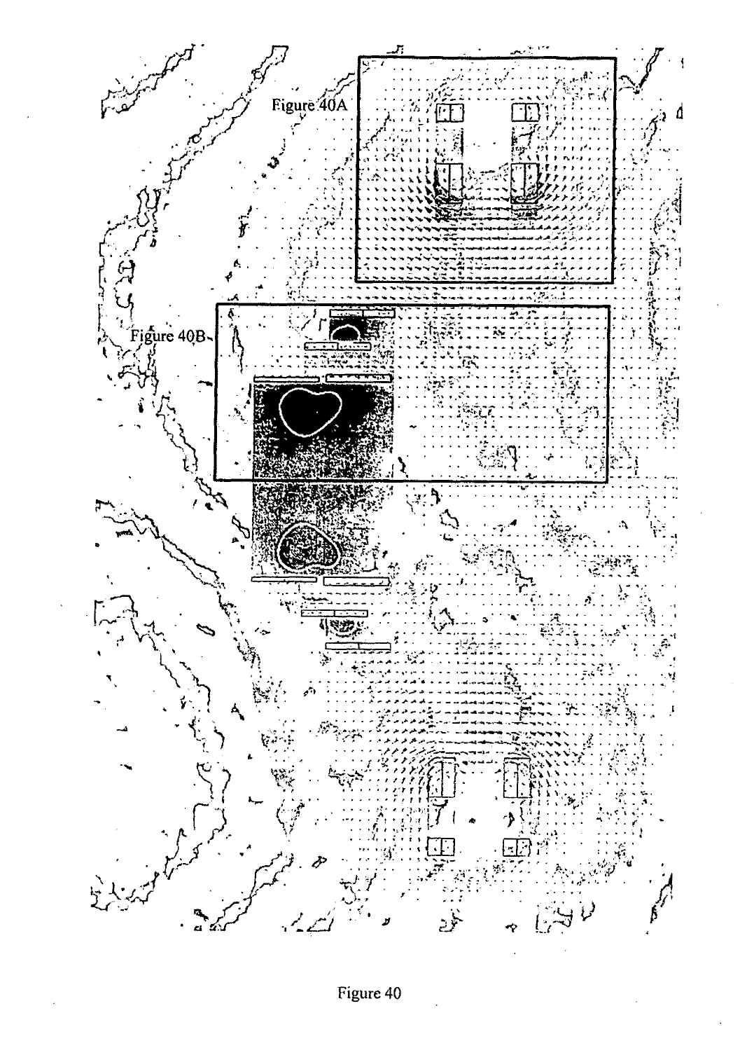

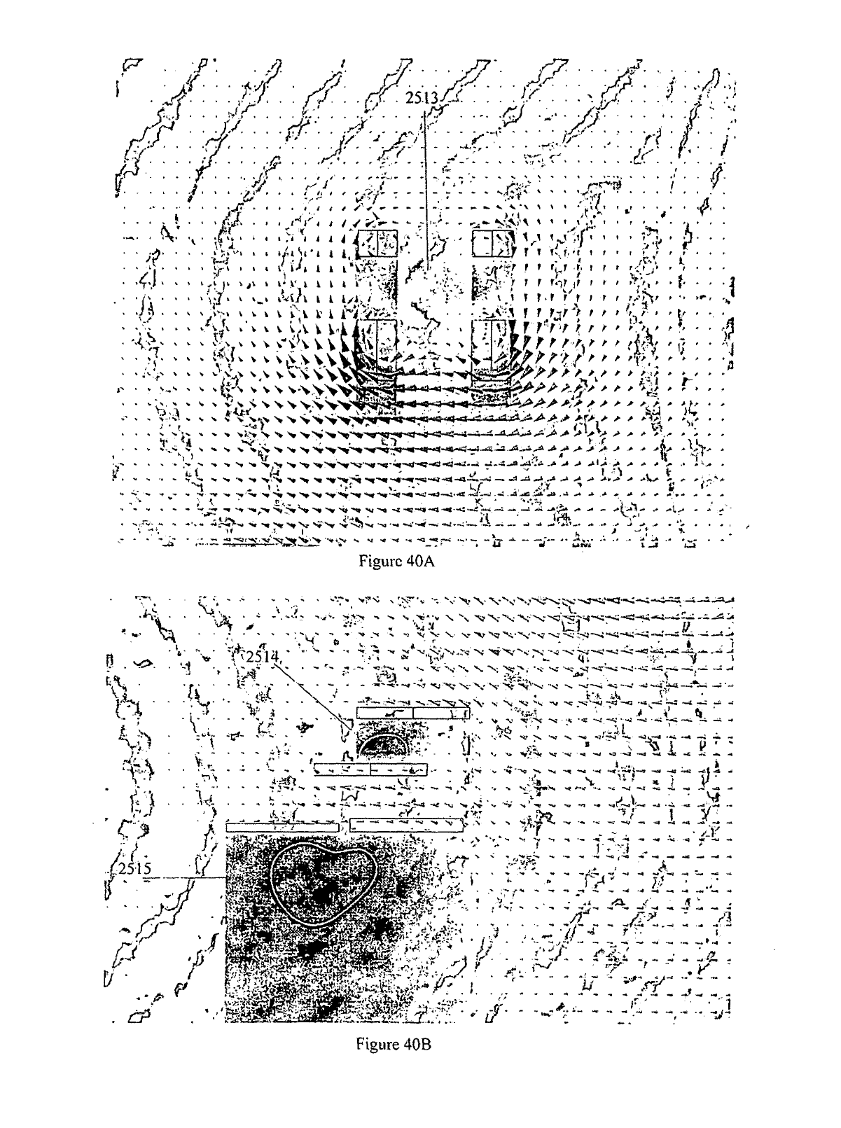

FIGS. 40,40A and 40B are field plots of the coil arrangement of the turbine of FIGS. 39A and 39B. Again a null field region 2513 is produced between in the gap between the pair of superconducting elements and centred about the spacing provided between the concentric coil arrangements of the superconducting elements as illustrated in FIG. 40A. The cancelling coil arrangement in this instance illustrated in FIG. 40B produces two sets of null field regions 2514, 2515, a null being produced between the outer most and middle coils 2514 and nulls 2515 produced within the innermost coils. The two innermost solenoids are not equal in terms of their number of turns. The innermost solenoid closest to the axial gap in the outer drive coils has a larger number of turns to compensate for the higher field strength that has to be cancelled.

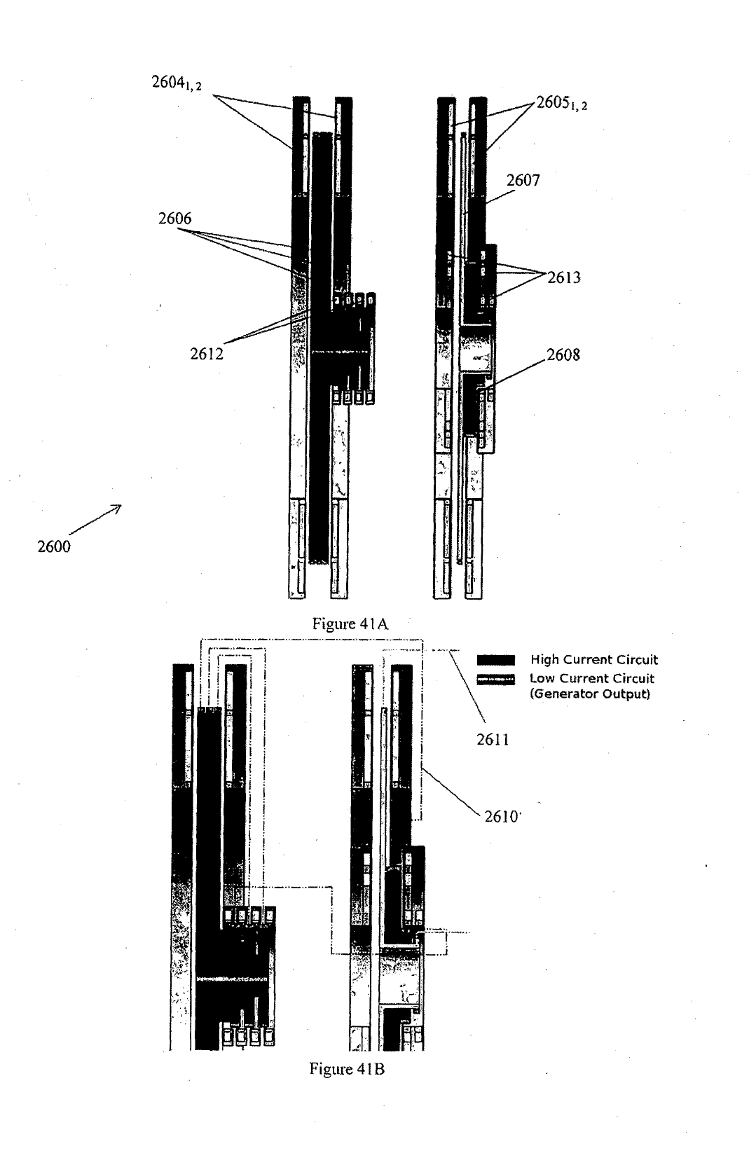

FIG. 41A depicts a further possible arrangement of a turbine 2600 according to one embodiment of the present invention. This configuration is similar to that illustrated in FIG. 6A but with a laminated low speed rotor assembly coupled in series with separation between the low speed and high speed portions.

As shown the turbine 2600 in this case includes a pair of superconducting drive coils 2604₁, and 2604₂ for the production of the primary magnetic field about a laminated low speed generator stage 2606 and a second pair of superconducting drive coils 2605₁, and 2605₂ for the production the primary magnetic field about the high speed generator rotor 2607 and the high speed motor 2608. The low speed rotor is a series of three rotor portions 2606 each having a disk portion and a shaft portion.

Cancelling coils are provided coaxially with each of the pairs of superconducting drive coils. The cancelling coils 2612 provided relative to the superconducting drive coils 2604₁, and 2604₂ are provided in a location similar to that illustrated and explained in relation to FIG. 4A. The cancelling coils 2613 provided relative to the superconducting drive coils 2605₁, and 2605₂ are provided in a location similar to that illustrated and explained in relation to the embodiment illustrated in the Secondary generator stage 2401₂ of FIG. 37A.

FIG. 41B depicts the current flow through the turbine of FIG. 41A. Again, there is a high current circuit 2610 and a low current circuit 2611. As the high, current flows through the respective laminated rotors of the low speed generator stage and across the high speed motor stage 2608 torque is generated which is then transferred directly to the generator 2607 which creates the low current 2611 generator output.

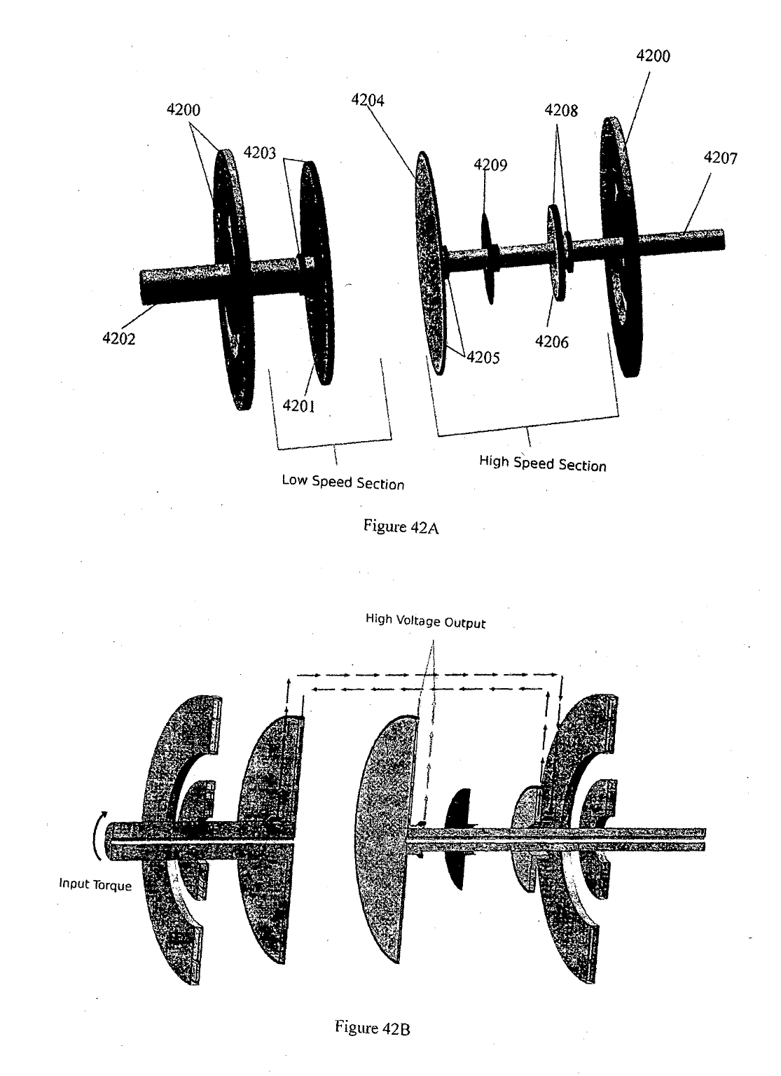

FIGS. 42A to 51 illustrate a number of basic configurations of the present invention. Each of these basic configurations can be thought, of, as a unit process with one or more unit processes combined to achieve a required outcome. It is important to note that variations of the invention could be produced as extensions on the basic two-stage unit processes illustrated in FIG. 46A to FIG. 51. All of these figures show exploded views of the components. The current path illustrations also show the components in section.

Additionally, while descriptors such as ‘low’ and ‘high’ may have been applied to the examples given, these should not be seen as in any way limiting possible implementations. They are merely provided for the purpose of illustrating the capacity to provide a relative ‘step up’ or ‘step down’ of voltage, current and/or speed values.

The directions of current flow and torque value arrows are shown for indicative purposes only. Different electrical and mechanical connections could be made allowing co-rotation or counter-rotation of isolated sections—something that would be readily apparent to anyone of sufficient skill.

The following basic configurations are explicitly clarified, each of which may form an alternative aspect of the present invention:

### 3 Stage Configurations:

A Low Speed. Mechanical Input to High Voltage Electrical DC Output is illustrated in FIGS. 42A and 42B. This configuration includes two pairs of stationary superconducting coils 4200, a first pair of outer, annular coils and a second pair of inner annular coils which are spaced concentrically inwardly within the outer annular coils. The configuration is divided into a low speed section and a high-speed section as designated in FIG. 42A.

The low speed section includes a low speed generator rotor 4201 attached to a low speed mechanical input shaft 4202. Liquid metal brushes 4203 are provided for the low speed generator rotor 4201.

The high-speed section includes a high-speed generator rotor 4204 with associated Liquid metal brushes 4205. A high-speed motor rotor 4206 is mounted on a high-speed assembly shaft 4207 which also mounts the high-speed generator rotor 4204. Again, the high-speed motor rotor 4206 is provided with liquid metal brushes 4208 for current transfer. The high-speed motor rotor 4206 and the high-speed generator rotor 4204 are mechanically connected but electrically insulated through the provision of electrical insulation collar 4209.

The current paths in the configuration are illustrated in FIG. 42A are illustrated in FIG. 42B and include a high voltage low current output. A low voltage high current path is also illustrated between the liquid metal brushes 4203 on the low speed generator rotor 4201 and the liquid metal brushes 4208 on the high-speed motor rotor 4206.

The operation of this configuration is as described in relation to FIGS. 6A and 6B but is basically directed towards conversion of low speed torque input to high voltage, low current DC electrical output.

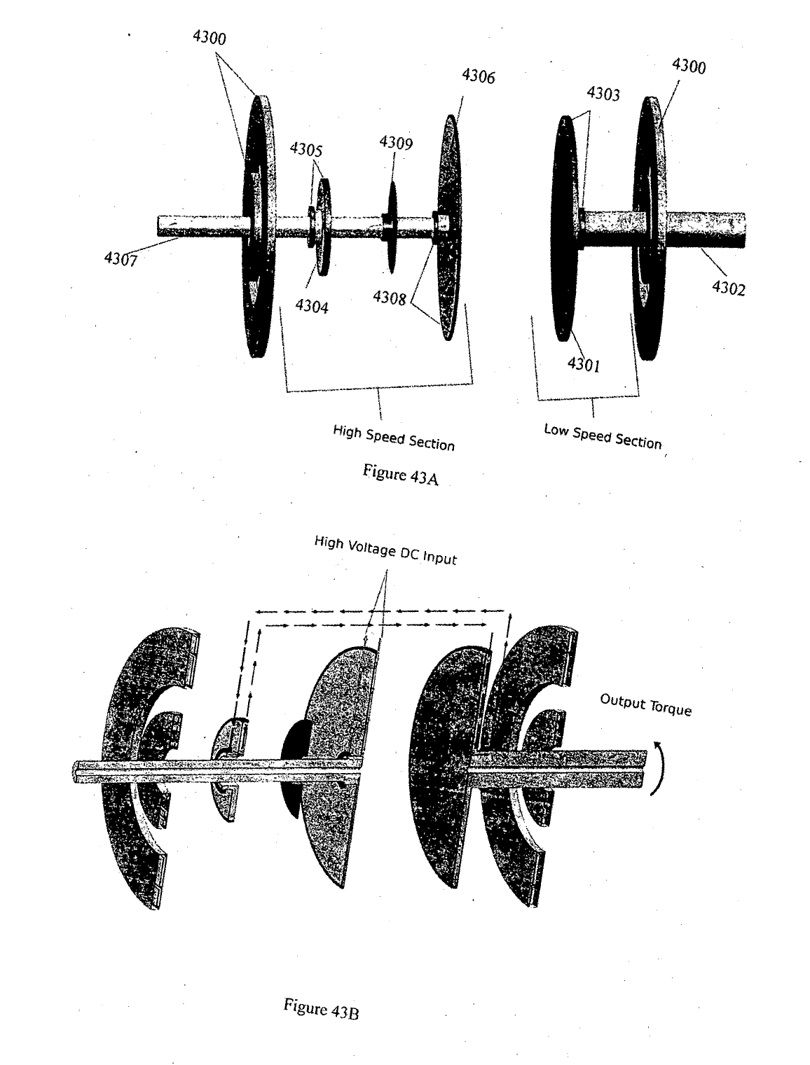

A High Voltage DC Input to Low Speed Mechanical Output is illustrated in FIGS. 43A and 43B. This configuration also includes two pairs of stationary superconducting coils 4300, a first pair of outer, annular coils and a second pair of inner annular coils which are spaced concentrically inwardly within the outer annular coils. The configuration is divided into a low speed section and a high-speed section as designated in FIG. 43A.

However, this configuration is basically the reverse configuration of that illustrated in FIGS. 42A and 42B. In this configuration, the high-speed section includes a high-speed generator rotor 4304 with associated liquid metal brushes 4305. A high-speed motor rotor 4306 is mounted on a high-speed assembly shaft 4307 which also mounts the high-speed generator rotor 4304. Again, the high-speed motor rotor 4306 is provided with liquid metal brushes 4308 for current transfer. The high-speed motor rotor 4306 and the high-speed generator rotor 4304 are mechanically connected but electrically insulated through the provision of electrical insulation collar 4309.

The low speed section includes a low speed motor rotor 4301 attached to a low speed mechanical output shaft 4302. Liquid metal brushes 4303 are provided for the low speed motor rotor 4301.

The current paths in the configuration are illustrated in FIG. 43A are illustrated in FIG. 43B and include a high voltage low current input. A low voltage, high current path is also illustrated between the liquid metal brushes 4303 on the low speed motor rotor 4301 and the liquid metal brushes 4305 on the high-speed generator rotor 4304.

As mentioned above, this configuration is basically the reverse of the configuration illustrated in FIGS. 42A and 42B and is directed towards conversion of high voltage, low current DC electrical input to low speed, high torque mechanical output.

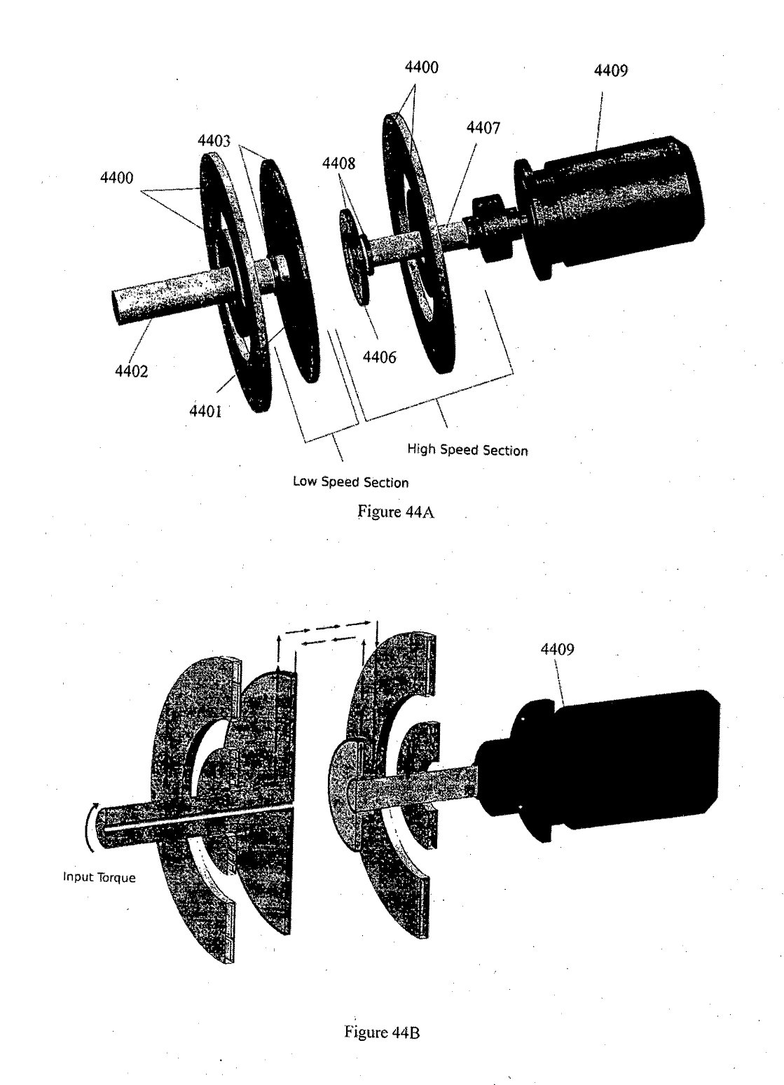

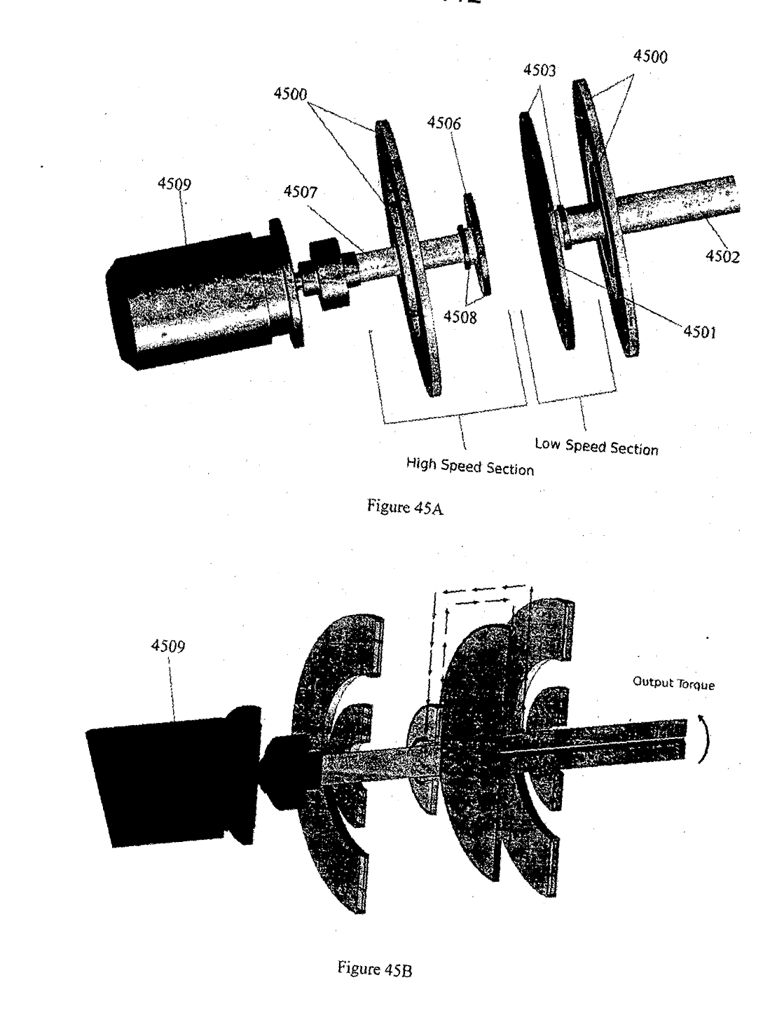

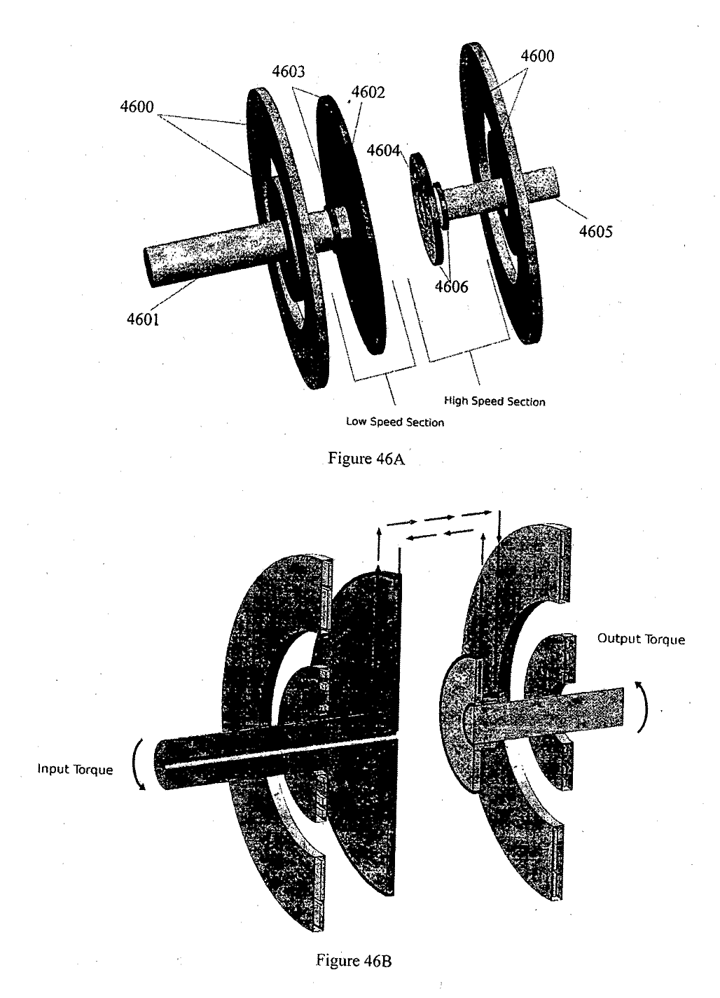

A Low Speed Mechanical Input to an AC Generator is illustrated in FIGS. 44A and 44B. As with the two previous configurations, this configuration also includes two pairs of stationary superconducting coils 4400, a first pair of outer, annular coils and a second pair of inner annular coils which are spaced concentrically inwardly within the outer annular coils. The configuration is divided into a low speed section and a high-speed section as designated in FIG. 44A.

The low speed section includes a low speed generator rotor 4401 attached to a low speed mechanical input shaft 4402. Liquid metal brushes 4403 are provided for the low speed generator rotor 4401.

The high-speed section includes a high-speed motor rotor 4406 mounted to a high-speed assembly shaft 4407 and the high-speed motor rotor 4406 is provided with liquid metal brushes 4408 for current transfer. The high-speed assembly shaft then feeds a high-speed AC generator 4409 output directly for the production of AC electrical output.

The current path is illustrated in FIG. 44B. In this configuration, low voltage high current path is provided between the liquid metal brushes 4403 on the low speed generator rotor 4401 and the liquid metal brushes 4408 on the high-speed motor rotor 4406.

An AC Motor to Low Speed Mechanical Output is illustrated in FIGS. 45A and 45B. As mentioned above, this configuration is basically the reverse of the configuration illustrated in FIGS. 44A and 44B.

This configuration also includes two pairs of stationary superconducting coils 4500, a first pair of outer, annular coils and a second pair of inner annular coils which are spaced concentrically inwardly within the outer annular coils. The configuration is divided into a low speed section and a high-speed section as designated in FIG. 45A.

The low speed section includes a low speed motor rotor 4501 attached to a low speed mechanical output shaft 4502. Liquid metal brushes 4503 are provided for the low speed motor rotor 4501.

The high-speed section includes a high-speed generator rotor 4506 mounted to a high-speed assembly shaft 4507 and the high-speed generator rotor 4506 is provided with liquid metal brushes 4508 for current transfer. The high-speed assembly shaft 4507 is driven by a high-speed AC generator 4509 input directly for the conversion of the AC electrical input to low speed, high torque output.

The current path is illustrated in FIG. 45B. In this configuration, low voltage high current path is provided between the liquid metal brushes 4503 on the low speed motor rotor 4501 and the liquid metal brushes 4508 on the high-speed generator rotor 4506.

### 2 Stage Configurations:

A Homopolar Electromagnetic Gearbox for conversion of low speed mechanical input to high speed mechanical output is illustrated in FIGS. 46A and 46B. This configuration also includes two pairs of stationary superconducting coils 4600, a first pair of outer, annular coils and a second pair of inner annular coils which are spaced concentrically inwardly within the outer annular coils. The configuration is divided into a low speed section and a high-speed section as designated in FIG. 46A.

A low speed mechanical input shaft 4601 mounts a low speed generator rotor 4602 such that the liquid metal brushes 4603 are positioned between the stationary superconducting coils 4600. A high-speed motor rotor 4604 is mounted to a high-speed mechanical output shaft 4605. The high-speed motor rotor 4604 is provided with liquid metal brushes 4606 to create a low voltage high current path between the liquid metal brushes 4606 on the high-speed motor rotor 4604 with the liquid metal brushes 4603 on the low speed generator rotor 4602. This current path is illustrated more particularly in FIG. 46B.

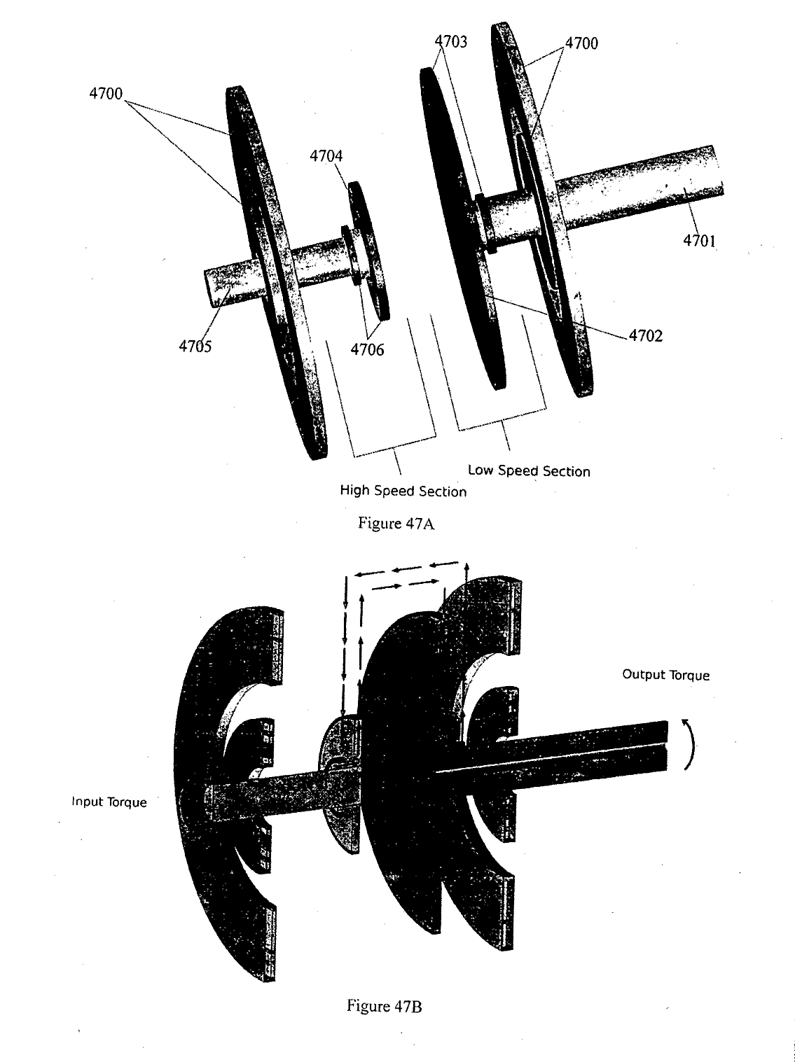

A Homopolar Electromagnetic Gearbox for conversion of high speed mechanical input to low speed mechanical output is illustrated in FIGS. 47A and 47B. This configuration also includes two pairs of stationary superconducting coils 4700, a first pair of outer, annular coils and a second pair of inner annular coils which are spaced concentrically inwardly within the outer annular coils. The configuration is divided into a low speed section and a high-speed section as designated in FIG. 47A.

A low speed mechanical output shaft 4701 mounts a low speed motor rotor 4702 such that the liquid metal brushes 4703 are positioned between the stationary superconducting coils 4700. A high-speed generator rotor 4704 is mounted to a high-speed mechanical input shaft 4705. The high-speed generator rotor 4704 is provided with liquid metal brushes 4706 to create a low voltage high current path between the liquid metal brushes 4706 on the high-speed generator rotor 4704 with the liquid metal brushes 4703 on the low speed motor rotor 4702. This current path is illustrated more particularly in FIG. 47B.

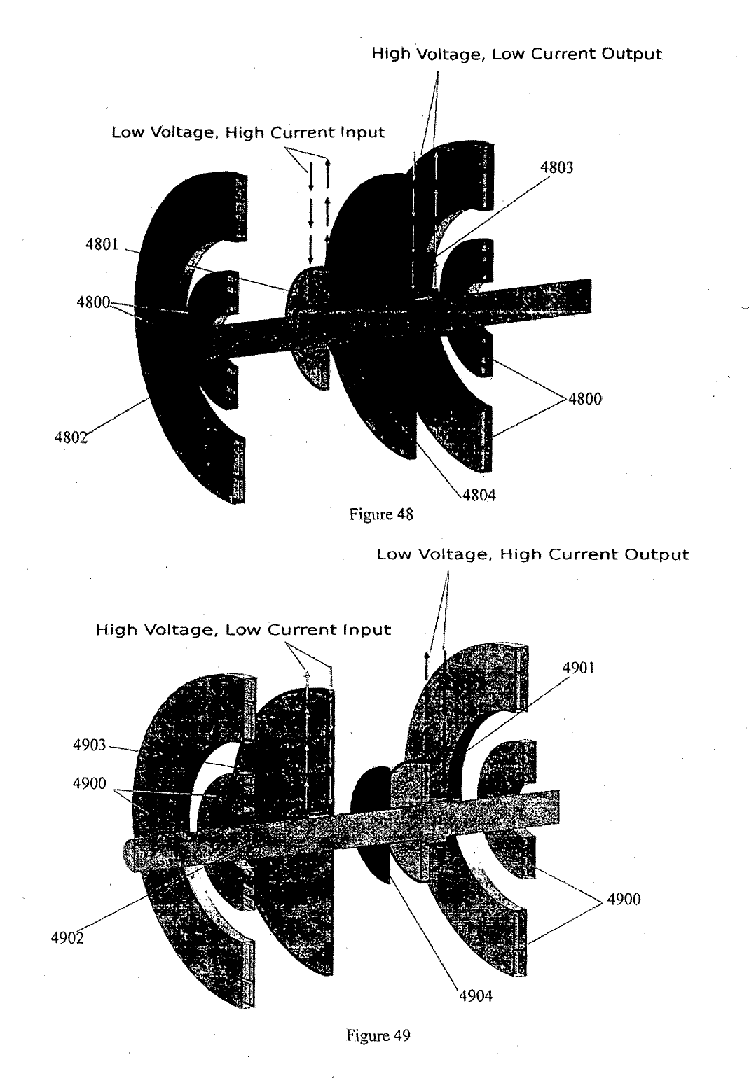

An Electromagnetic Power Converter for conversion of low voltage DC electrical input to high voltage DC electrical output is illustrated in FIG. 48. This configuration includes two pairs of stationary superconducting coils 4800, a first pair of outer, annular coils and a second pair of inner annular coils which are spaced concentrically inwardly within the outer annular coils. A small diameter motor rotor 4801 is mounted to a shaft 4802 which is common and also mounts a larger diameter generator rotor 4803. The small diameter motor 4801 and larger diameter generator 4803 are electrically insulated through the provision of an insulation collar 4804. The insulation collar also extends partially along the shaft 4802 within the mounting collar of the large diameter generator 4803. The small diameter motor 4801 and large diameter generator 4803 are therefore mechanically connected to the shaft but electrically insulated from it and each other.

There are two current pathways illustrated in FIG. 48 namely a low voltage high current input path through the liquid metal brushes of the small diameter motor 4801 and a high voltage low current output path through the liquid metal brushes associated with the large diameter generator 4803.

An Electromagnetic Power Converter for conversion of high voltage DC electrical input to low voltage DC electrical output is illustrated in FIG. 49. This configuration is basically the reverse of the configuration illustrated in FIG. 48. This converter includes two pairs of stationary superconducting coils 4900, a first pair of outer, annular coils and a second pair of inner annular coils which are spaced concentrically inwardly within the outer annular coils. A small diameter generator rotor 4901 is mounted to a shaft 4902 which is common and also mounts a larger diameter motor rotor 4903. The small diameter generator motor 4901 and larger diameter motor 4903 are electrically insulated through the provision of an insulation collar 4904. The insulation collar also extends partially along the shaft 4902 within the mounting collar of the large diameter motor 4903. The small diameter generator 4901 and large diameter motor 4903 are therefore mechanically connected to the shaft but electrically insulated from it and each other.

There are two current pathways illustrated in FIG. 49 namely a low voltage high current input path through the liquid metal brushes of the large diameter motor 4903 and a high voltage low current output path through the liquid metal brushes associated with the small diameter generator 4901.

An Electromagnetic Power Converter for conversion of AC electrical input to DC electrical output is illustrated in FIG. 50. This configuration utilises the turbine 1400 illustrated in FIG. 23A (excluding the tertiary stray field cancelling coils) to convert DC electrical input to AC electrical output through the use of an AC generator 5000 linked to the shaft of the turbine 1400.

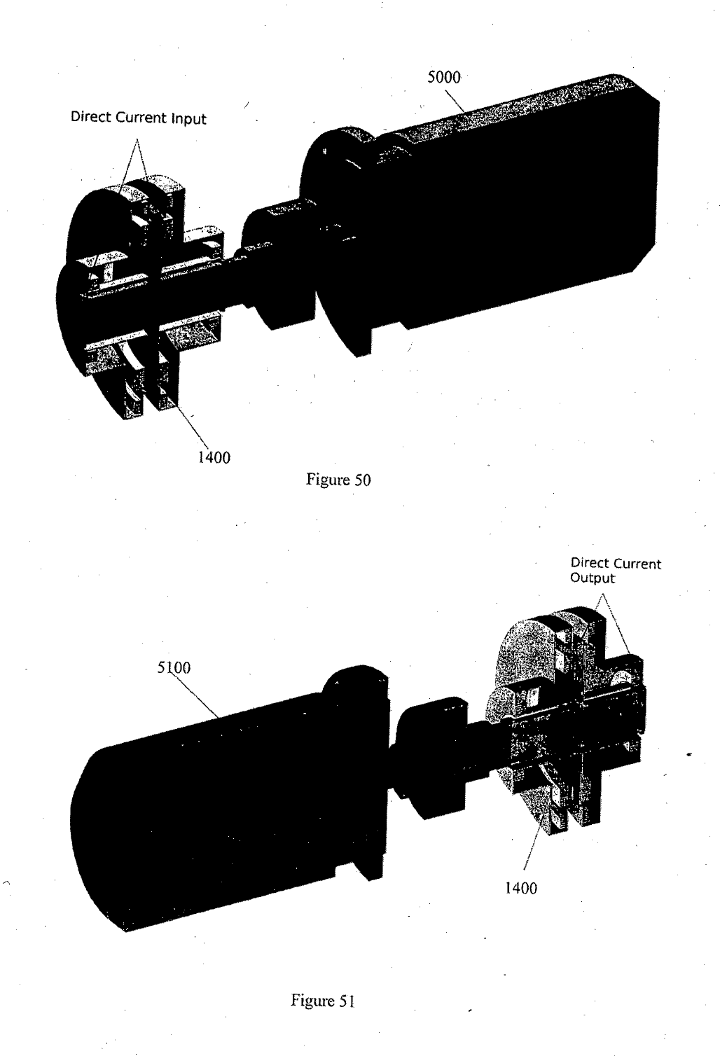

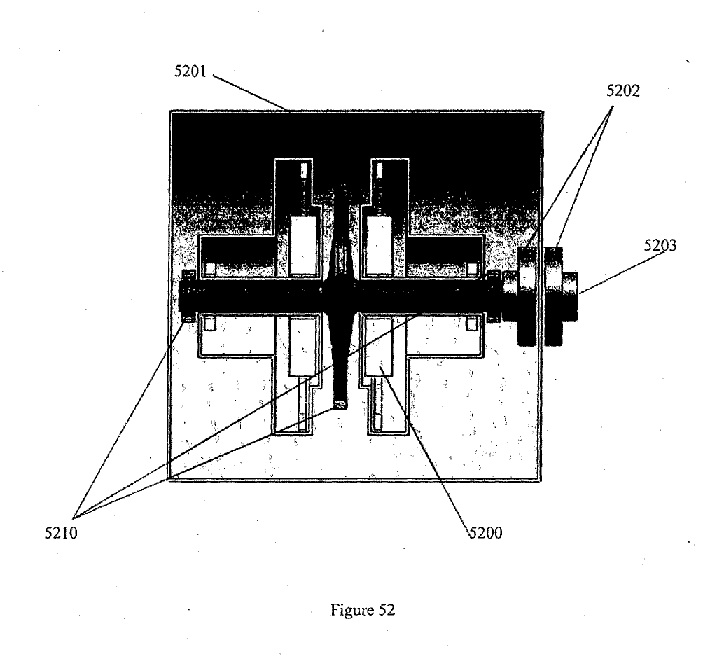

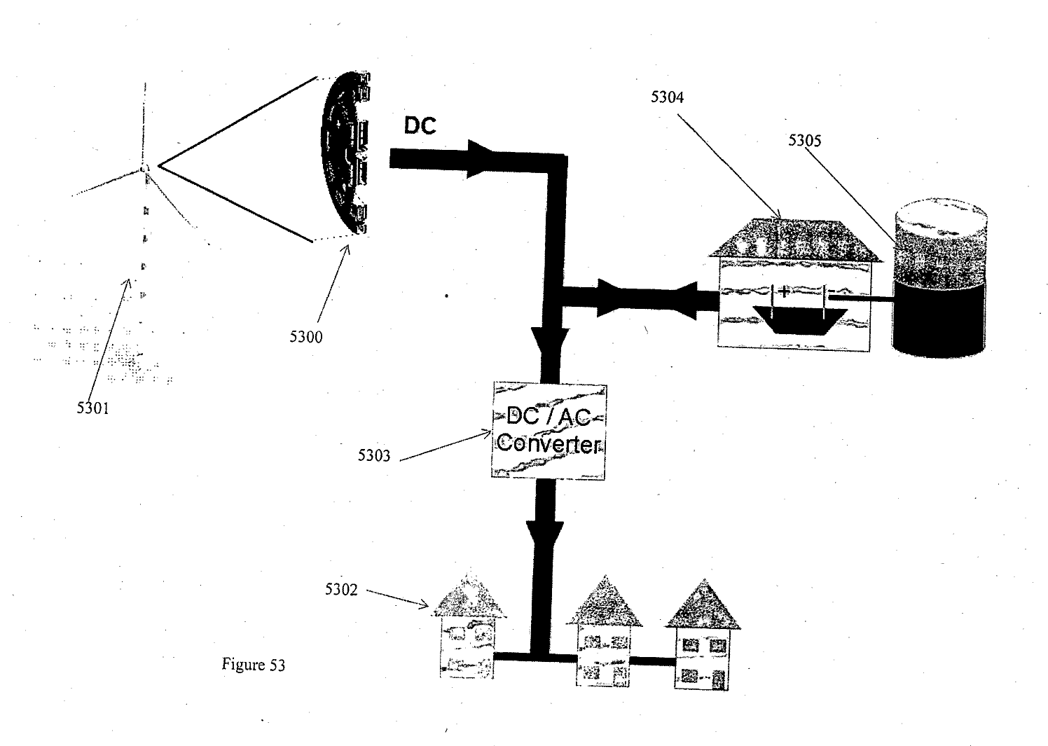

An Electromagnetic Power Converter for conversion of AC electrical input to DC electrical output is illustrated in FIG. 51. This configuration also utilises the turbine 1400 illustrated in FIG. 23A to convert AC electrical input provided through an AC motor 5100 linked to the shaft of the turbine 1400 to DC electrical output.

FIG. 52 is an illustration of a particularly preferred liquid metal brush sealing arrangement which may find use with the present invention. Many liquid metals that could be used for the liquid metal brush current delivery system require a conditioned environment such as an inert gas and no humidity. The materials used for liquid metal brushes, in the majority of cases, either suffer performance degradation or react chemically when exposed to oxygen and/or moisture.

A possible sealing arrangement is shown in FIG. 52 where the entire turbine/generator 5200 is sealed in a suitable sealed containment vessel 5201 containing an optimum environment for Liquid metal brush 5210 operation. A magnetic coupling 5202 can then be used to transmit the output torque of the turbine/generator 5200 through the wall of the containment vessel 5201 with an output shaft 5203 outside the sealed containment vessel 5201. The wall in the area of the magnetic coupling 5202 should be a non-conductive material in order to eliminate the formation of eddy currents. A significant advantage in this layout is the removal of the need for a seal on a rotating shaft which may be prone to leakage and or degradation over time.

An appropriate cooling system could be fitted to this containment vessel 5201 and may include fan forced cooling, a recirculating fluid cooling system or other techniques to keep the turbine/generator 5200 at a stable temperature.

The containment vessel 5201 allows the entire assembly to be sealed within a positively pressurised inert gas environment to prevent degradation or reaction of the liquid metal material. The inert gas could be N₂ (Nitrogen), Argon or any other suitable inert gas. The only incursions into the sealed chamber would the stationary current leads and any utility connections for liquid or gas recirculation cooling systems. These incursions would only need stationary rather than the rotating seals that would conventionally be used to seal the output shaft.

The rotor of this embodiment could also be supported by magnetic bearings to further reduce losses and maintenance requirements of the turbine/generator 5200.

Illustrated in FIG. 53 is a schematic illustration of one possible implementation of the generator 5300 of the present invention. Utilising the power conversion functionality of the generator 5300 the input from a wind powered rotor 5301 is converted to DC electrical output. This DC electrical output can then be fed to either a power load, in the figure represented by a number of houses 5302 after being passed through a DC/AC converter 5303. Alternatively or in combination with the power fed to the power load, some or all of the DC electrical output from the generator 5300 can be used in a process such as the electrolytic formation of the hydrogen gas from water. This process, illustrated schematically by unit 5304 is an energy intensive process which requires high current and low voltage for optimum performance. Any hydrogen produced can be stored in a hydrogen storage tank 5305. Once created, the hydrogen stored in the storage tank 5305 can then be drawn upon as required such as in conditions of low wind where the wind powered rotor 5301 is not creating any or sufficient electrical power to supply the power load 5302.

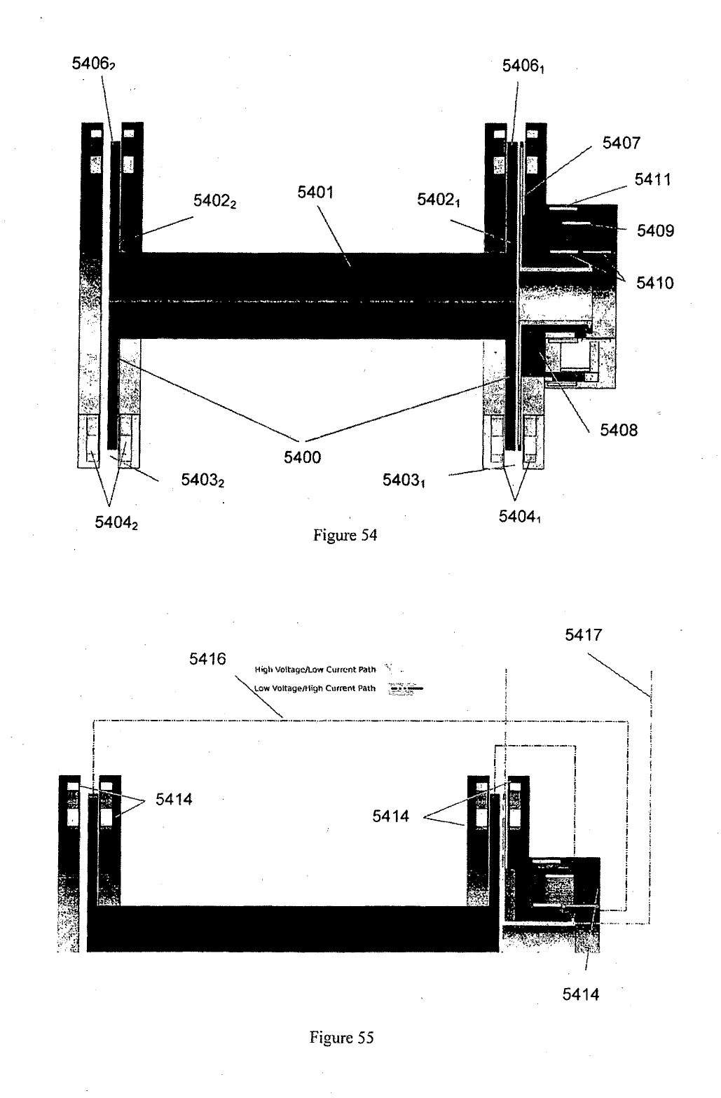

FIGS. 54 and 55 illustrate a variation to the previously presented multistage variation with revised cancelling coils illustrated in FIGS. 39A and 39B. This embodiment includes a low speed motor stage 5400 with a central shaft 5401 and a pair of rotors 5402₁,5402₂ located at either end. One of the rotors 5402₁ is disposed within a gap 5403₁ between a pair of outer drive superconducting coils with a positive current 5404₁, and the other of the rotors 5402₂ is disposed within a gap 5403₂ between a pair of outer drive superconducting coils with a negative current 5404₂ to enable the outer brushes 5406₁,5406₂ of the respective rotors to be positioned within the null field region produced within the gaps 5403₁,5403₂.

A high speed motor stage 5407 is provided adjacent to the rotor 5402₁. A high-speed intermediate generator stage 5408 is provided adjacent to the high-speed motor stage 5407 and is mechanically connected there to but electrically isolated therefrom.

In the variation illustrated in FIGS. 54 and 55, the innermost set of cancelling coils around the low speed rotor interconnect shaft that were provided in the embodiment illustrated in FIGS. 37A and 37B, have been removed. The inner, cancelling coils have been varied to create the required null field regions. As illustrated, the middle cancelling coil 5409 of the three cancelling coil sets (the positive current coil) has been axially offset from the inner cancelling coil set 5410 and the outer cancelling coil set 5411 (the negative current coils). The inner negative current cancelling coils 5410 have been widened with a gap introduced between them to widen the null field region. The inner cancelling solenoid (of 5410)closest to the high speed intermediate generator stage 5408 has an increased number of turns and thickness to compensate for the larger magnetic field strength that has to be cancelled in this region.

As before, each of the superconducting coils is provided within a cryogenic envelope 5414.

The current pathways are illustrated in FIG. 55 and include a low voltage/high current path 5416 through the rotor drum and the high-speed intermediate generator stage 5408 and a high voltage/low current path 5417 through the high-speed motor stage 5407.

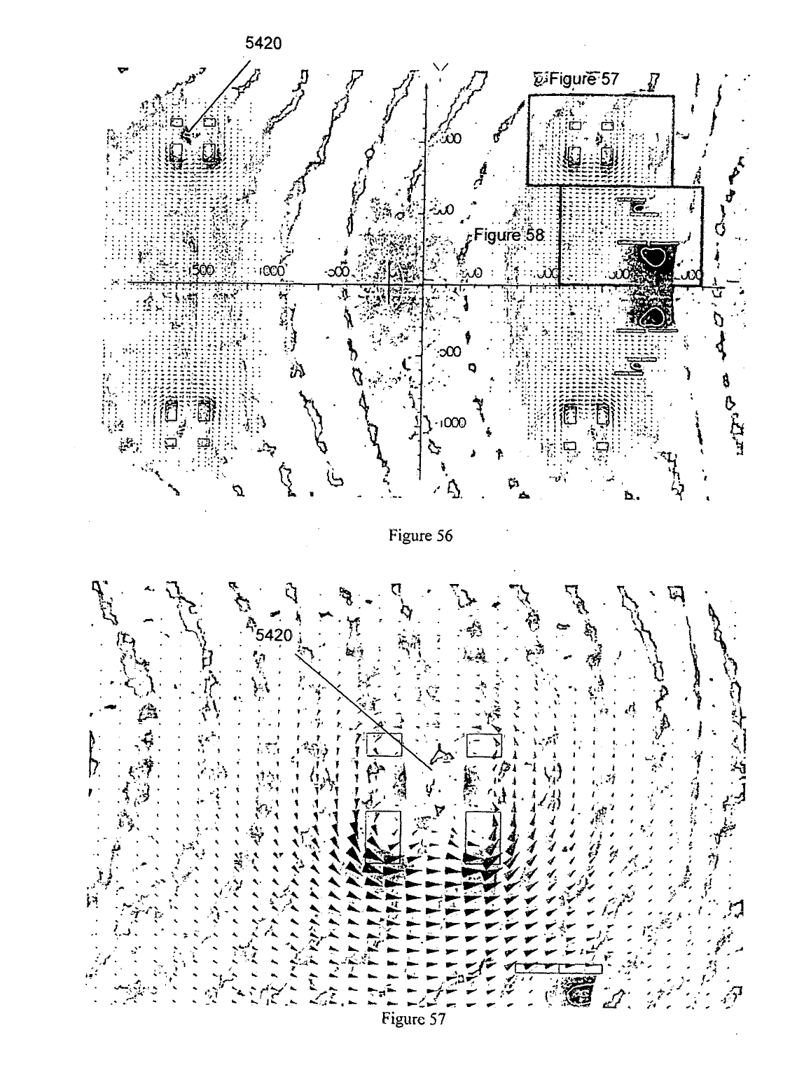

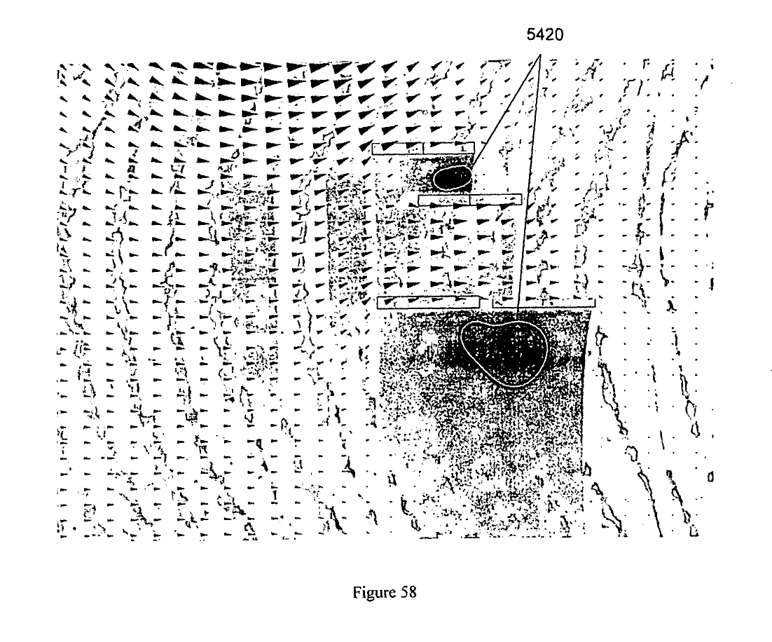

FIGS. 56 to 58 illustrate the field plot of the variation within the null field regions below 0.2 T 5420 outlined. The enlarged null field region created by the variation of the inner cancelling coils is particularly well illustrated in FIG. 58.

There are a variety of other situations in which high current and low voltage electrical supply is particularly useful including electroplating, electrowinning, Aluminium smelting, the production of hydrogen fuel, AC/DC conversion, electromagnetic gearboxes, wind turbines and in defence applications such as in railguns or kinetic weapons.

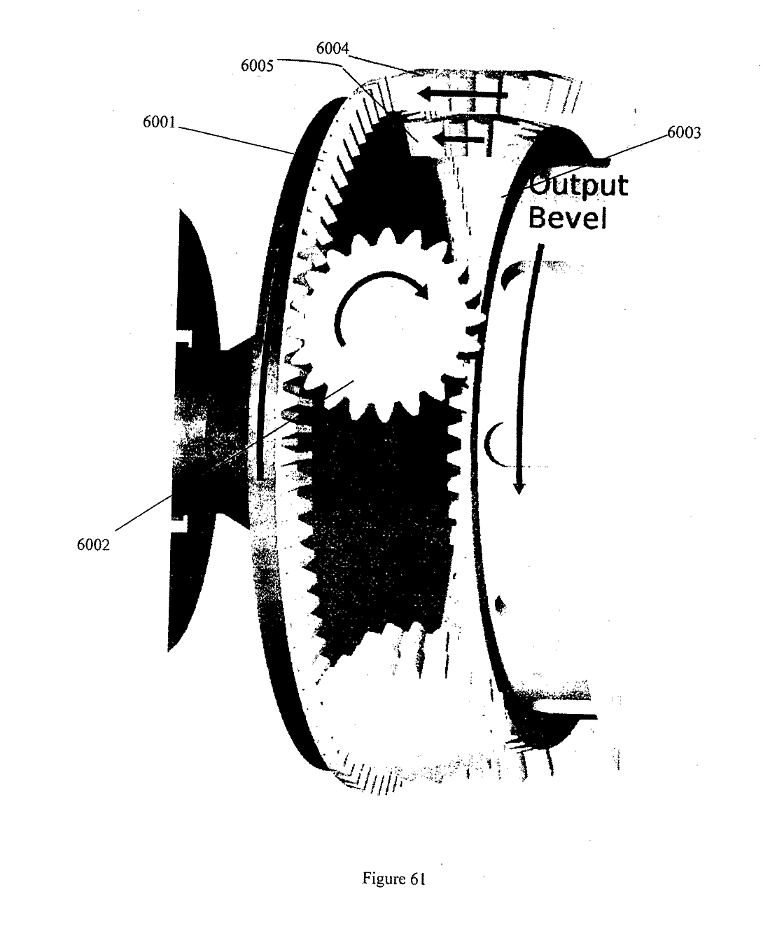

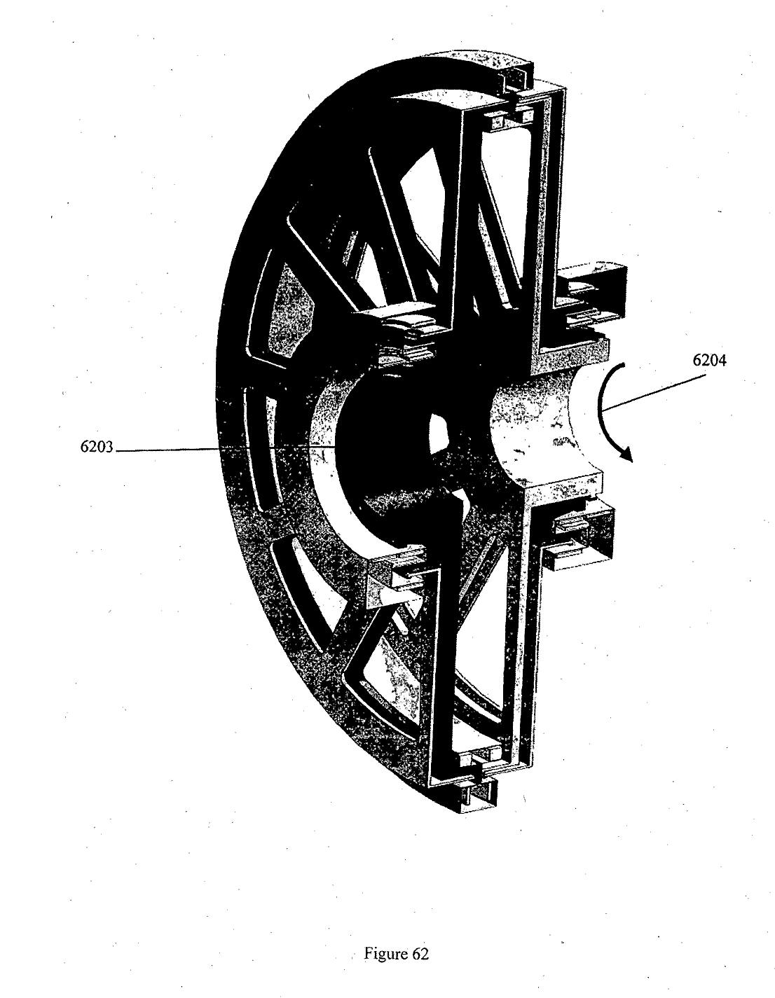

Devices such as those discussed previously can be used with torque equalisation systems such as those illustrated in FIGS. 59 to 61. In FIG. 59, a torque equalisation system allowing for in-line speed reduction or increase is illustrated used in conjunction with the embodiment of the present invention illustrated in FIGS. 23A and 24A applied to a pair of counter rotating turbines.

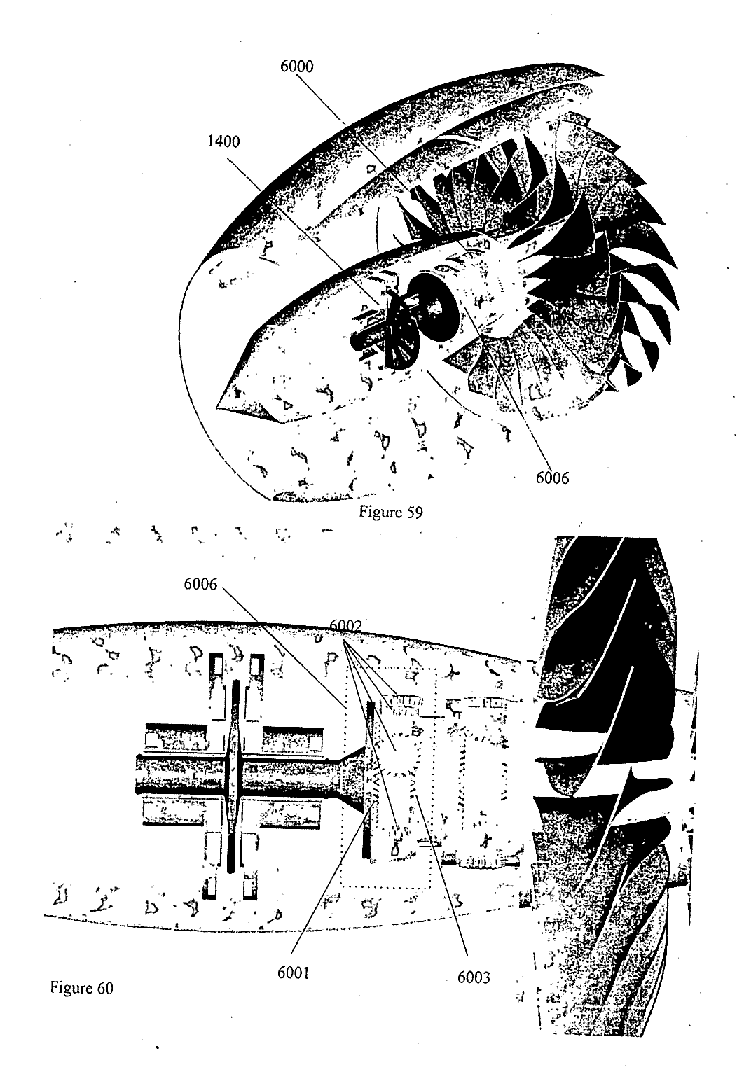

The torque equalisation system is particularly illustrated in FIG. 60. In this Figure, the torque equalisation system 6000 includes an input bevel gear 6001, a series of dual pinion gears 6002 and an output bevel gear 6003. The input bevel gear 6001 together with the outer pinion gear 6004 of the dual pinion gear 6002 mesh together with a first gear ratio and the inner pinion gear 6005 of the dual pinion gear 6002 mesh with the output bevel gear 6003 in a second gear ratio which is different to first gear ratio. The respective gear ratios can be manipulated in order to provide a change of overall rotational speed between the input bevel gear 6001 and the output bevel gear 6003 this either increasing or decreasing shaft speed. A multi ration pinion torque converter 6006 is provided with the torque equalisation system in order to provide speed reduction. The convertor 6006 and the torque equaliser 6000 operate on similar principles and use similar components.

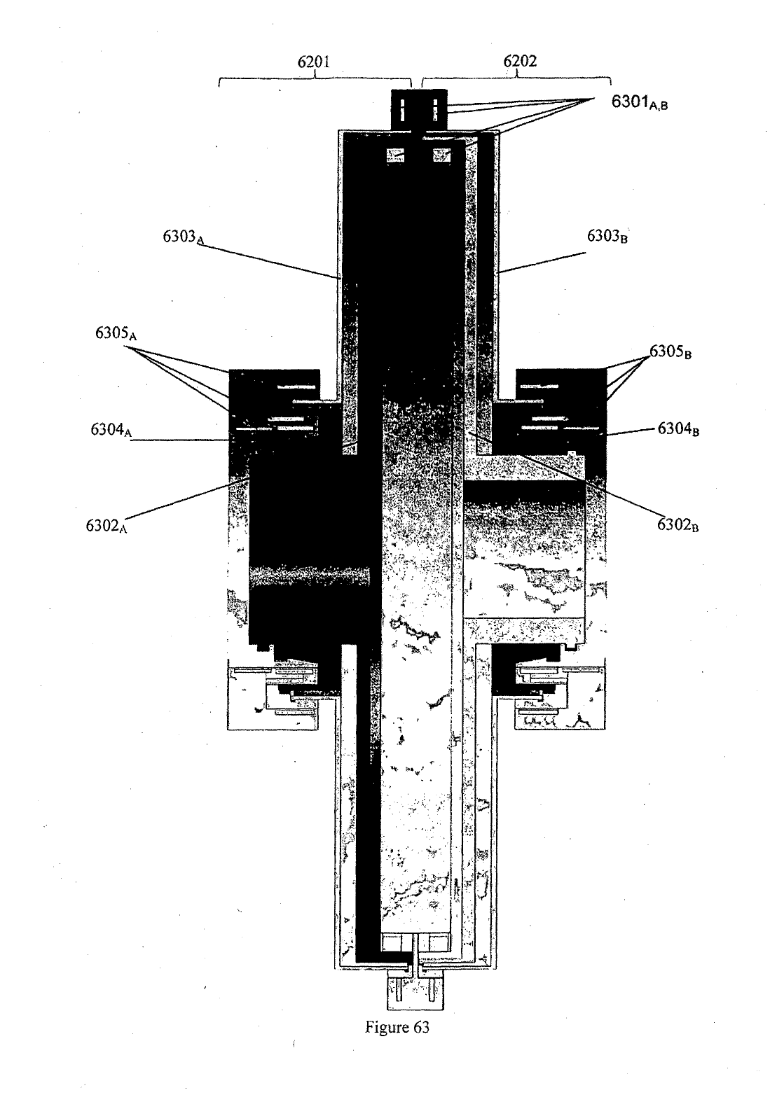

FIGS. 62 and 63 show the design and components of a counter rotating generator based on the turbine technology of the present invention. This generator is designed for use in a wind turbine that employs a pair of counter rotating wind turbine blades.

The use of counter rotating turbine blades allows a wind turbine to extract power from the wind more efficiently within a given swept area. In these configurations, each side of the Counter Rotating generator (named Stage A 6201 and Stage B 6202 respectively) can operate and generate electricity independently. This design pairs a multi-MW Stage A section 6201 with a multi-MW Stage B 6202 section.

The turbine generator illustrated in FIG. 62 includes two independent generator sections allowing opposing directions of input torque as illustrated. The Stage A, input torque direction 6203 is opposite to the Stage B input torque direction 6204. FIG. 63 shows the key components of the counter rotating wind turbine generator illustrated in FIG. 62. The rotating and counter rotating stages are labelled ‘A’ and ‘B’.

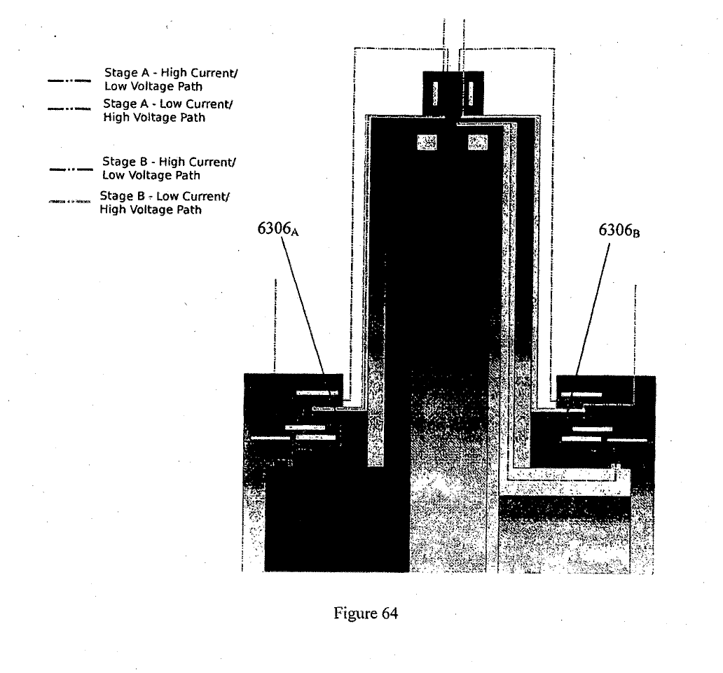

As with previous embodiments and illustrated particularly in FIG. 63, each stage includes a pair of outer superconducting coils 6301 between which a portion of the low speed generator rotor 6302_{A}, 6302₈ is located. Each stage also includes a high speed generator rotor 6303_{A}, 6303₈, and a high speed motor section 6304_{A}, 6304₈ as well as a series of inner cancelling coils 6305_{A}, 6305_{B} to create the null field regions within which portions of the rotors are located. The high speed generator 6303_{A}, 6303_{B} and high speed motor 6304_{A}, 6304_{B} of each stage are mechanically coupled but electrically insulated from each other by, the provision of insulation 6306_{A}, 6306₈ best illustrated in FIG. 64.

Another variation included in this design is a change in the radial position of the innermost brush of the high speed generator stage to coincide with the outermost brush of the high speed motor stage. This change in brush position has minimal impact on the voltage generated by the high speed stage while creating additional room for the innermost high current brush interconnects. This variation in layout could also be applied to many of the previously disclosed embodiments.

Mechanical and/or thermal connection between the outer superconducting drive coils can be made in the gap between the stage A and stage B rotors.

The preferred high and low current paths within the independent counter rotating stages are illustrated in FIG. 64.

If required, the low speed generator rotor stages 6302_{A}, 6302_{B} could also be routed to the outside of the high speed generator rotor stages 6303_{A}, 6303₈, thereby encapsulating the inner cancelling coils 6305_{A}, 6305₈ and entering the inner coil set from the side opposite to that shown in FIG. 64. This may offer easier connection to the torque input elements.

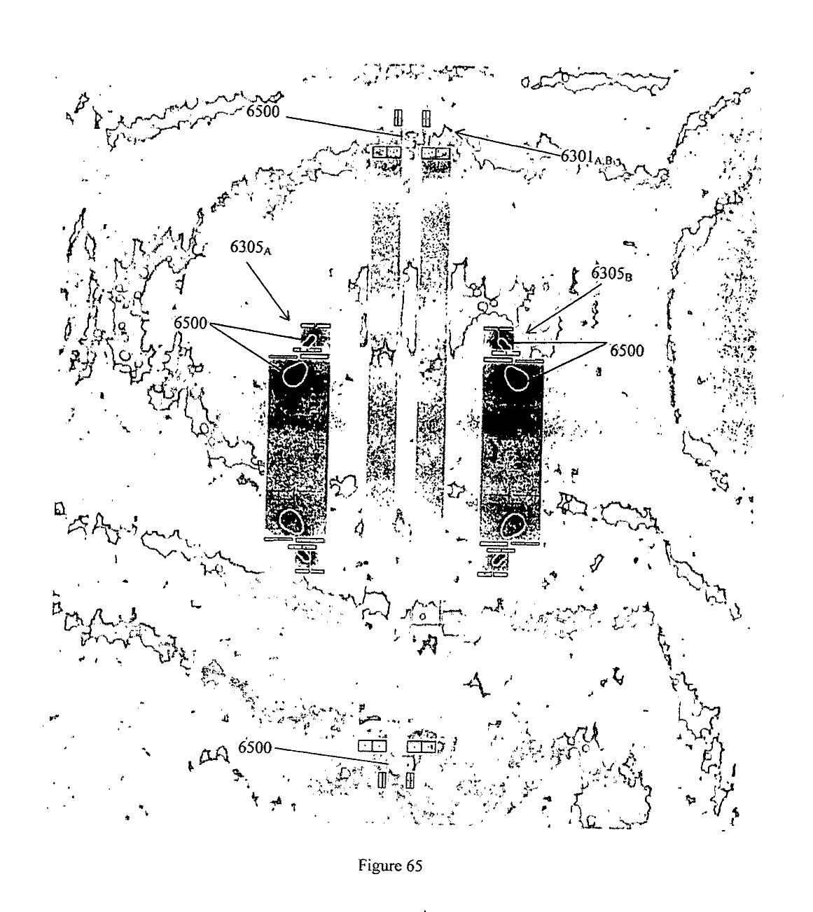

FIGS. 65 to 68 present a series of field plots created in Vector Fields Opera 3d software to illustrate the regions of high and low magnetic field strength. The design of the outermost coils differs from previous design as the inner pair 6702_{A}, 6702_{B} of the outer coils are wider in cross section than the outer pair 6701_{A}, 6701₈ of the outer coils as best illustrated in FIG. 67. The ratio between these coil widths is around 4:1—although this ratio may need to be adjusted if significantly different geometry is used. This change in the shape of the coils helps to produce higher field strength through the bore of the driving solenoid while retaining a large, usable null field region 6500 between the inner and outer pairs of coils. Another side effect is a reduction in the size of the inter coil forces when compared with the previous thin solenoid, outer coil designs. This variation in coil geometry could also be applied to many of the previously disclosed embodiments including those used in the marine pod system.

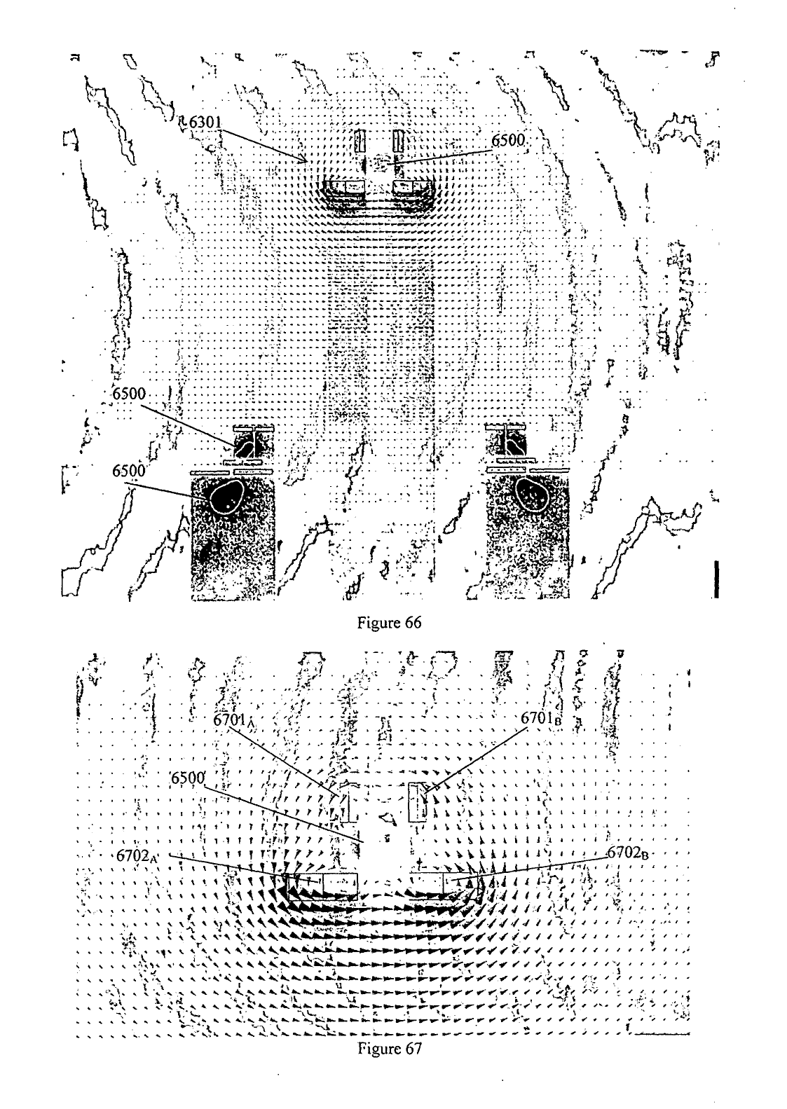

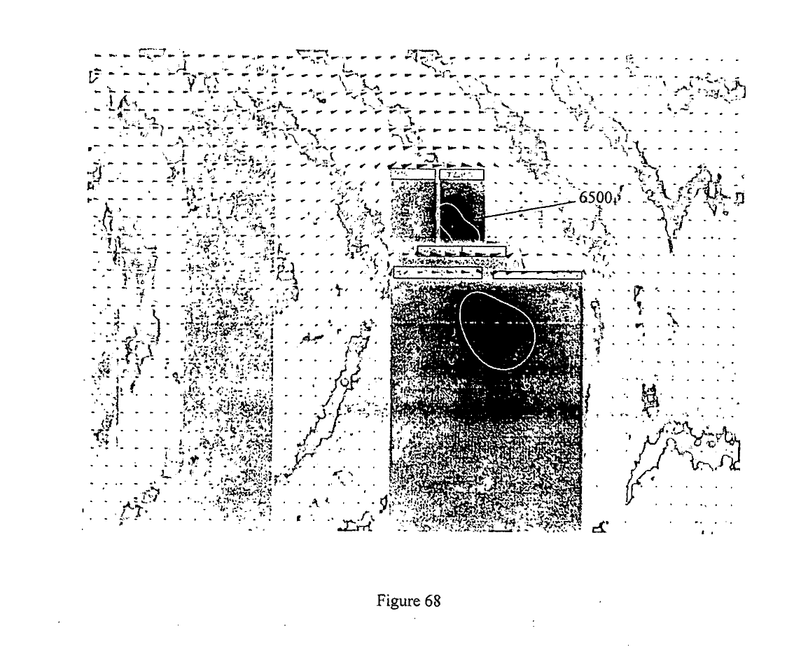

FIG. 65 shows an overview of the coil system used in the turbine generator illustrated in FIG. 62. The areas circumscribed by freeform lines in light green are regions where the field strength is below 0.2 T (the null field regions, 6500). FIG. 66 is a half sectional view of the coil assembly used in the turbine. The field vectors are illustrated in this image to show the direction of the magnetic field. FIG. 67 is a sectional view of the outer coil assembly shown in FIGS. 65 and 66 clearly showing the differing aspect ratios between the inner pair 6702_{A}, 6702₈ of the outer coils and the outer pair 6701_{A}, 6701_{B} of the outer coil set. FIG. 68 is a detail sectional view of the inner coil assembly 6305₈ shown in FIGS. 65 to 67 showing the slight offset of the outer radial null field regions 6500₁ to encapsulate the brushes of the high speed motor (lower region) and rotor (upper region) stages.

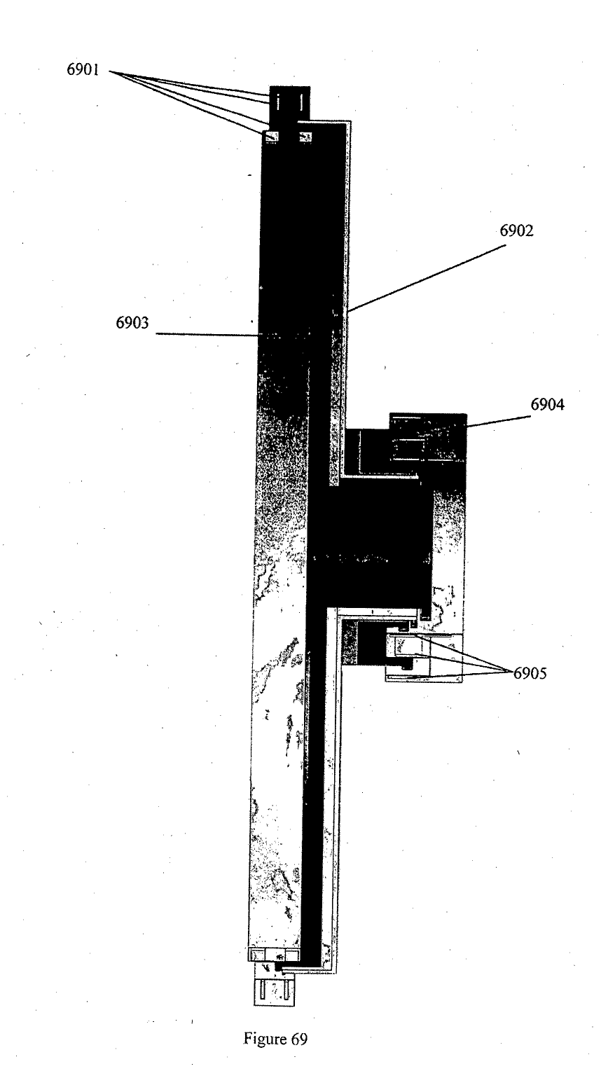

A variation is illustrated in FIG. 69. The illustrated design is a multi-MW rated design for a single rotating wind turbine blade. The basic components are very similar to the previously discussed wind turbine designs beginning particularly with FIG. 62. Key differences include the use of the revised outer coil aspect ratios as well as changing the design of the secondary motor and generator stages such that the cancelling coils are arranged on one lateral side of the motor and generator stages. This allows greater access to the low speed rotor for the connection of the wind turbine shaft. Both the high and low speed rotors exit from the side of the outer coil assembly in order to allow better mechanical support of the outer coils.

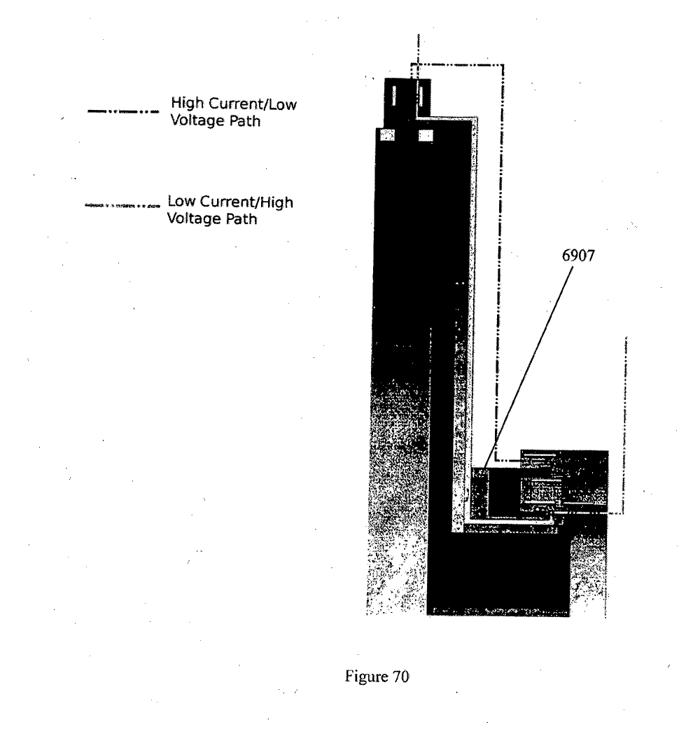

Again, this embodiment includes a set of outer superconducting coils 6901 between which a portion of the high speed generator rotor 6902 and a portion of the low speed generator rotor 6903 are located. A, high speed motor section 6904 is provided as well as a series of inner cancelling coils 6905 to create the null field regions 6906 within which the brush contacts are located. The high and low current paths are illustrated in FIG. 70. Again, the high speed generator rotor 6903 is mechanically coupled to but electrically isolated from the high speed motor section 6904 by an insulating sleeve 6907.

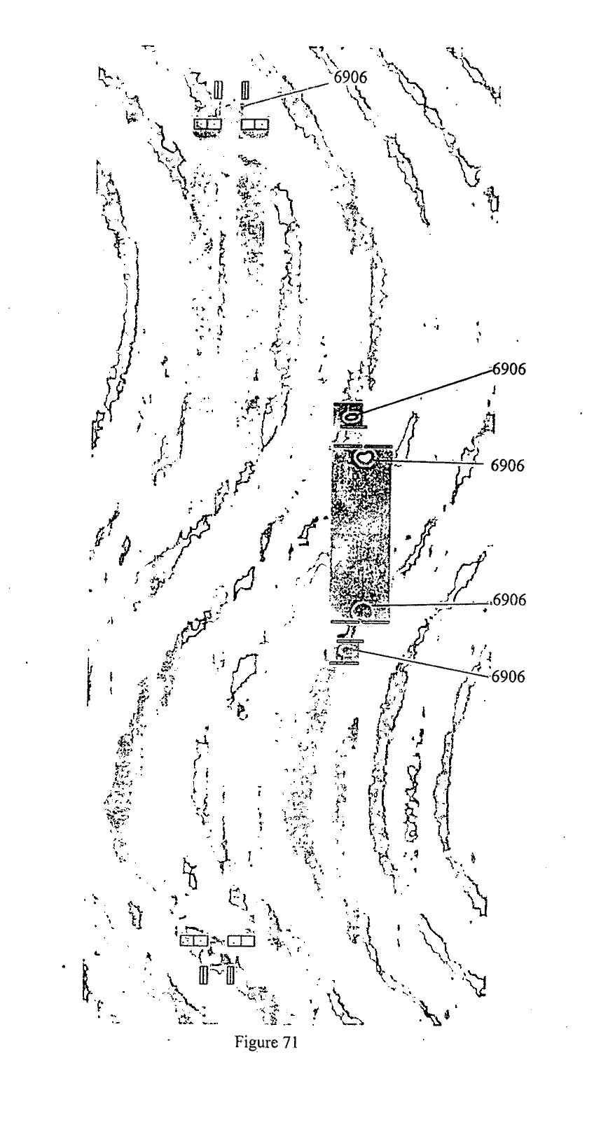

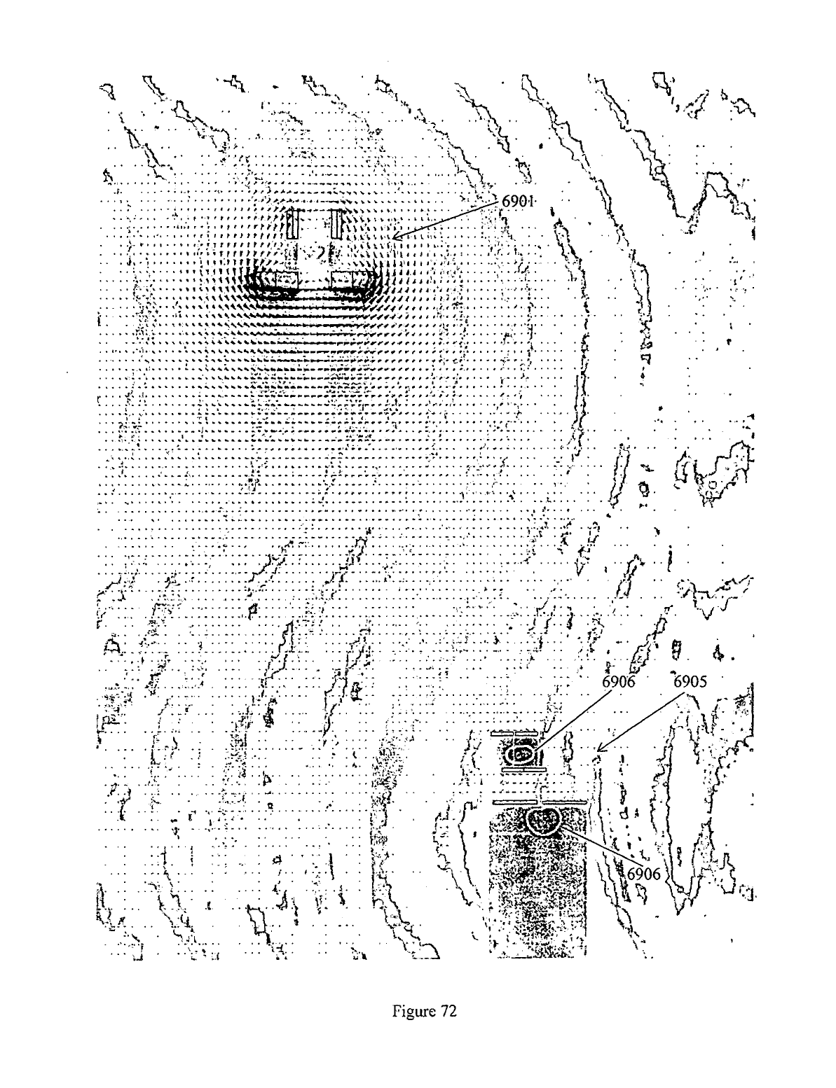

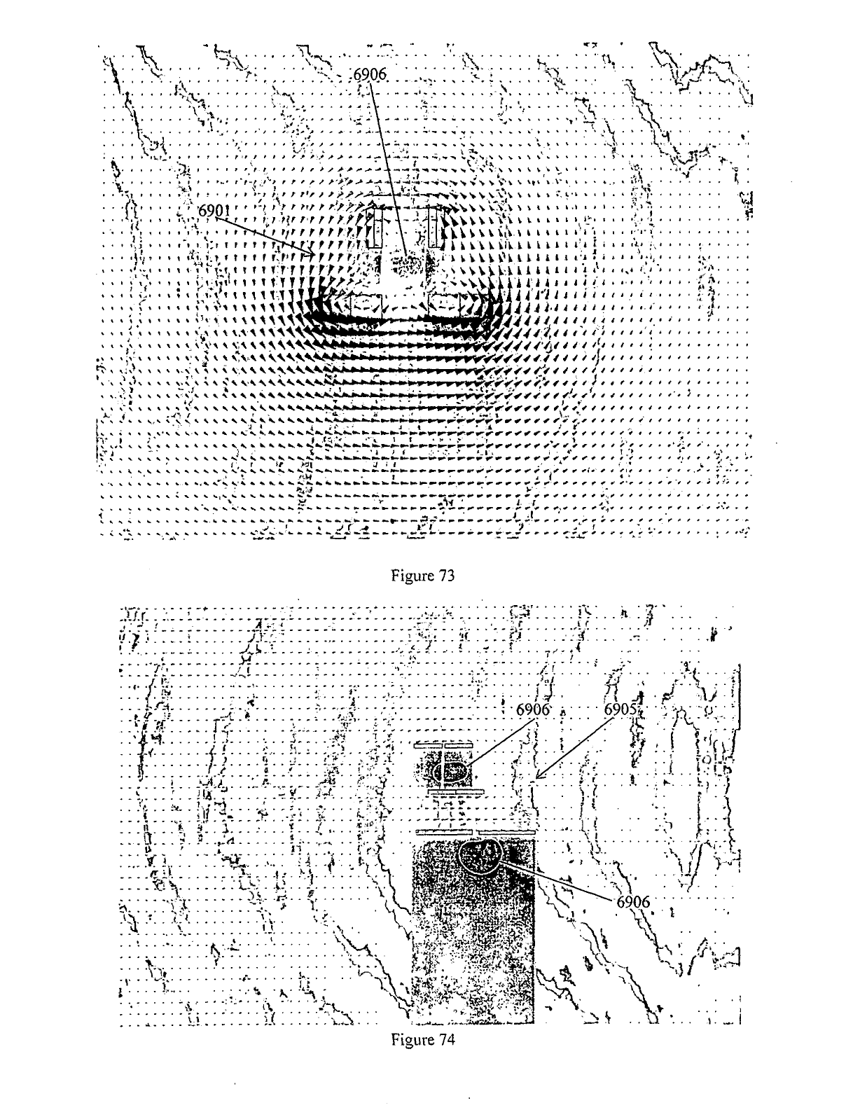

FIG. 71 shows an overview of the field plot for the variation illustrated in FIG. 69. FIG. 72 illustrated a half sectional field plot of the direct drive device with, the field vectors included to show the direction of field. A field plot of the outer coil assembly 6901 of the direct drive variation is illustrated in FIG. 73 with the area circumscribed by a freeform line being the region below 0.2 T (the null field region 6906). The field plot illustrated in FIG. 74 is of the inner cancelling coil assembly 6905 of the direct drive device with the areas circumscribed by freeform lines being the region below 0.2 T (the null field region 6906).

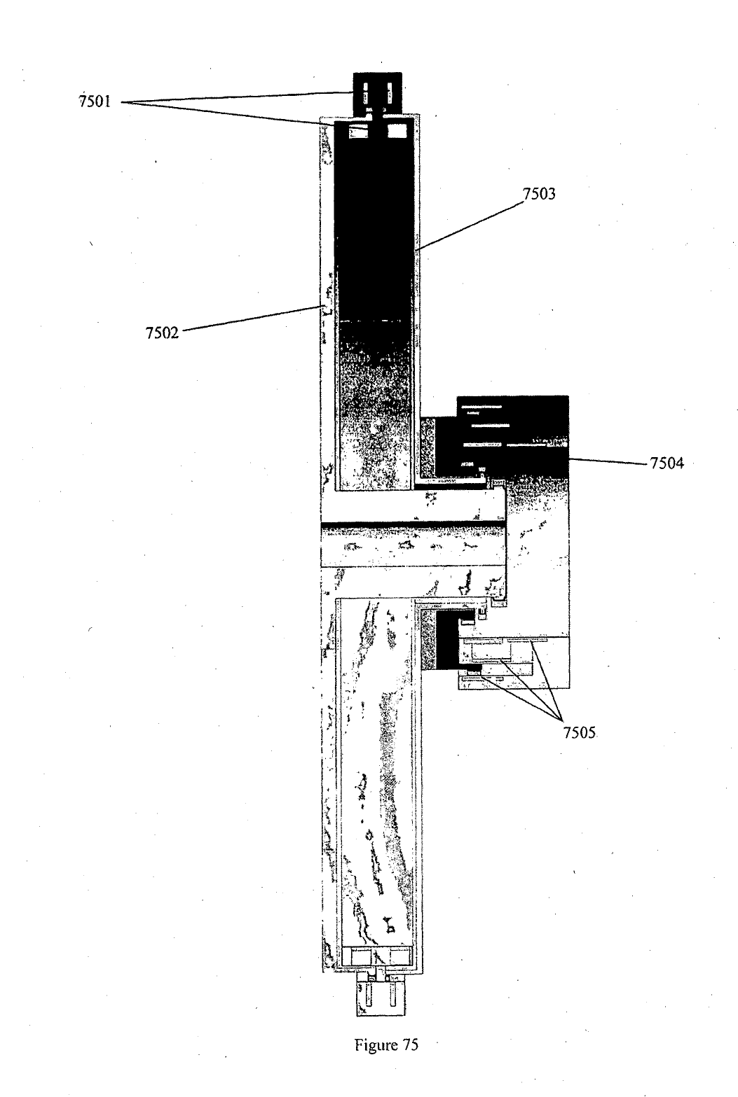

The variant design illustrated in FIG. 75 shows a multi-MW wind turbine generator variation where the low speed generator rotor stage 7502 is routed out through the opposite gap in the coil arrangement. This is presented as an alternative path for the low speed rotor. In general (and as previously discussed) all paths that the rotor can take between the two null field regions are valid and will result in a similar, if not identical, voltage path integral/rad/s. Mechanical and/or thermal connection between the outer superconducting drive coils can be made in the gap between the low speed generator and high speed generator rotors.

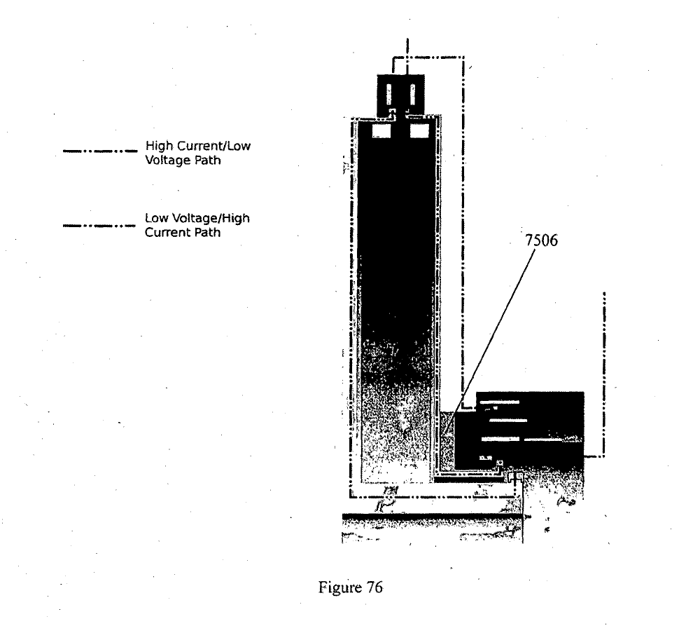

Again, this embodiment includes a set of outer superconducting coils 7501 between which a portion of the high speed generator rotor 7503 and a portion of the low speed generator rotor 7502 are located. A high speed motor section 7504 is provided as well as a series of inner cancelling coils 7505 to create the null field regions within which a portion of the motor is located. Again, the high speed generator rotor 7503 is mechanically coupled to but electrically isolated from the high speed motor section 7504 by an insulating sleeve 7506. The high and low current paths are illustrated in FIG. 76.

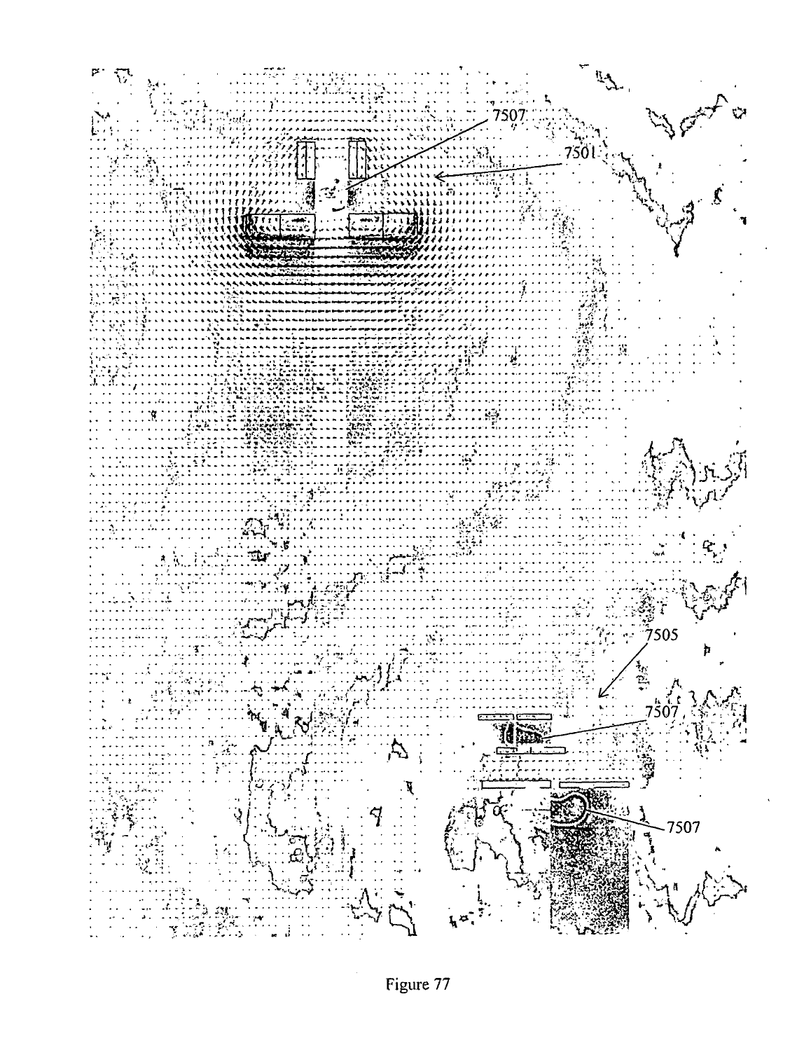

FIG. 77 shows the field profile for the multi-MW Wind Turbine Generator design variant. Field vectors are shown to indicate the magnetic field direction. The areas circumscribed by a freeform line indicate where the field strength is below 0.2 T (the null field region 7507).

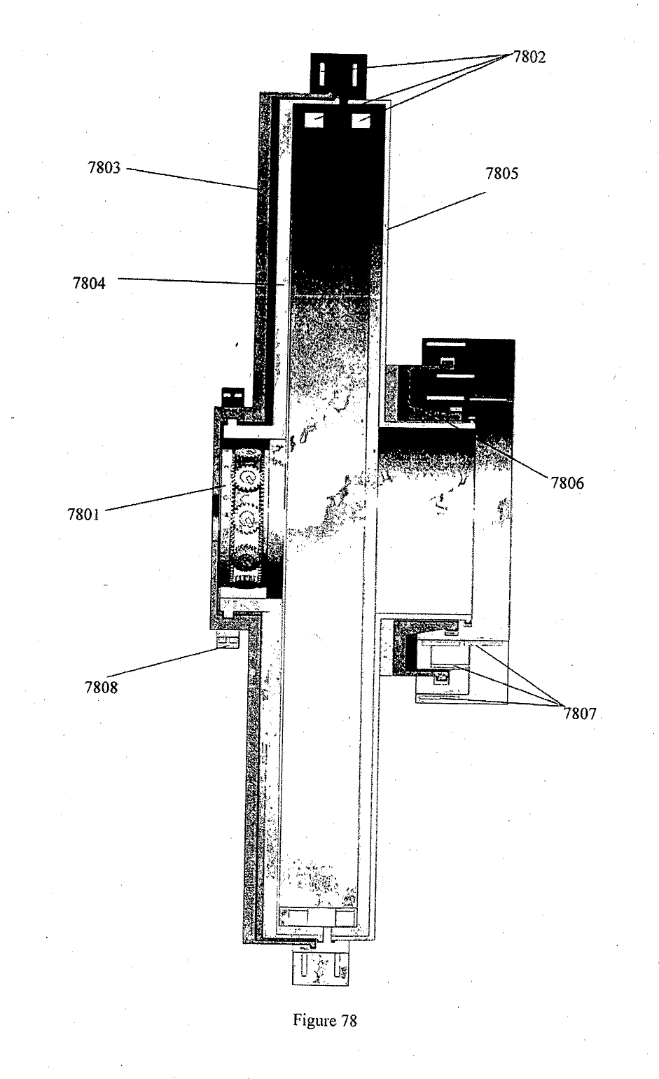

A further variation illustrated in FIG. 78 shows a counter rotating design where initial low speed stages are connected in series and feed into a single high speed motor/rotor combination. This in turn results in a single high voltage output. A torque equaliser 7801 is included in this design to synchronise the RPM and Torque delivered by counter-rotating, low speed generator rotors. This synchronisation is preferred to ensure correct generator performance.

While the variation illustrated in FIG. 78 is shown with the rotors connected in series, it would be obvious to anyone skilled in the art that the rotors could also be readily connected in parallel.

Again, the configuration has includes a set of outer superconducting drive coils 7802 between which a portion of the Stage A low speed generator rotor 7803 and the Stage B low speed generator rotor 7804 are located. A high speed generator rotor 7805 and a high speed motor 7806 are provided as well as a series of high speed cancelling coils 7807 and a set of low speed interstage cancelling coils 7808 to create the null field regions within which the liquid metal brushes located.

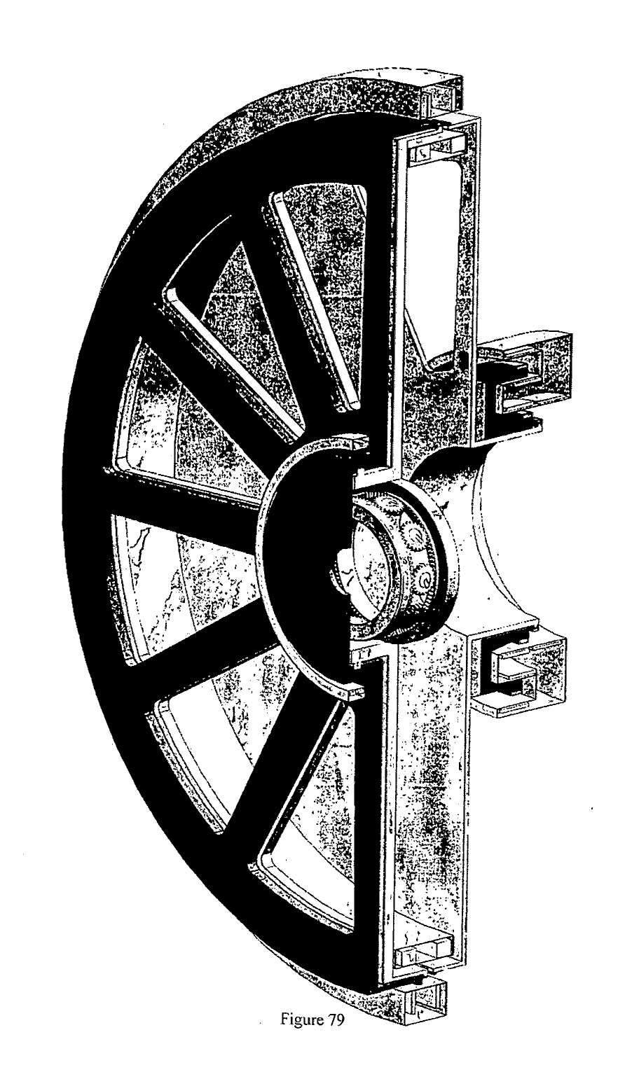

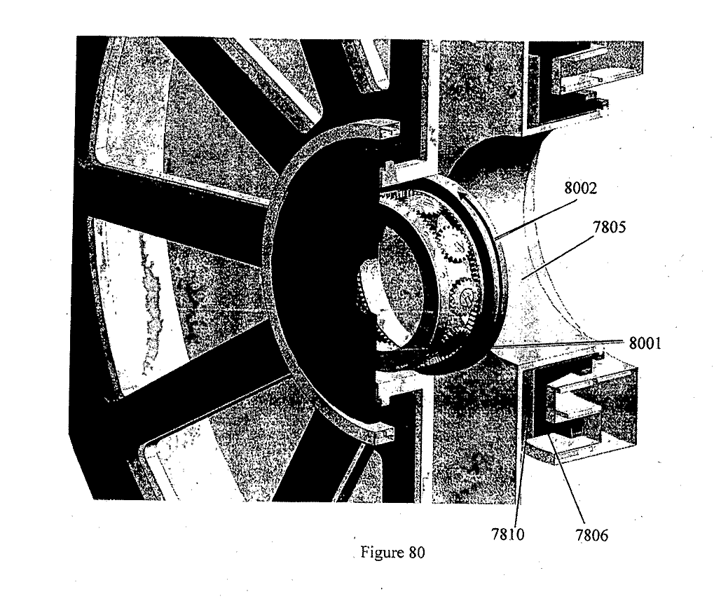

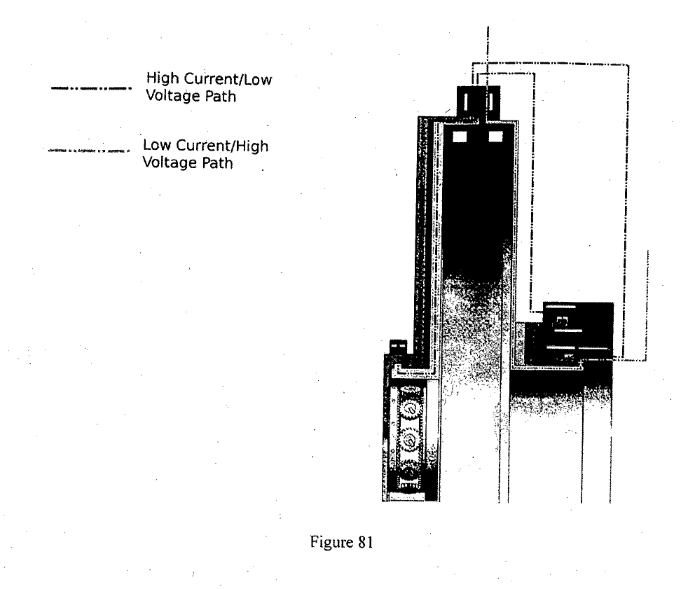

FIG. 80 is a close up of the sectional view of FIG. 79 showing the detail of the Torque/RPM Equaliser and the relative directions of applied input torque for Stage A 8001 and Stage B 8002. Again, the high speed generator rotor 7805 is mechanically coupled to but electrically isolated from the high speed motor section 7806 by an insulating sleeve 7810. The high and low current paths for this embodiment are illustrated in FIG. 81.

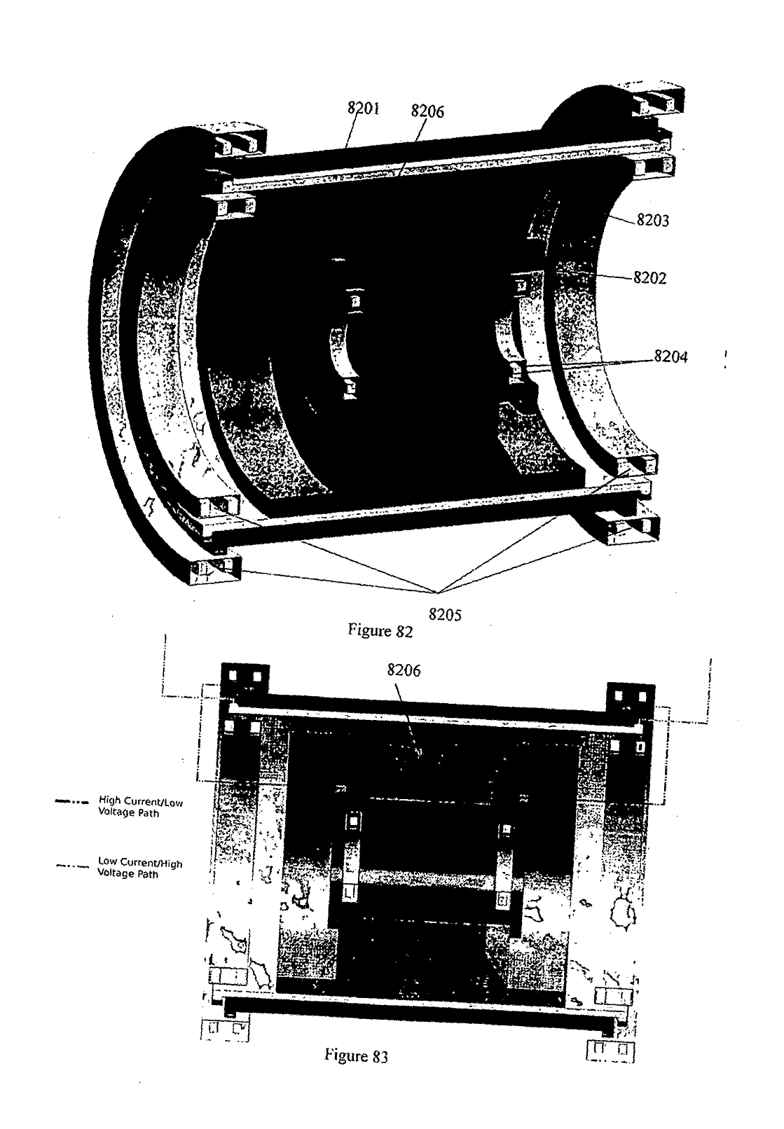

The Wind. Turbine generators can also be configured as a drum style turbine. The first of the drum style designs illustrated in FIG. 82 incorporates a drum style low speed generator element 8201 that is electrically coupled to a drum style high speed motor element 8202 which is situated on a smaller radius than the low speed generator 8201. The motor element 8202 is mechanically coupled to a high speed generator section 8203 that provides the final high voltage DC output. The inner cancelling sets 8204 of superconducting coils create the null field regions required by the brushes of the high speed motor element 8202. Again, outer superconducting drive coils 8205 are provided to impart rotation in the drum configuration. The high and low current paths for this embodiment are illustrated in FIG. 83. The high speed generator element 8203 is mechanically coupled to but electrically isolated from the high speed motor element 8202 by an insulation assembly 8206.

It would be obvious to those skilled in the art that the drum style power converter stages could also be readily used independently of the low speed rotor for other power conversion requirements in that same manner that the radial power converter stages can be split off and used independently.

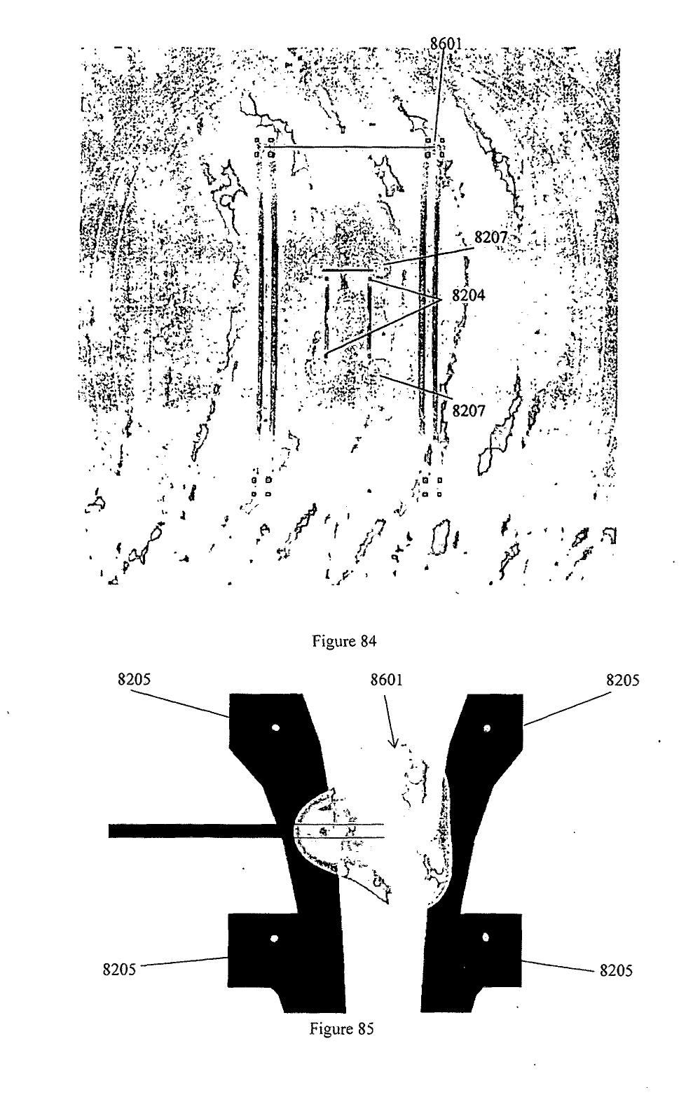

FIG. 84 shows an overview of the field plot for the variation illustrated in FIG. 82. The location of the inner cancelling coils 8204 which produce the inner null field regions 8207 are illustrated on this image.

FIG. 85 shows the null field region 8601 at the centre of the outer drive coils 8205 in the drum embodiment illustrated in FIG. 82. The region highlighted has a field strength low enough to allow the placement of liquid metal brushes.

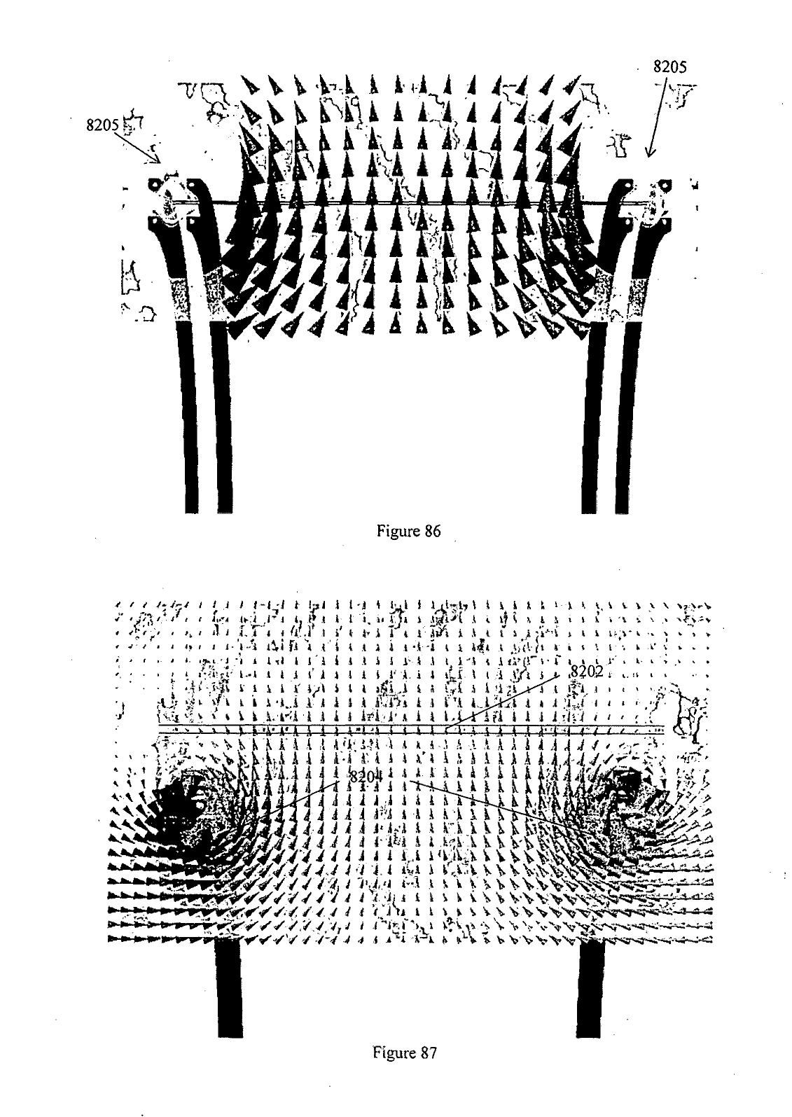

FIG. 86 shows the vectors of the main driving field produced by the outer drive coils 8205 along the drum element and FIG. 87 shows the field vectors in the region around the inner cancelling coils 8204 and the high speed motor section 8202.

The drum style turbines can also be constructed using a radial style power converter. The design variation illustrated in FIG. 88 includes this radial style electromagnetic power converter to provide the final power output of the generator. This embodiment incorporates a drum style low speed generator element 8801 and a high speed generator rotor 8802. Outer superconducting drive coils 8804 are provided to drive the low speed generator element 8801. A high speed motor element 8803 is mechanically coupled to the high speed generator rotor 8802 but electrically isolated from it by an insulating sleeve 8806. A set of inner superconducting cancelling coils 8805 are provided to form null field regions in which the current transfer brushes of the high speed generator motor. 8802 and the high speed motor element 8803 are located. The high and low current paths for this embodiment are illustrated in FIG. 89.

The 2 Coil designs that have been discussed above can also be extended to a 3 Coil design. This design has the advantage of doubling the length of the low speed generator (thus increasing the voltage/power generated) by providing a coaxial pair of low speed generator rotors 9001, 9002 without doubling the length of superconducting wire required.

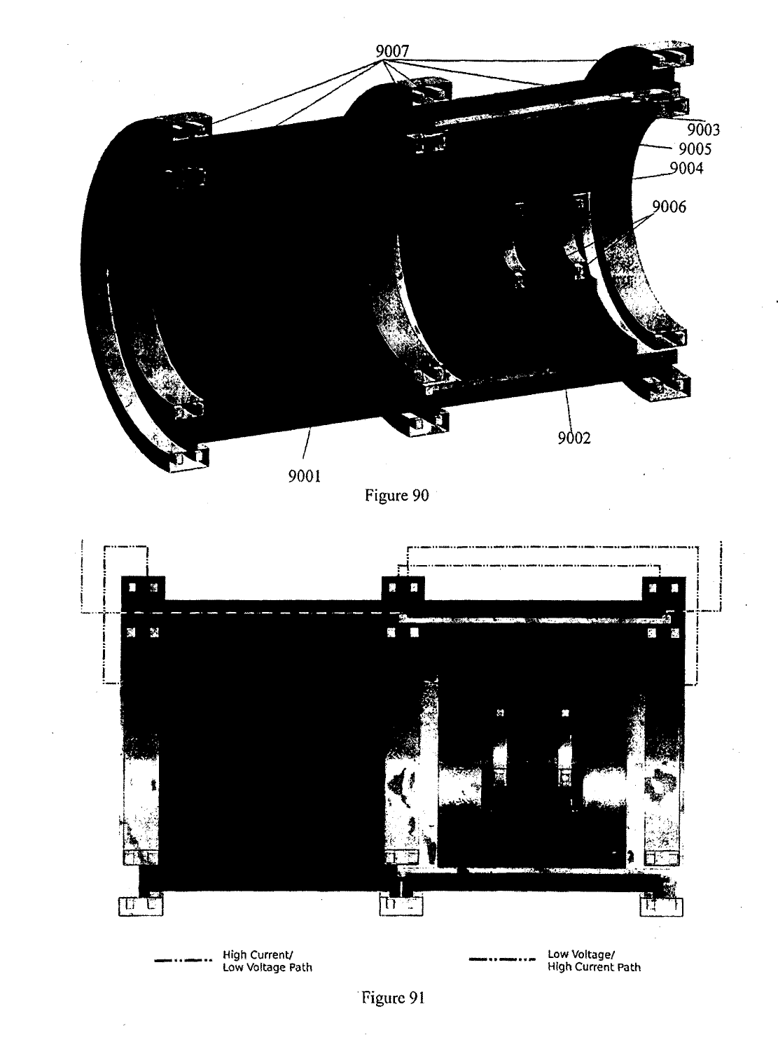

In the design shown in FIG. 90, the rotors 9001 and 9002 of the low speed generator section are serially connected electrically while being mechanically coupled to each other and spinning in the same direction. It would be obvious to one skilled in the art that these elements could be through connected and allowed to counter rotate (albeit with addition of a Torque/RPM equaliser to synchronise the generators). Alternatively, the rotors 9001 and 9002 could be connected in parallel with the generated current extracted at either end and from a combined brush at the midpoint

This example is shown incorporating a drum style electromagnetic power converter as discussed with relation to FIG. 82. In the embodiment illustrated in FIG. 90, a high speed generator element 9003 is located concentrically within low speed generator rotor 9002. The high speed motor stage 9004 is mechanically coupled to the high speed generator element 9003 but is electrically insulated therefrom by insulating assembly 9005. Inner superconducting cancelling coils 9006 are provided in order to form null field regions in which to locate the current transfer brushes. Multiple outer superconducting drive coils 9007 are provided in order to drive the low speed generator rotors 9001, 9002.

The high and low current paths for this embodiment are illustrated in FIG. 91. The low speed rotors 9001 and 9002 of this configuration are connected in series and are co-rotating, although counter-rotating and parallel connections are also possible.

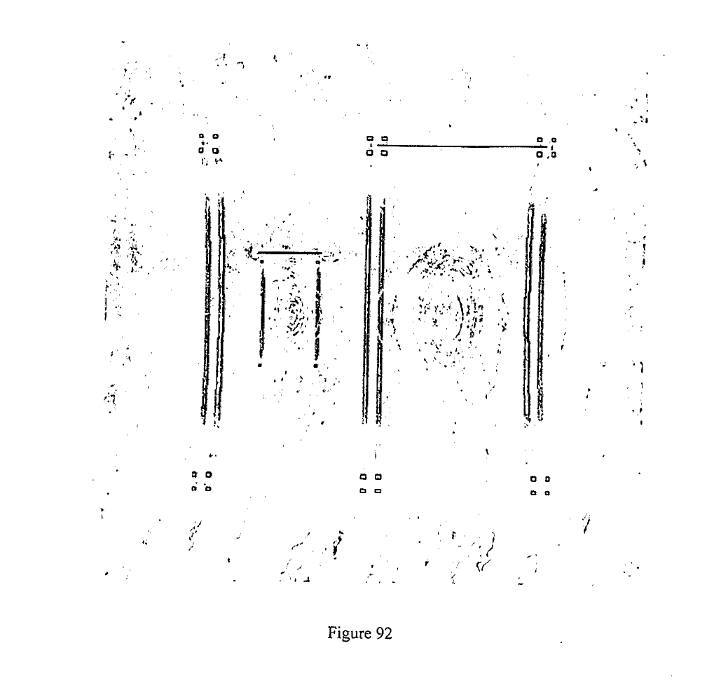

The general field plot is illustrated in FIG. 92. The regions that are circumscribed by a freeform lines represent areas within which (or beyond which) liquid metal or other current carrying brushes could be placed and function optimally.

Any of the designs described herein can also function with a rotating cryostat and superconducting coils rather than the stationary cryostat and coils usually described. The nature of Faraday's paradox means that the described generators or motors will function when the field coils are either stationary or rotating with the rotor. The key requirement is for relative motion between the rotor and external stationary electrical circuit.

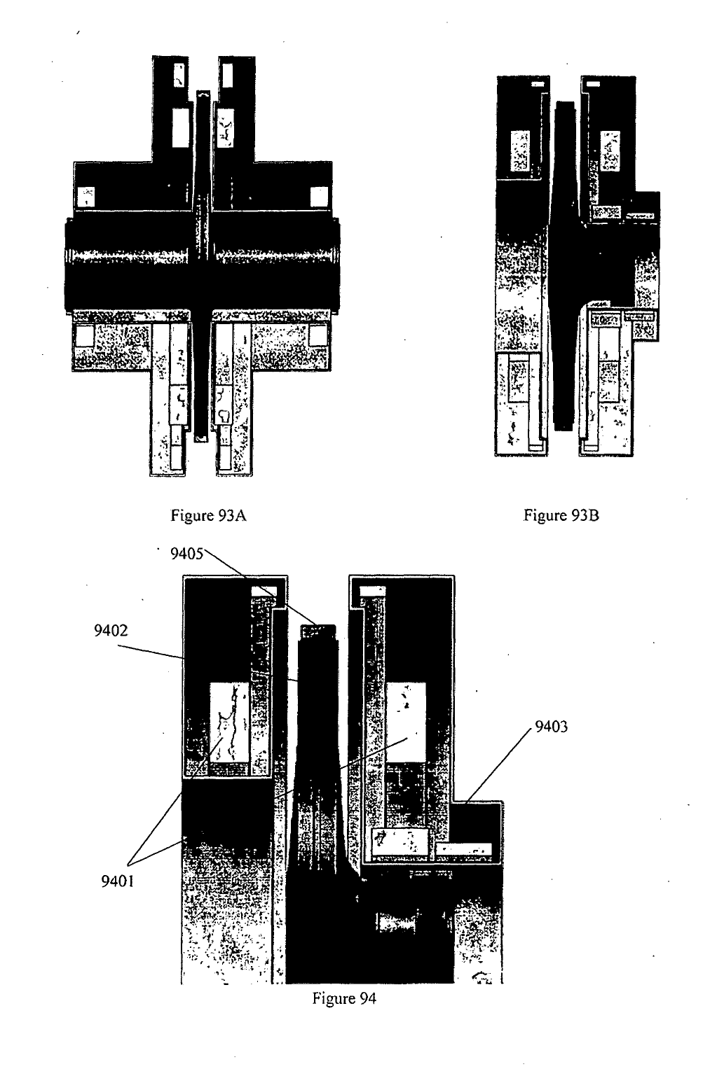

A further development of the turbine described above has also been made. A major difference in this development is a single sided current path. In original designs, current flowed to or from the central large diameter liquid metal brush to two current collectors located either end of the device. In the development, the current flows to one current collection location at one end of the device. At the other end, the cancelling coil is removed and the space used for torque input/output. The removal of one of the cancelling coils from one side of the motor/generator can enable the use of a light weight input/output shaft. The remaining shaft cancelling coil required for producing a null field region in the area of the liquid metal brush contact can be formed using one or more cancelling coils. An example of the original turbine is shown in FIG. 93A and the development is illustrated in FIG. 93B.

Other modifications incorporated in this embodiment include:
a) Increased distance between the main drive coils 9401. This results in a significant reduction in force between the coils.
b) Double working current using wider contact and increased rotor thickness 9402—effectively 2 rotors when compared to original designs. The increased working current also allows a reduced overall diameter for the same power which also reduces superconducting wire length required.
c) Where allowable the shaft cancelling coils 9403 can be shifted closer to the centre of the device and reduce the overall length as well as being provided on one side only.
d) The input/output shaft (not shown) for the rotor 9402 has been provided on one side only.
e) The increased width of the current transfer brush 9405 allows increased current to be passed through the rotor.

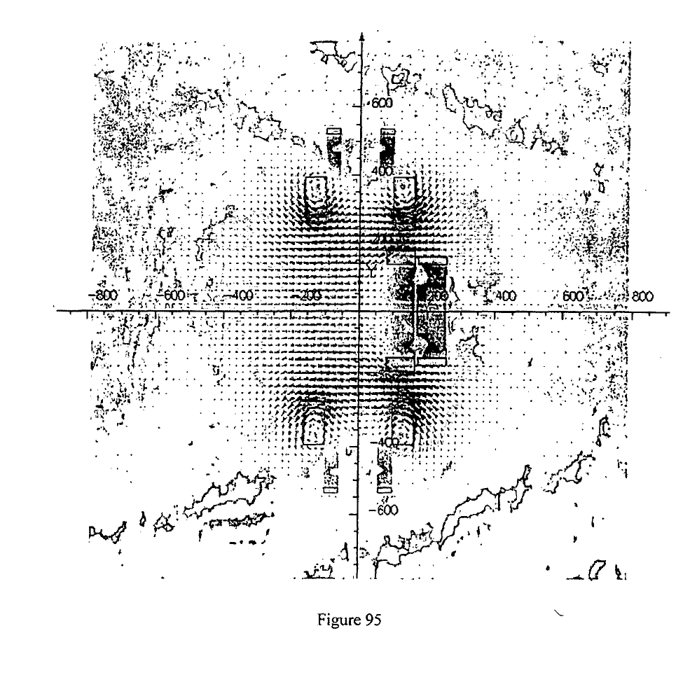

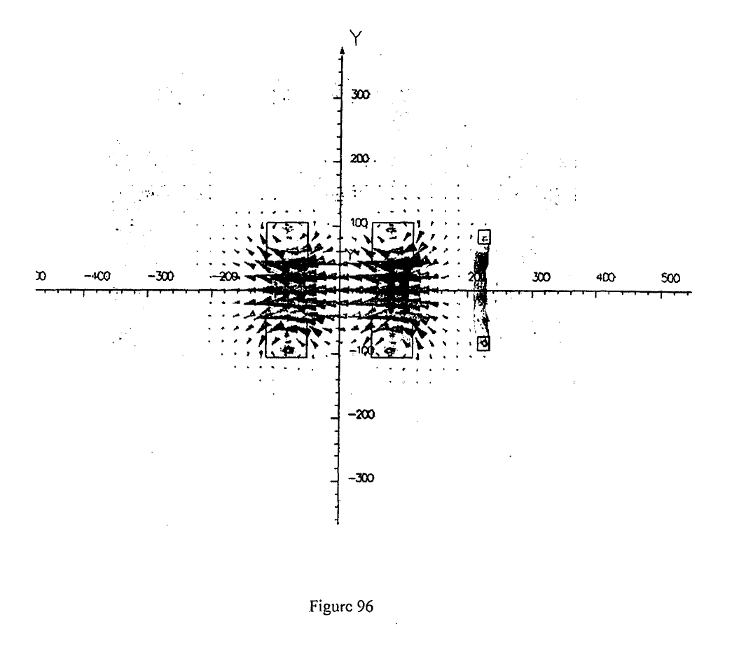

The field plot illustrated in FIG. 95 shows the typical coil layout and null field areas for the development turbine. It is also feasible for smaller diameter designs for the outer cancelling coils can be removed completely as illustrated in the field plot illustrated in FIG. 96.

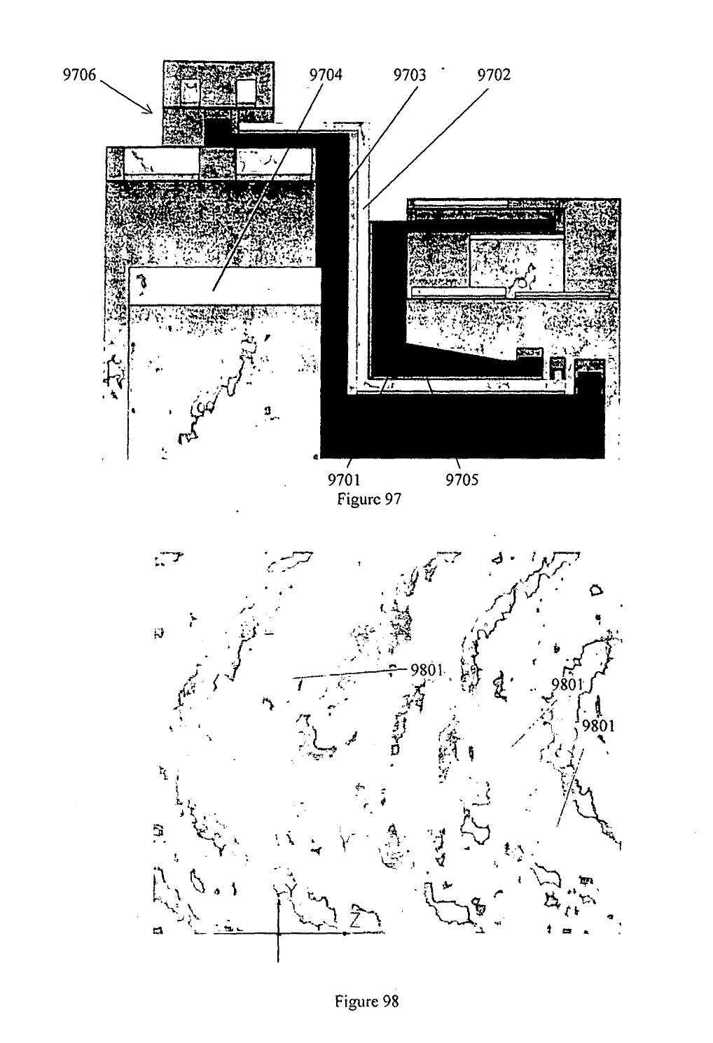

Many of the alternative arrangements described with reference to FIG. 62 and related Figures, can also be applied to an Electromagnetic convertor/low speed motor design. A revision in the aspect ratios of the main drive coils and outer cancelling coils can result in a lower overall diameter for the electromagnetic convertor as illustrated in FIG. 97. The basic layout includes a high speed generator 9701 which is mechanically coupled but insulated from a high speed motor section 9702 by an insulating shim 9705. The high speed generator 9701 is electrically associated with a low speed motor section 9703. An output shaft 9704 is also provided. The main drive coils of the superconducting drive coil assembly 9706 are more like a solenoid aspect (as described in detail above) compared to the pancake shape used in other embodiments.

The half field plot for this embodiment is illustrated in FIG. 98. The null field regions 9801 (below 0.2 T) are circumscribed by freeform lines.

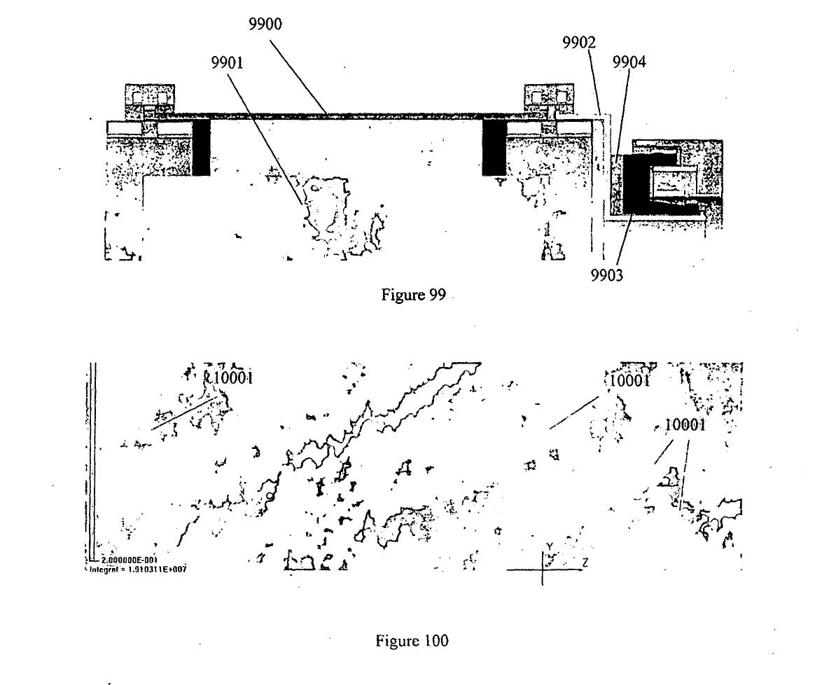

This alternate coil design can also be applied to many other designs including the drum/radial hybrid motor/electromagnetic converter design illustrated in FIG. 99 with the associated field plot illustrated in FIG. 100. This embodiment includes a low speed drum motor 9900, an output shaft 9901 and a high speed radial motor 9902 mechanically coupled to but electrically insulated from a high speed radial generator 9903 by insulating shim 9904.

The half field plot for this embodiment is illustrated in FIG. 100. The null field regions 10001 (below 0.2 T) are circumscribed by freeform lines.

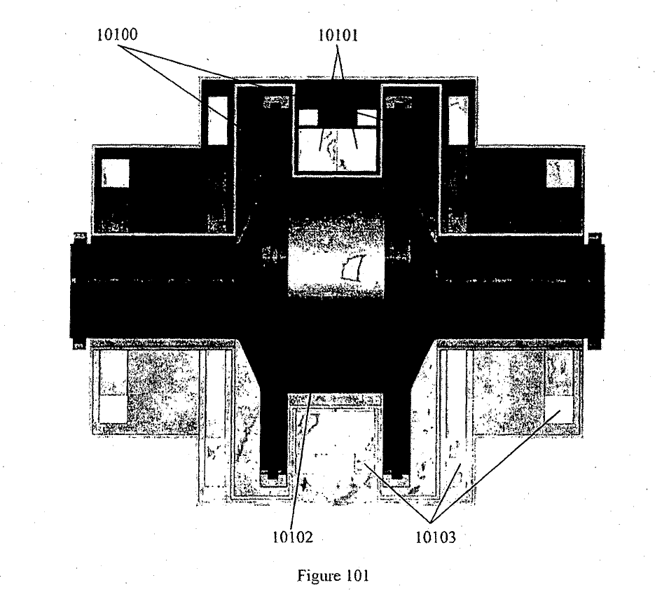

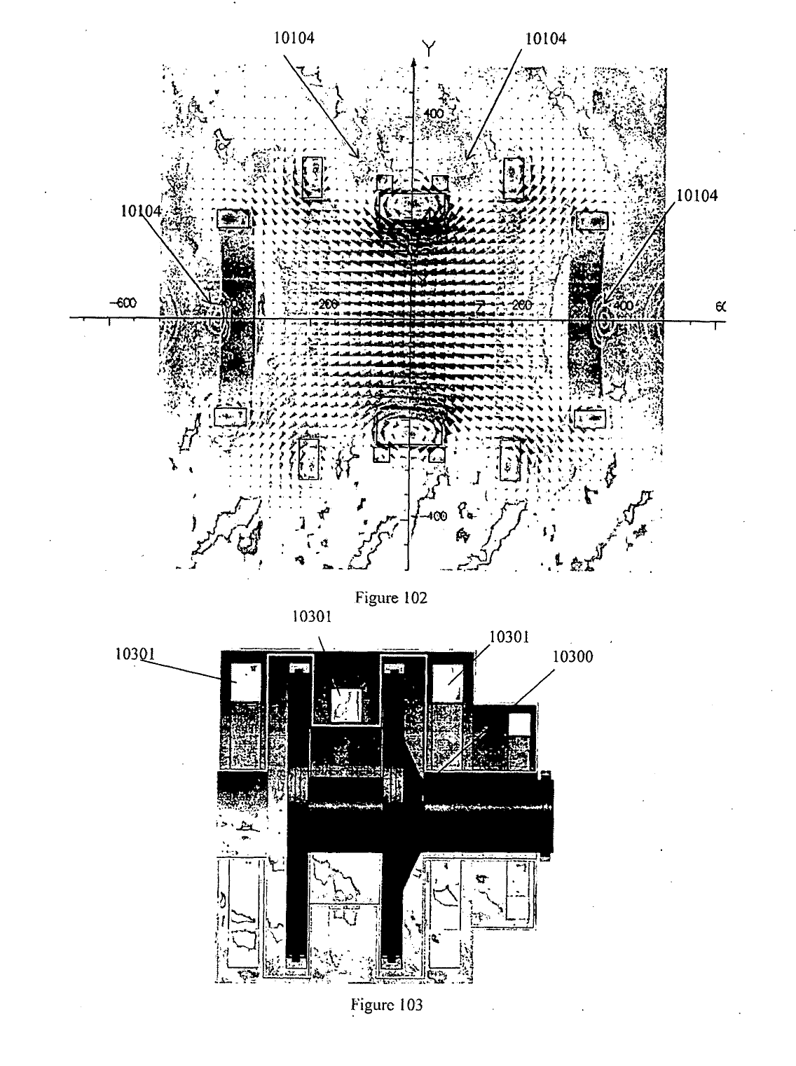

Still a further variation illustrated in FIG. 101 effectively positions two rotors 10100 on the outside of the main drive coils 10101 which have been moved together. In this way the field is effectively used twice. The main coils 10101 are provided as illustrated without a gap between the main coils. The rotors 10100 are position outside the main drive coils. The rotors are mechanically coupled together but electrically isolated from each other using an insulation connector 10102. Also additional cancelling coils 10103 have been added as shown to create the required null field areas for the preferred liquid metal brush contacts. The field plot for this embodiment is illustrated in FIG. 102 with null field areas 10104 shown.

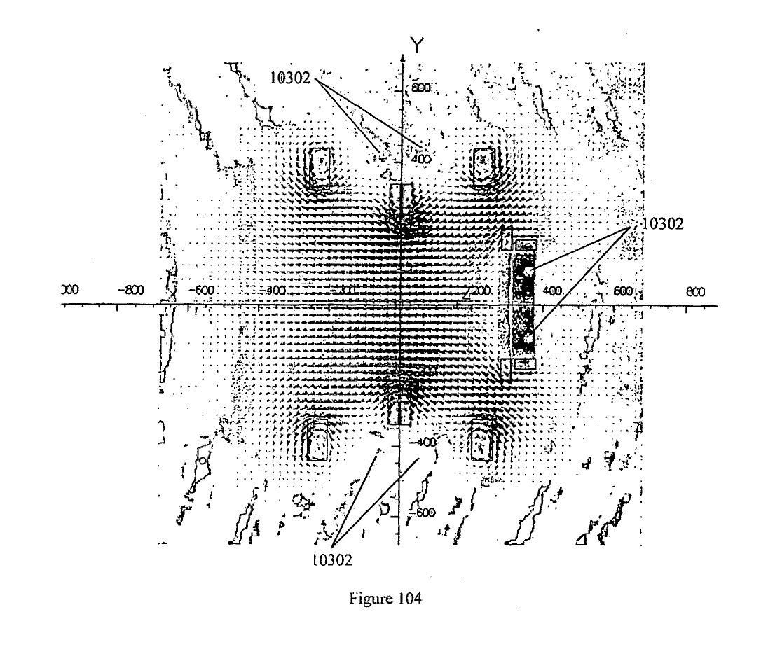

Another variation is shown in FIG. 103. In this case, two rotors or a double rotor 10300, would be positioned between the three sets of main drive coils 10301 and would be connected in parallel to a common shaft and current collected at one end (as shown) or both ends if additional cancelling coils were added the other end. The field plot for this embodiment is illustrated in FIG. 104 with null field areas 10302 shown.

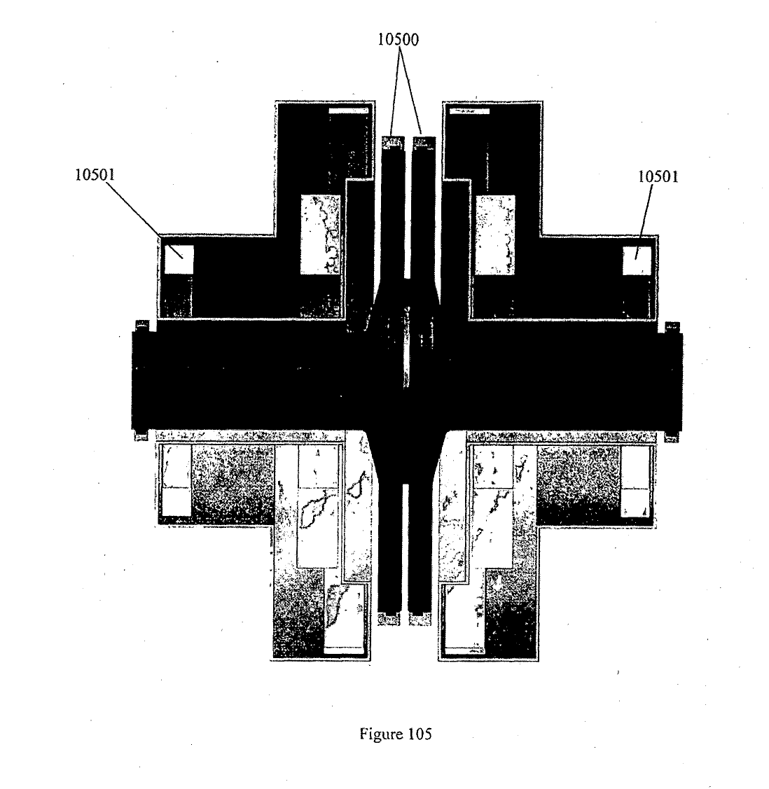

Another variation to the single sided development design is a double sided design with two rotors 10500 and two sets of shaft cancelling coils 10501 as shown in FIG. 105. The rotors are mechanically coupled but electrically isolated from each other.

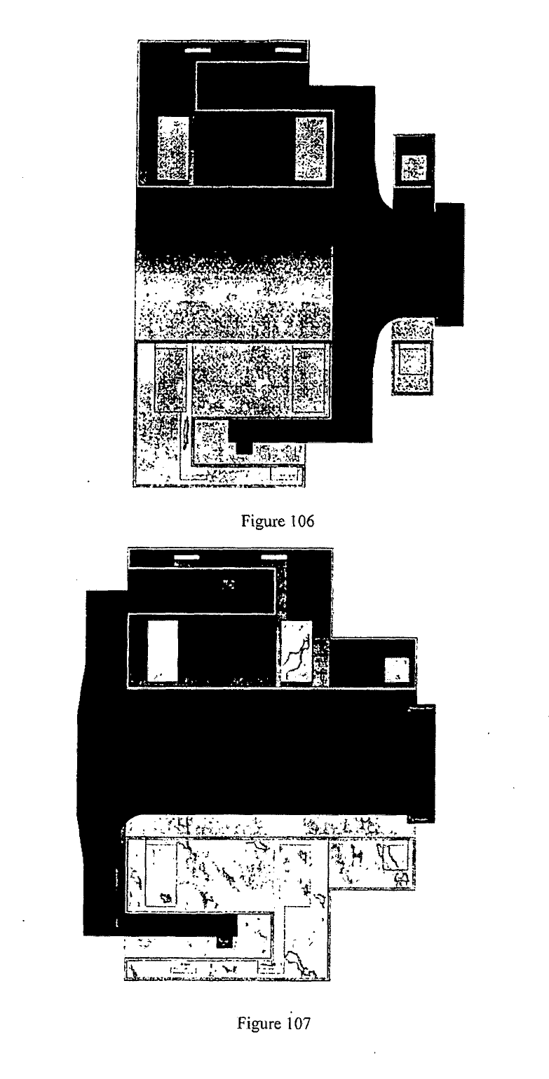

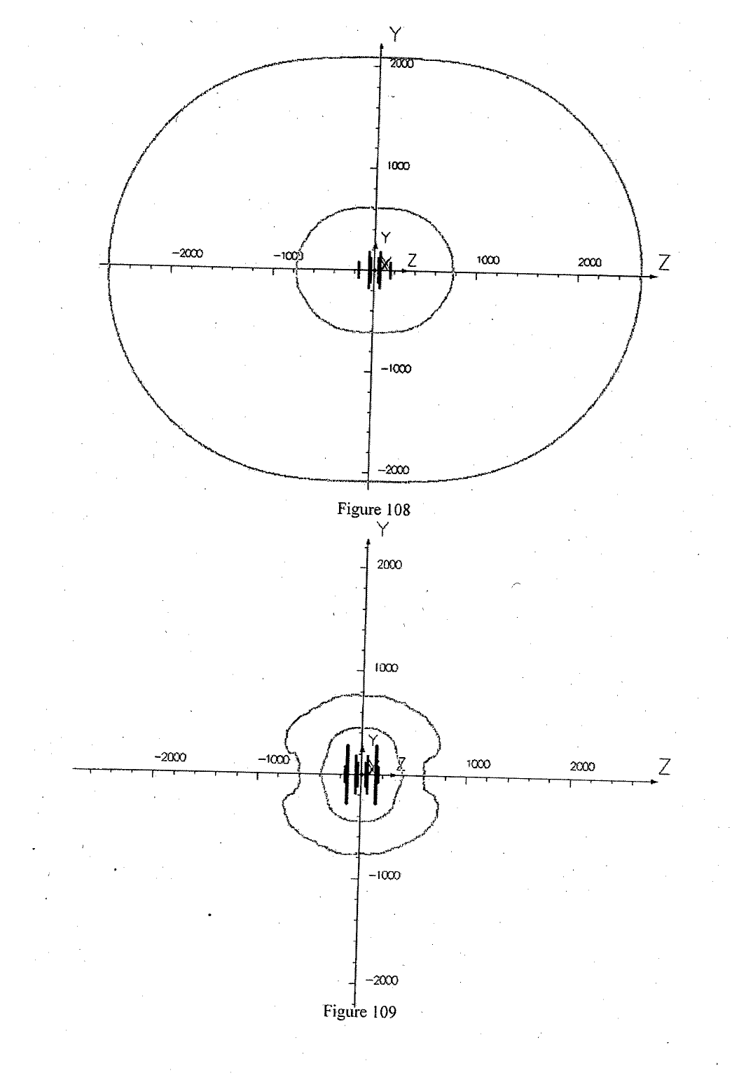

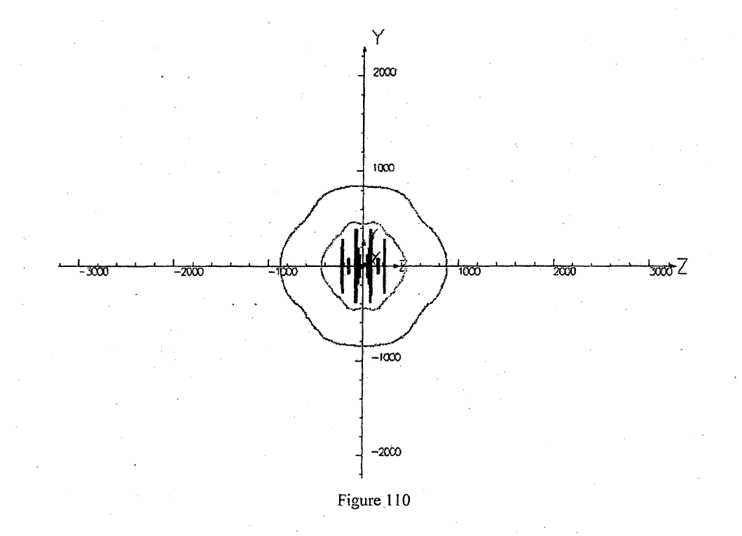

Other variations to the single sided configuration are alternate rotor shape, position and cryostat layout as shown in FIGS. 106 and 107.

FIG. 108 is a magnetic field distribution image of a radial style disc device similar to that shown in FIGS. 23A and 23B without tertiary cancelling coils. The outer line is the 5 Gauss line of the device which marks the boundary of the areas that have higher and lower fields. The inner line is the border of the area within which the field is above 200 Gauss, excepting the null field regions for the liquid metal brushes which are not visible at this scale. The device which creates this field distribution does not employ active shielding.

FIG. 109 is a magnetic field distribution image of the device illustrated in FIGS. 23A and 23B including active shielding using two (tertiary) shielding coils. Again, the outer line is the 5 Gauss line of the device which marks the boundary of the areas that have higher and lower fields. The inner line is the border of the area within which the field is above 200 Gauss, excepting the null field regions for the liquid metal brushes which are not visible at this scale. Note the comparative reduction in axial and radial offset of the 5 Gauss line compared with that illustrated in FIG. 108.

FIG. 110 is a magnetic field distribution image of the device illustrated in FIGS. 23A and 23B but modified to employ active shielding using four shielding coils. The outer line is the 5 Gauss line of the device which marks the boundary of the areas that have higher and lower fields. The inner line is the border of the area within which the field is above 200 Gauss, excepting the null field regions for the liquid metal brushes which are not visible at this scale. Note the comparative reduction in axial and radial offset of the 5 Gauss line compared with that illustrated in FIG. 108.

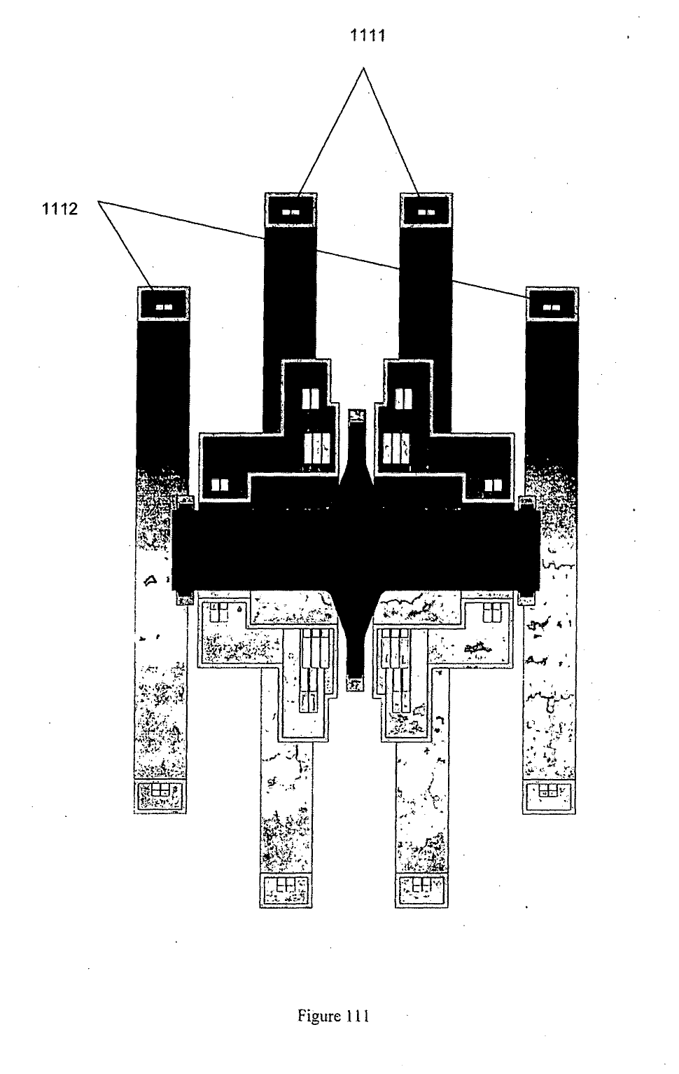

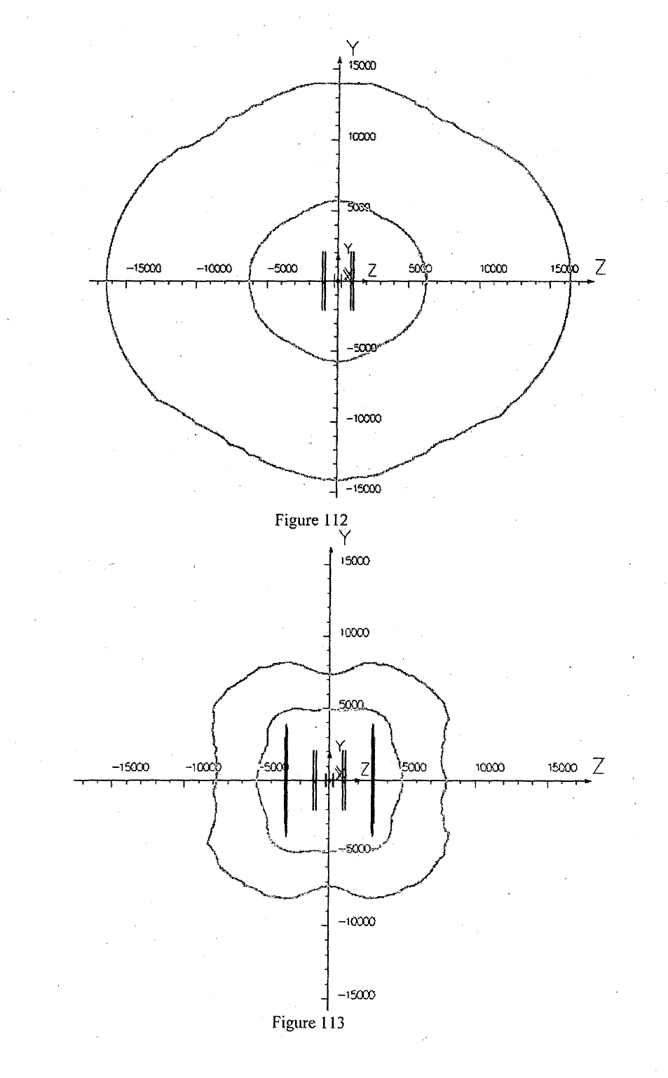

FIG. 111 is a sectional view of the device illustrated in FIGS. 23A and 23B but modified to employ a total of four active cancelling coils in the context of a disc style radial device which produces the magnetic field distribution image illustrated in FIG. 110. In this device a pair of outer active stray field cancelling coils 1111 is provided as well as a pair of inner active stray field cancelling coils 1112.

FIG. 112 is a magnetic field distribution image showing the 5 Gauss and 200 Gauss lines of a drum style axial device similar to that illustrated in FIG. 82 without the use of active cancelling coils.

FIG. 113 is a magnetic field distribution image showing the 5 Gauss and 200 Gauss lines of a drum style axial device similar to that illustrated in FIG. 82 with the use of two active cancelling coils. This Figure compared to FIG. 112 shows the significant reduction in the 5 and 200 Gauss boundaries.

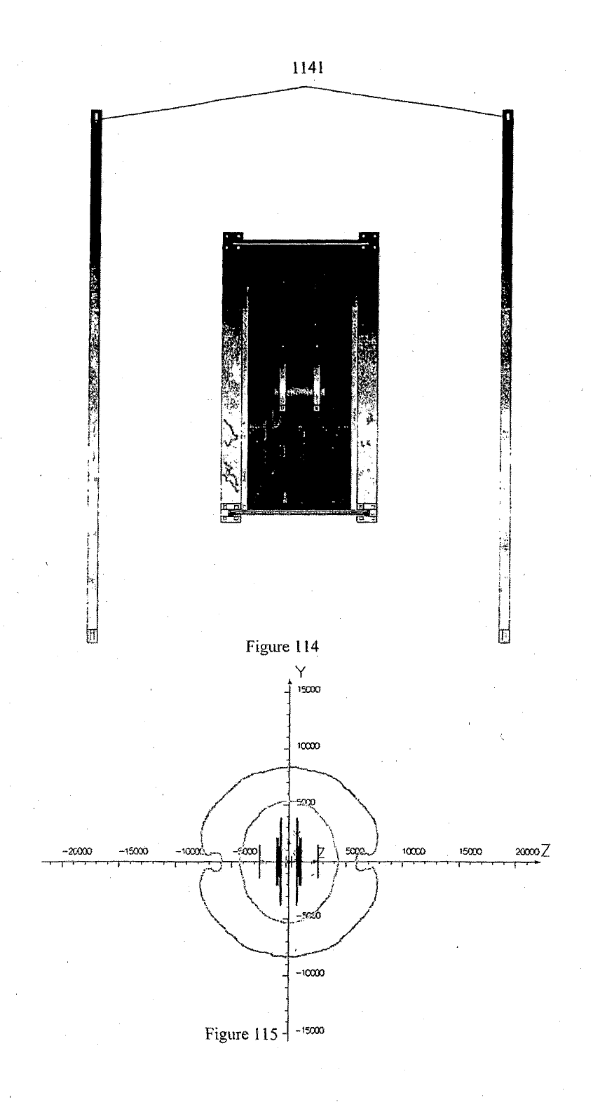

FIG. 114 is a sectional view of the device producing the field shown in FIG. 113 showing the positioning of the two additional active cancelling coils 1141.

FIG. 115 shows the 5 Gauss and 200 Gauss lines of a drum style axial device similar to that illustrated in FIG. 82 modified to include four active cancelling coils. Again, this Figure compared to FIG. 112 shows the significant reduction in the 5 and 200 Gauss boundaries.

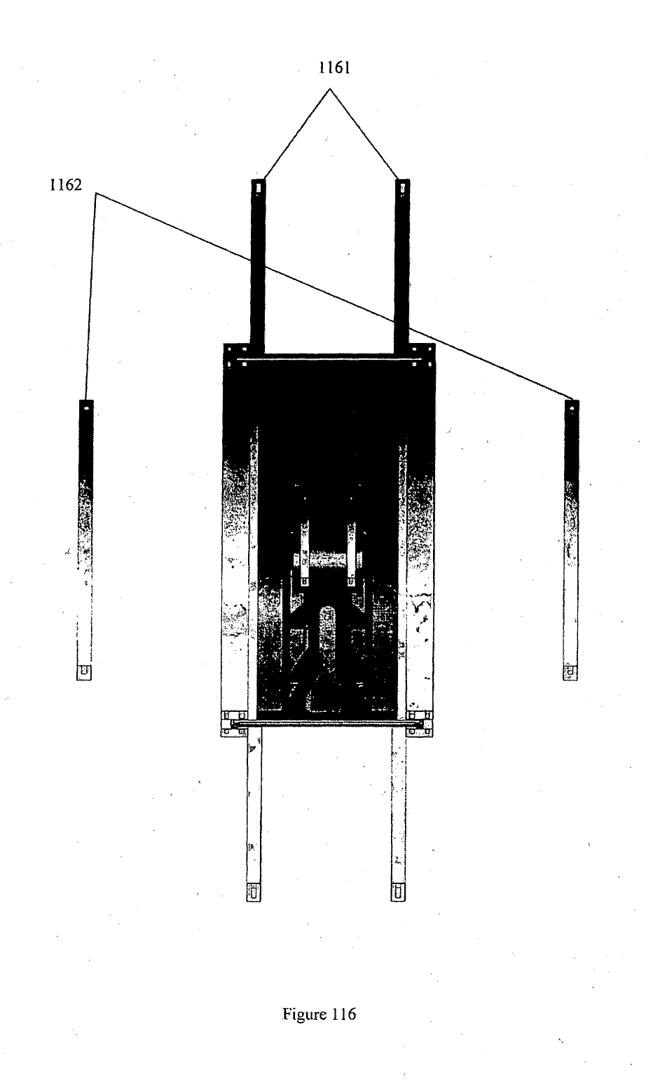

FIG. 116 is a sectional view of the device producing the field shown in FIG. 115 showing the positioning of the four additional active cancelling coils. In this device a pair of larger diameter active stray field cancelling coils 1161 is provided as well as a pair of smaller diameter active stray field cancelling coils 1162.

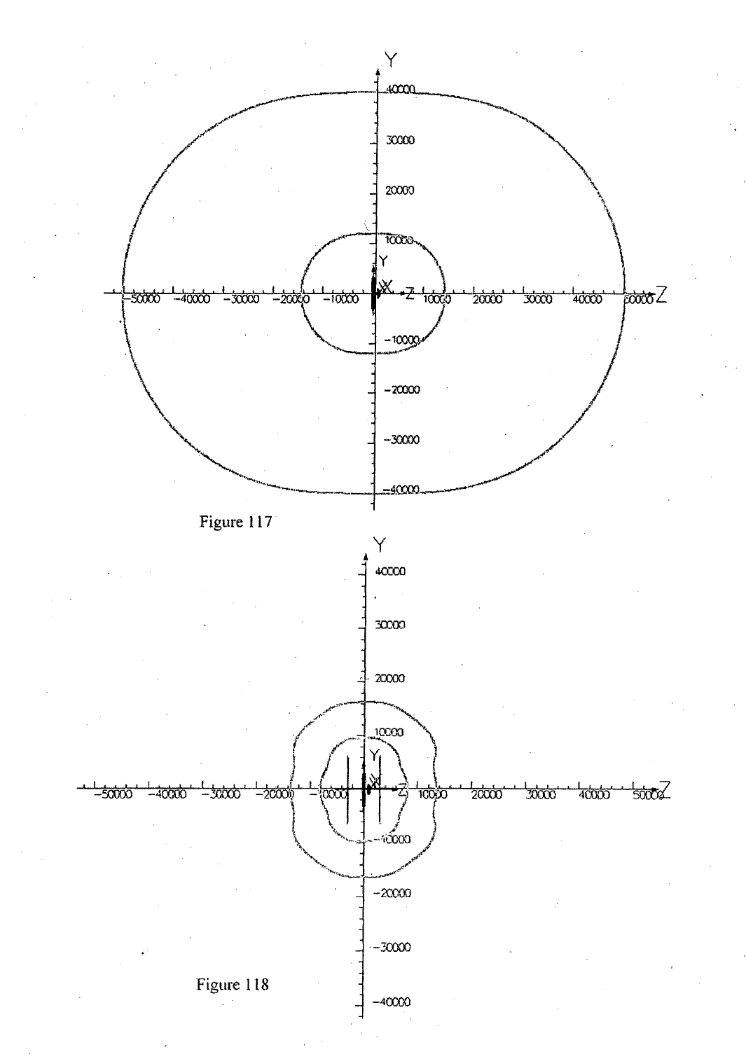

FIG. 117 shows the 5 Gauss and 200 Gauss lines of a multi-stage radial style disc device similar to that shown in FIG. 69 without active shielding. The outer line is the 5 Gauss line of the device which marks the boundary of the areas that have higher and lower fields. The inner line is the border of the area within which the field is above 200 Gauss, excepting the null field regions for the liquid metal brushes which are not visible at this scale. The above device does not employ active shielding.

FIG. 118 shows the 5 Gauss and 200 Gauss lines of a multi-stage radial style disc device similar to that shown in FIG. 69 with active shielding using two shielding coils 1181. As with the previous Figures, the outer line is the 5 Gauss line of the device which marks the boundary of the areas that have higher and lower fields. The inner line is the border of the area within which the field is above 200 Gauss, excepting the null field regions for the liquid metal brushes which are not visible at this scale. The above device employs active shielding using two shielding coils and the comparative reduction in axial and radial offset of the 5 Gauss line is readily apparent.

FIG. 119 is a sectional view of the device producing the field shown in FIG. 118 showing the positioning of the two additional shielding coils 1181.

FIG. 120 is an isometric view of a main rotating disc and shaft assembly with tongue shaped outer ring forming one half of a liquid metal brush assembly according to a preferred embodiment. The main conductive output shaft 120A is mounted for rotation about bearing mounts 120B. The shaft 120A mounts a main rotor disc 120C for rotation with the shaft 120A. The outer portion 120D of the main rotor disc 120C which forms an inner conducting surface of a preferred liquid metal brush assembly is provided in a different material to the rotor disc 120C, in this case, copper. It is also shaped as a radially extending tongue.

FIG. 121 is a sectioned isometric view of a full rotor and both inner and outer liquid metal brush assemblies according to a preferred embodiment including the containment walls for the liquid metal material. According to this configuration, the rotating shaft 121A is mounted between a pair of electrically isolated shaft mounting points 121B. The rotating shaft 121A mounts a rotating disc 121C contained within a stationary liquid metal containment vessel 121D. An outer current delivery/takeoff ring 121E is provided adjacent the rotating disc 121C and an inner current delivery/takeoff ring 121F is located at one lateral end of the rotating shaft 121A. Both of these current delivery/takeoff rings include liquid metal brush assemblies for current delivery/takeoff. The inner current delivery/takeoff ring 121F is also located within a stationary liquid metal containment vessel 121G.

FIG. 22 is a front elevation view of the configuration illustrated in FIG. 121. This figure clearly illustrates the ceramic bearings 122A mounted on O-rings in order to accommodate thermal expansion. Again, the rotating shaft 121 A mounts a rotating disk assembly 121C which has an outer liquid metal brush assembly 122B provided for current delivery/takeoff. The rotating shaft 121A also mounts an inner liquid metal brush assembly 122C at one lateral end thereof which allows current flow through the rotating shaft 121A and rotating disc assembly 121C.

FIG. 123 is a detailed view of the outer liquid metal brush assembly illustrated in FIG. 122. In this configuration, the rotating disc 123A is manufactured of aluminium and an outer ring of the rotating disc (which also forms the rotating inner ring 123B of the liquid metal brush assembly) is configured as a copper attachment with an elongate tongue 123C. The rotating inner ring 123B is attached to the rotating disc 123A using a number of fasteners 123D. The stationary outer ring 123E of the liquid metal brush assembly is a two-piece ring to allow assembly of the stationary outer ring 123E over the rotating inner ring 123B to define a substantially U-shaped groove therebetween to contain the liquid metal 1230 for current transfer. Filling taps and sensor ports 123F are provided to allow the liquid metal 123G to be injected into the substantially U-shaped groove. The entire assembly is contained within liquid metal containment vessel walls 123H in order to prevent loss of the liquid metal 123G when the device is not operating.

FIG. 124 is a detailed view of the inner liquid metal brush assembly illustrated in FIG. 122. This configuration is similar in many respects to the configuration illustrated in FIG. 123. Again, the rotating shaft 124D is mounted for rotation using an electrically insulated shaft mounting point 124H and ceramic bearings 1241 mounted on O-rings to cater for thermal expansion. An outer part of the shaft 124D provides a mount for the inner ring 124C of a liquid metal brush assembly. The inner ring 124C is manufactured from copper and is attached to the preferred aluminium rotating shaft 124D using one or more fasteners 124E. Again, a two-piece stationary outer ring 124A is provided and mounted relative to the inner ring 124C to define a substantially U-shaped groove to receive the liquid metal to form the contact 124B. A liquid metal containment vessel 124F contains the liquid metal brush assembly and a circumferential fluid seal 124G is provided to prevent loss of the liquid metal 124B when the device is not operating.

FIG. 125 is a sectional view of a preferred embodiment of a rotating disc/shaft assembly showing the flared disc section. In this configuration, the rotating disc 125A is provided with a flared disc section 125B towards the root of the disc 125A, that is where the disc 125A is mounted to the rotating shaft 125C. A pair of liquid metal collection grooves 125D is provided, one on each lateral side of the rotating disc 125A to collect liquid metal which drains from the liquid metal brush assembly when the device is not operating. The flared disc section 125B could alternatively be undercut to improve fluid collection. Fluid seals 125E are also provided between the containment assembly walls 125F and the rotating shaft 125C to prevent loss of the liquid metal.

FIG. 126 is a sectional view of a complete rotor and brush assembly with the drive magnet and cryostat boundaries shown according to a preferred embodiment of the present invention.

FIG. 127 shows one possible implementation where the sealed inert environment defined by an outer boundary wall 127A is created around the rotor and cryostat assemblies with the final output shaft 127B sealed using a low wear, Ferro-fluid seal 127C.

It is to be understood that the above embodiments have been provided only by way of exemplification of this invention, and that further modifications and improvements thereto, as would be apparent to persons skilled in the relevant art, are deemed to fall within the broad scope and ambit of the present invention described herein.

1. A generator said generator including:
a first magnetic assembly and a second magnetic assembly wherein the first and second magnetic assemblies are arranged in parallel for the production of a magnetic field and a null magnetic field region;
a rotor positioned between the first and second magnetic assemblies the rotor being coupled to a drive shaft extending through the first and second magnetic assemblies wherein a portion of the rotor is positioned in the null field region;
at least one current transfer mechanism coupled to the rotor in the null field region and at least one current transfer mechanism coupled to the shaft;
a chive mechanism attached to the shaft;
whereby actuation of the drive mechanism causes rotation of the rotor in the magnetic field to produce an electric potential between the first and second current transfer mechanisms.

2. The generator of claim 1 wherein each of the magnetic assemblies includes one or more coils of superconducting material contained within a cryogenic envelope.

3. The generator of claim 2 wherein the superconducting coils are linked to form a solenoid.

4. The generator of claim 2 wherein the superconducting coils are arranged in specific geometric configurations within the magnetic assemblies.

5. The generator of claim 4 wherein the coils are arranged concentrically within the magnetic assemblies.

6. The generator of claim 4 wherein the coils are arranged coaxially.

7. The generator of any one of claims 2 to 6 wherein the coils forming each magnetic assembly are of alternating polarity.

8. The generator of any one of claims 1 to 7 wherein the rotor is constructed from a plurality of conductive layers.

9. The generator of claim 8 wherein adjacent layers are electrically coupled to form a series circuit through the rotor.

10. The generator of any one of the preceding claims wherein the current transfer mechanisms are in the form of liquid metal brushes.

11. The generator of any one of the preceding claims wherein at least one current transfer mechanism coupled to the shaft is positioned external to the first or second magnetic assemblies.

12. The generator of claim 11 wherein at least one current transfer mechanism is coupled to the shaft in a region where the strength of the magnetic field is below 0.2 T.

13. The generator of any one of the preceding claims wherein the drive mechanism is a low speed drive.

14. The generator of claim 13 wherein the electric potential produced is low voltage and high current.

15. The generator of any one of claims 1 to 12 wherein the drive mechanism is a high speed drive.

16. The generator of claim 13 wherein the electric potential produced is a high voltage and low current.

17. The generator of any one of the preceding claims wherein the generator further includes third and fourth magnetic assemblies arranged in parallel and positioned concentrically within the first and second magnetic assemblies.

18. The generator of claim 17 wherein third and fourth magnetic assemblies include one or more coils of superconducting material contained within a cryogenic envelope.

19. A generator including a DC-DC conversion stage the generator including:
a first magnetic assembly and a second magnetic assembly wherein the first and second magnetic assemblies are arranged in parallel for the production of a primary drive field and a null magnetic field region;
a first rotor positioned between the first and second magnetic assemblies, the first rotor being adapted for connection to a drive shaft wherein a portion of the rotor is positioned in the null field region;
an electric motor electrically coupled to the first rotor, the electric motor positioned between a third and fourth magnetic assemblies are arranged in parallel to produce a drive field for the motor, said third and fourth magnetic assemblies producing a plurality of secondary null field regions wherein the electrical couplings of the motor are positioned with the secondary null field regions;
a second rotor positioned between the first and second magnetic assemblies and adjacent the first rotor, said second rotor being mechanically coupled to the electric motor wherein a portion of the second rotor is positioned in the null field region;
a drive mechanism mechanically coupled to the first rotor;
whereby actuation of the drive mechanism causes rotation of the first rotor within the primary drive field to produce a high current which is passed through the electric motor to generate a torque to drive the second rotor within the primary field to produce a low current output.

20. The generator of claim 19 wherein the first and second rotors include inner and outer current transfer mechanisms.

21. The generator of claim 20 wherein the inner current transfer mechanisms are positioned within at least one of the secondary null field regions produced by the third and fourth magnetic assemblies and the outer current transfer mechanisms are positioned within the null field region produced by the first and second magnetic assemblies.

22. The generator of any one of claims 19 to 21 wherein the electrical couplings for the electric motor may be in the form of an inner and an outer current transfer mechanism.

23. The generator of claim 22 wherein the inner current transfer mechanism is positioned within a first region within the secondary null field regions and the outer brush is positioned within a second region within the secondary null field regions.

24. The generator of any one of claims 19 to 23 wherein each of the magnetic assemblies includes one or more coils of superconducting material contained within a cryogenic envelope.

25. The generator of claim 24 wherein the superconducting conducting coils are arranged in specific geometric configurations within the magnetic assemblies.

26. The generator of claim 25 wherein the coils are arranged concentrically within the magnetic assemblies.

27. The generator of claim 25 wherein the coils are arranged coaxially.

28. The generator of any one of claims 24 to 27 wherein the coils forming each magnetic assembly are of alternating polarity.

29. The generator of any one of claims 19 to 28 wherein the first, second, third and fourth magnetic assemblies may be arranged in overlapping relation.

30. The generator of claim 29 wherein the third and fourth magnetic assemblies are arranged concentrically within the first and second magnetic assemblies.

31. The generator of any one of claims 19 to 30 further including a third rotor positioned between fifth and sixth magnetic assemblies such that a portion of the third rotor is positioned within null magnetic field region produced between the fifth and sixth magnetic assemblies.

32. The generator of claim 31 wherein the third rotor is mechanically and electrically coupled to the first rotor.

33. The generator of claim 31 or 32 wherein the fifth and sixth magnetic assemblies include one or more coils of superconducting material contained within a cryogenic envelope.

34. The generator of claim 33 wherein the superconducting conducting coils are arranged in specific geometric configurations within the magnetic assemblies.

35. The generator of claim 34 wherein the coils are arranged concentrically within the magnetic assemblies.

36. The generator of any one of claims 19 to 35 wherein the second rotor is electrically isolated from the electric motor.

37. A generator including a DC-DC conversion stage the generator including:
a first magnetic assembly and a second magnetic assembly wherein the first and second magnetic assemblies are arranged in parallel for the production of a primary drive field and a null magnetic field region;
a first rotor adapted for connection to a drive shaft wherein a portion of the rotor is positioned in the null field region produced between the first and second magnetic assemblies;
an electric motor electrically coupled to the first rotor the electric motor positioned between a third and fourth magnetic assemblies which are arranged in parallel to produce a drive field for the motor said third and fourth magnetic assemblies producing a plurality of secondary null field regions wherein the electrical couplings of the motor are positioned within the secondary null null field regions;
a second rotor positioned adjacent the first rotor, said second rotor being mechanically coupled to the electric motor and wherein a portion of the second rotor is positioned in the null field region produced between the first and second magnetic assemblies;
a drive mechanism mechanically coupled to the first rotor;
whereby actuation of the drive mechanism causes rotation of the first rotor within the primary drive field to produce a high current which is passed through the electric motor to generate a torque to drive the second rotor within the primary field to produce a low current output.

38. A generator including:
a first magnetic assembly and a second magnetic assembly wherein the first and second magnetic assemblies are arranged in parallel for the production of a primary drive field and regions of null magnetic field;
a third and a fourth magnetic assembly arranged in parallel and positioned concentrically within the first and second magnetic assemblies;
a rotor positioned between the magnetic assemblies the rotor being adapted for connection to a drive shaft;
a plurality of current transfer mechanisms coupled at discrete points along the rotor wherein each current transfer mechanism is positioned within a region of null magnetic field produced between the magnetic assemblies, the rotor in the null field region and a second current transfer mechanism coupled to the shaft;
a drive mechanism attached to the rotor;
whereby actuation of the drive mechanism causes rotation of the rotor in the magnetic field to produce an electric potential between the current transfer mechanisms.

39. A generator as claimed in any one of the preceding claims wherein any rotor provided is a laminated rotor including a number of rotor disc elements each mounted to corresponding cylinder elements for rotation thereabout, the cylinder elements forming a conductive shaft, and wherein a non-conducting material is disposed between each of the rotor disc elements to create a strong mechanical connection between the elements while retaining electrical isolation between the elements.

40. A generator as claimed in any one of the preceding claims wherein any magnetic assembly is realised using normal conducting materials, permanent magnetic materials or bulk superconducting materials.
